(19) United States
(12) Patent Application Publication
(10) Pub. No.: US 2025/0131201 A1
(43) Pub. Date: Apr. 24, 2025

(54) ARTIFICIAL INTELLIGENCE ASSISTED CONVERSATION USING A BIOSENSOR

(71) Applicant: Cognixion Corporation, Santa Barbara, CA (US)

(72) Inventors: Christopher Jason Ullrich, Ventura, CA (US); Carl Hagmann, Syracuse, NY (US); Cole Heiner, Vista, CA (US); Daniela Friedson-Trujillo, Highland Village, TX (US); Joseph Andreas Forsland, Santa Barbara, CA (US)

(73) Assignee: Cognixion Corporation, Santa Barbara, CA (US)

(21) Appl. No.: 18/920,731

(22) Filed: Oct. 18, 2024

Related U.S. Application Data
(60) Provisional application No. 63/591,407, filed on Oct. 18, 2023.

(51) Int. Cl. G06F 40/35; G06F 3/01

(52) U.S. Cl. CPC G06F 40/35; G06F 3/015

(57) ABSTRACT

A system and method for AI-assisted conversation utilize a biosensor to receive biosignals, which are analyzed by the perception engine. The engine generates context tags and text descriptions from multimodal sensory inputs and biosignal analysis. This information is then used by the conversation engine, along with memory engine data (conversation history, biographical background, keywords), to generate prompts for a language model. These prompts are displayed to a user through a computing device that presents various conversation features like communication history, context data, and selected content. The system enables interactive AI-assisted conversations between humans and machines or other humans.

### CROSS-REFERENCE TO RELATED APPLICATIONS

This application claims the benefit of U.S. provisional patent application Ser. No. 63/591,407, filed on Oct. 18, 2023, the contents of which are incorporated herein by reference in their entirety.

### BACKGROUND

Human agency as a term of human psychology may refer to an individual's capacity to actively and independently make choices and to impose those choices on their surroundings. There are many situations in which people have a need and desire to make choices in interacting with their environment but are unable to do so without assistance. In this manner, such people find themselves impaired in their human agency to effect a change in their surroundings or communicate with those around them.

Advances in augmented and virtual reality, as well as the field of robotics and artificial intelligence (AI), offer a host of tools whereby a user unable to enact their agency to interact with the world around them unassisted may be supported in doing so. These systems may remain partially or fully inaccessible to users unable to speak, users with limited mobility, users with impaired perception of their surroundings, either sensory perception or social perception, and most of all, users inexperienced in interacting with augmented reality (AR), virtual reality (VR), and robotics.

Recent advances in Generative AI (GenAI) may allow those unfamiliar with coding to interact with AI and robotic assistants, as well as the people around them, using GenAI outputs. “Generative AI” or “GenAI” in this disclosure refers to a type of Artificial Intelligence (AI) capable of creating a wide variety of data, such as images, videos, audio, text, and 3D models. It does this by learning patterns from existing data, then using this knowledge to generate new and unique outputs. GenAI is capable of producing highly realistic and complex content that mimics human creativity, making it a valuable tool for many industries such as gaming, entertainment, and product design (found on https://generativeai.net, accessed May 24, 2023).

GenAI may include large language models (LLMs), Generative Pre-trained Transformer (GPT) including chatbots such as ChatGPT, OpenAI, text-to-image and other visual art creators such as Midjourney and Stable Diffusion, and even more comprehensive models such as the generalist agent Gato. However, conventional interaction with these entities involves formulating effective natural language queries, and this may not be possible for all users.

Users unable to formulate effective natural language queries may utilize a number of conventional solutions in support of speech and conversation. Improving upon conventional solutions may involve the integration of GenAI and/or language model support in the form of local small language models, cloud-based large language models, and variations and combinations thereof. There is, therefore, a need for a system capable of creating effective GenAI prompts, based on information other than or in addition to natural language provided by a user, in support of augmenting or facilitating the user's ability to hold a conversation with others.

### BRIEF SUMMARY

A system for facilitating an AI-assisted conversation utilizing a biosensor and a method for use of the same is described. This system comprises a biosensor that captures biosignals and a perception engine to process these signals along with multimodal sensory data such as audio, visual, and haptic inputs. The user experience engine allows users to interact with the conversation features through a generated interface, including accessing communication history, context data, and selectable content via the biosensor.

The AI system includes various components like a memory engine for storing different types of data (conversation history, biographical background, keywords), a perception engine that analyzes multimodal sensory information and biosignals, and a conversation engine to manage prompts generated from this analysis which are passed on to a language model (LM), which suggests conversation features to a user for selection and use in an AI-assisted conversation. A refinement engine permits users to approve or modify responses before they are finalized. A tuning engine allows continuous tuning and improvement to the LM. A computing device delivers the user interface for interaction with these features while a companion application facilitates communication between humans and machine agents.

### BRIEF DESCRIPTION OF THE SEVERAL VIEWS OF THE DRAWINGS

To easily identify the discussion of any particular element or act, the most significant digit or digits in a reference number refer to the figure number in which that element is first introduced.

FIG. 1 illustrates a conversation augmentation system 100 in accordance with one embodiment.

FIG. 2 illustrates a user experience engine 200 in accordance with one embodiment.

FIG. 3 illustrates a conversation engine 300 in accordance with one embodiment.

FIG. 4 illustrates a perception engine 400 in accordance with one embodiment.

FIG. 5 illustrates a memory engine 500 in accordance with one embodiment.

FIG. 6 illustrates a refinement engine 600 in accordance with one embodiment.

FIG. 7 illustrates a tuning engine 700 in accordance with one embodiment.

FIG. 8 illustrates a language engine 800 in accordance with one embodiment.

FIG. 9 illustrates a corpus search engine 900 in accordance with one embodiment.

FIG. 10 illustrates a routine 1000 in accordance with one embodiment.

FIG. 11 illustrates an operation sequence diagram 1100 in accordance with one embodiment.

FIG. 12A-FIG. 12J illustrate an exemplary user interface 1200 in accordance with one embodiment.

FIG. 13A-FIG. 13H illustrate an exemplary user interface 1300 in accordance with one embodiment.

FIG. 14 illustrates an exemplary user interface 1400 in accordance with one embodiment.

FIG. 15A and FIG. 15B illustrate an exemplary user interface 1500 in accordance with one embodiment.

FIG. 16 illustrates a user agency and capability augmentation system 1600 in accordance with one embodiment.

FIG. 17 illustrates a biosignals subsystem 1700 in accordance with one embodiment.

FIG. 18 illustrates a context subsystem 1800 in accordance with one embodiment.

FIG. 19 illustrates a routine 1900 in accordance with one embodiment.

FIG. 20 illustrates a turn-taking capability augmentation system 2000 in accordance with one embodiment.

FIG. 21 illustrates a user agency and capability augmentation system with output adequacy feedback 2100 in accordance with one embodiment.

FIG. 22 illustrates a routine 2200 in accordance with one embodiment.

FIG. 23 illustrates an exemplary tokenizer 2300 in accordance with one embodiment.

FIG. 24A illustrates an isometric view of a brain computer interface or BCI headset system 2400 in accordance with one embodiment.

FIG. 24B illustrates a rear view of a BCI headset system 2400 in accordance with one embodiment.

FIG. 24C and FIG. 24D illustrate exploded views of a BCI headset system 2400 in accordance with one embodiment.

FIG. 25 illustrates a logical diagram of a user wearing an augmented reality headset 2500 in accordance with one embodiment.

FIG. 26 a logical diagram of a user wearing an augmented reality headset 2600 in accordance with one embodiment.

FIG. 27 illustrates a diagram of a use case including a user wearing an augmented reality headset 2700 in accordance with one embodiment.

FIG. 28 illustrates a flow diagram 2800 in accordance with one embodiment.

FIG. 29 illustrates a flow diagram 2900 in accordance with one embodiment.

FIG. 30 illustrates a routine 3000 in accordance with one embodiment.

FIG. 31 illustrates a routine 3100 in accordance with one embodiment.

FIG. 32 illustrates a routine 3200 in accordance with one embodiment.

FIG. 33 illustrates a routine 3300 in accordance with one embodiment.

FIG. 34 illustrates a routine 3400 in accordance with one embodiment.

FIG. 35 illustrates a routine 3500 in accordance with one embodiment.

FIG. 36 illustrates a routine 3600 in accordance with one embodiment.

FIG. 37 illustrates a routine 3700 in accordance with one embodiment.

FIG. 38 illustrates a routine 3800 in accordance with one embodiment.

FIG. 39 illustrates a routine 3900 in accordance with one embodiment.

### DETAILED DESCRIPTION

There are disclosed herein systems and methods for human agency support through an integrated use of context information from the user's environment, the user's historical data such as recorded usage of the system, a body of recorded historical work product, etc., biosensor signals indicating information about the user's physical state and bodily actions, and explicit user input. These are input to a prompt composer capable of taking in these inputs, generating a prompt for a generative AI or generalist agent. Specifically, the disclosed solution augments a user's agency in participating in conversations with one or more conversation partners. These conversation partners may be human partners or machine agents.

The output of the generative AI or generalist agent may drive an output stage that is able to support and facilitate the human agency of the user based on the output. In this manner, the user may interact with the system with ease and rapidity, the system generating communications to or instructing the actions of supportive and interactive entities surrounding the user, such as other people, robotic aids, smart systems, etc.

A system is disclosed that allows a user wearing wearable biosensors and/or implantable biosensing devices to engage in an AI assisted conversation. Biosensors utilized in the system may include but are not limited to wirelessly connected wearable or implantable devices such as a Brain Computer Interface (BCI), functional magnetic resonance imaging (FMRI), electroencephalography (EEG), or implantable brain chips, motion remote gesture sensing controllers, breathing tube sip and puff controllers, electrooculography (EOG) or eye gaze sensing controllers, to trigger a function. The system may include an AR-BCI system or device comprising an AR display, biosensors such as EEG electrodes, a visual evoked potential (VEP) classifier, a visual layout including selected conversation history and possible responses selectable using the biosensors, and an AI query generator.

The system may include a network-connected companion application on a local and/or remote device such as a smartphone, tablet, or other mobile computing device. This companion application may support text, voice, or gesture inputs to generate text. In one embodiment, the self-contained AR-BCI system may also consume speech without the need of a companion application. The system may include a communication path that sends generated text to the AR-BCI system.

The system may utilize a network-connected AI system in one embodiment. This may be an AI natural language processing (NLP) model able to ingest conversation history, biographical background, keywords, and other ancillary data that may generate a set of possible responses, consistent with the conversation. In one embodiment, a chat-based LLM such as Metachat may engage in dialog with internal and external agents to integrate and act on the biosensor and conversation history information. In other words, the “chat” that typically occurs between human and a machine may instead be a chat between machines about current events and conversation with minimal human intervention.

The system may include Multimodal Prompt Orchestration in which the biosensor data may be automatically and flexibly written into a prompt before the prompt is delivered to LLM. The user may be able to control the direction of the conversation by entering keywords to generate phrases about different topics. The keywords may be used to search the internet or user's background materials for information to be integrated into the prompt sent to the LLM or GenAI.

In one embodiment, the visual layout may use information about the type of response (e.g. yes/no, explicit category or general phrase) to modify the visual layout of the selectable stimuli. In one embodiment, the generated responses may consistently be positive, neutral, or negative relative to the partner prompt. In one embodiment, the generated responses may be refined using techniques such as emotional affect or progressive refinement in which a user indicates that none of the generated responses are what they wanted to say.

The disclosed system may incorporate and interconnect devices to sense a user's environment and the speech and actions of their conversation partner(s) and interpret the data detected using AI. Camera data may be analyzed with AI to detect places and things using scene and object recognition. People and faces may be detected through face detection and tagging. Gestures and emotions may be recognized. Microphone data may be analyzed for speech recognition and to detect additional details from ambient sound. AI may support NLP to recognize language from both foreground and background audio. Both the raw data from these devices as well as the analysis from AI may be used to present suggested utterances and replies to the user through the AR-BCI visual display, a smart device, etc.

In one embodiment, a custom machine learning (ML) trained reply prediction model may be used. This model may be trained on an open-source dataset of language that may be used by the user. In one embodiment, a model may be trained on a dataset comprising the user's written record, including social media, work content, conversation histories, etc. The model may be trained on commercially available models such as Google's Smart Reply or Lobe's “smart” model. The model may be configured to provide three to five responses based on a conversation in progress.

Results of AI analysis may be displayed on an AR headset, smart device, or similar user interface. The display may include recognition event labels of places, objects, people, faces, gestures, and emotions. Speech transcriptions and suggested AI replies may be displayed. For example, statements by the user and conversation partner may be displayed, along with the three to five options for a response generated by AI that the user may select from. Within the AR paradigm, a variety of standard selection techniques may be used, such as “gaze to target and commit,” “gaze to target and finger tap to commit,” “finger tap to target and commit,” “gesture recognition to target and commit,” “gesture recognition to target and finger tap to commit,” “virtual navigation controller,” “physical wand,” “physical switch,” etc. In this manner, the disclosed solution may be highly accessible. It may be feasibly implemented across smartphones, tablets, AR headsets, and other mobile devices. Communication may be facilitated between deaf and hearing parties. The AI used may be run locally, from the cloud, or both. “Cloud computing” refers to a model for enabling convenient, on-demand network access to a shared pool of configurable computing resources (e.g., networks, servers, storage, applications, and services) that may be rapidly provisioned and released with minimal management effort or service provider interaction. This cloud model promotes availability and is comprised of at least five characteristics, at least three service models, and at least four deployment models.

In one embodiment, the underlying language model may be tuned and personalized with reinforcement learning from human feedback using a combination of biographical, authored, or other content generated by a user.

In one embodiment, the system may be used by an operator of a vehicle or machinery. Chat suggestions from the conversation engine may consist of recommended actions to take based on incoming data. This situation may be referred to as “human in the loop”.

In one embodiment, the system may be used by a surgeon, machine operator, or other user who needs an “extra set of eyes.” The conversation engine may support hands-free chat with agents that are monitoring data and biosignals, providing reminders and updates to the user. Chat-based selection, approval, or acknowledgement may be made in the interface with biosignals such as visual evoked potentials (VEPs) and eye-tracking. Adjustments may be set using the refinement engine. The memory engine may have recordings and data of previous operations to compare against the current one.

In one embodiment, the system may be used by the controller of a mobile robot. The perception engine outputs may be converted to directional commands for the robot, supporting discovery of target objects and landmarks by conversing with the user. The user may approve actions and receive information through the conversation engine chat.

In one embodiment, the system may have an auditory instead of visual interface. Chatting with the device may produce synthetic speech to answer questions, give operating instructions, or provide recommendations for actions.

In one embodiment, the system may be used in a military setting. The biosensor may be a wearable device that monitors the user's physical and mental state. The AI system may be used to provide real-time alerts and recommendations to the user based on the data.

In one embodiment, the system may be used in a healthcare setting. The biosensor may be a wearable device that monitors a patient's vital signs and other physiological data. The doctor or patient may use the conversation engine to probe symptoms and biosignal readings.

In another embodiment, the system may be used as a virtual assistant for individuals with disabilities, allowing them to control devices and access information through voice commands and gestures.

In one embodiment, the system may be used in gaming and entertainment applications. Users may control game characters or interact with virtual environments using biosignals and AI-powered suggestions.

In one embodiment, the system may be used in a virtual reality setting. The biosensor may be a wearable device that monitors the user's physical and mental state. The AI system may be used to provide real-time alerts and recommendations to the user based on the data, and to allow the user to control the virtual environment using biosignals.

In another embodiment, the system may be used for educational purposes, such as language learning or skill training. Students may practice conversations and receive feedback through the conversation engine.

In one embodiment, the system may be used in customer service applications. AI-powered chatbots may assist customers with product information, troubleshooting, and other support tasks.

In another embodiment, the system may be used for research and development purposes, such as data analysis or scientific discovery. Researchers may use biosignals and AI-powered suggestions to explore complex datasets and generate new insights.

In one embodiment, the system may be used in home automation applications. Users may control smart devices and access information through voice commands and gestures.

In one embodiment, the system may be used in a smart city setting. The biosensor may be a wearable device that monitors the user's physical and mental state. The AI system may be used to provide real-time alerts and recommendations to the user based on the data, and to allow the user to control smart city devices using biosignals.

In one embodiment, the system may be used in a smart transportation setting. The biosensor may be a wearable device that monitors the user's physical and mental state. The AI system may be used to provide real-time alerts and recommendations to the user based on the data, and to allow the user to control smart transportation devices using biosignals.

In one embodiment, the system may be used in a smart workplace setting. The biosensor may be a wearable device that monitors the user's physical and mental state. The AI system may be used to provide real-time alerts and recommendations to the user based on the data, and to allow the user to control smart workplace devices using biosignals.

In one embodiment, the system may be used in a smart education setting. The biosensor may be a wearable device that monitors the user's physical and mental state. The AI system may be used to provide real-time alerts and recommendations to the user based on the data, and to allow the user to control smart education devices using biosignals.

In one embodiment, the system may be used in a smart entertainment setting. The biosensor may be a wearable device that monitors the user's physical and mental state. The AI system may be used to provide real-time alerts and recommendations to the user based on the data, and to allow the user to control smart entertainment devices using biosignals.

In one embodiment, the system may be used in a smart retail setting. The biosensor may be a wearable device that monitors the user's physical and mental state. The AI system may be used to provide real-time alerts and recommendations to the user based on the data, and to allow the user to control smart retail devices using biosignals.

In one embodiment, the system may be used in a smart finance setting. The biosensor may be a wearable device that monitors the user's physical and mental state. The AI system may be used to provide real-time alerts and recommendations to the user based on the data, and to allow the user to control smart finance devices using biosignals.

In one embodiment, the system may be used in a smart agriculture setting. The biosensor may be a wearable device that monitors the user's physical and mental state. The AI system may be used to provide real-time alerts and recommendations to the user based on the data.

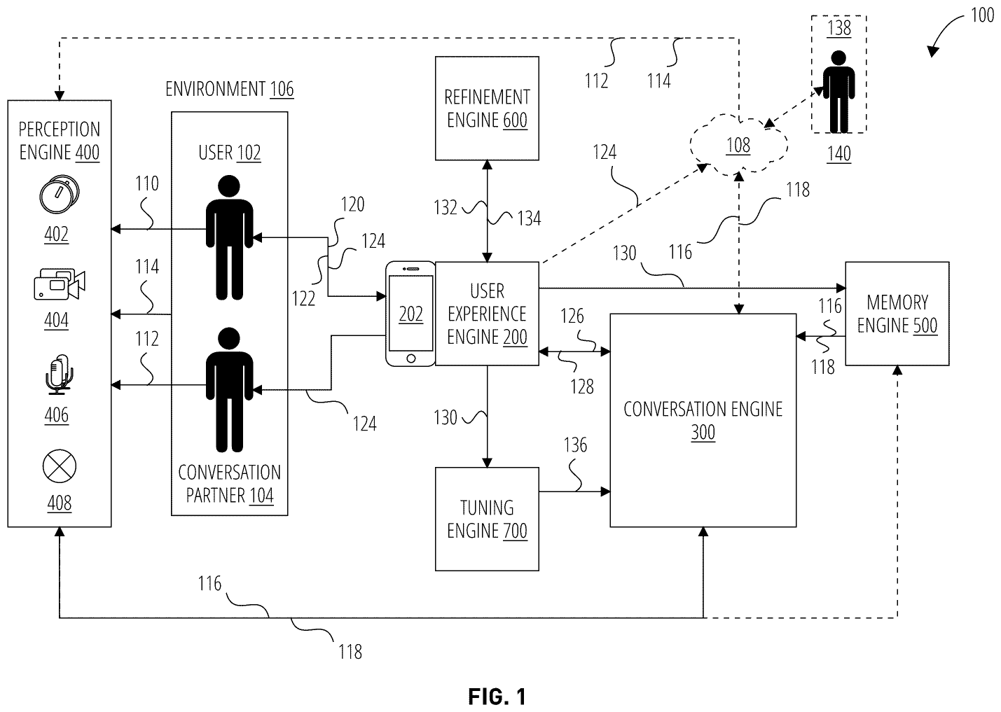

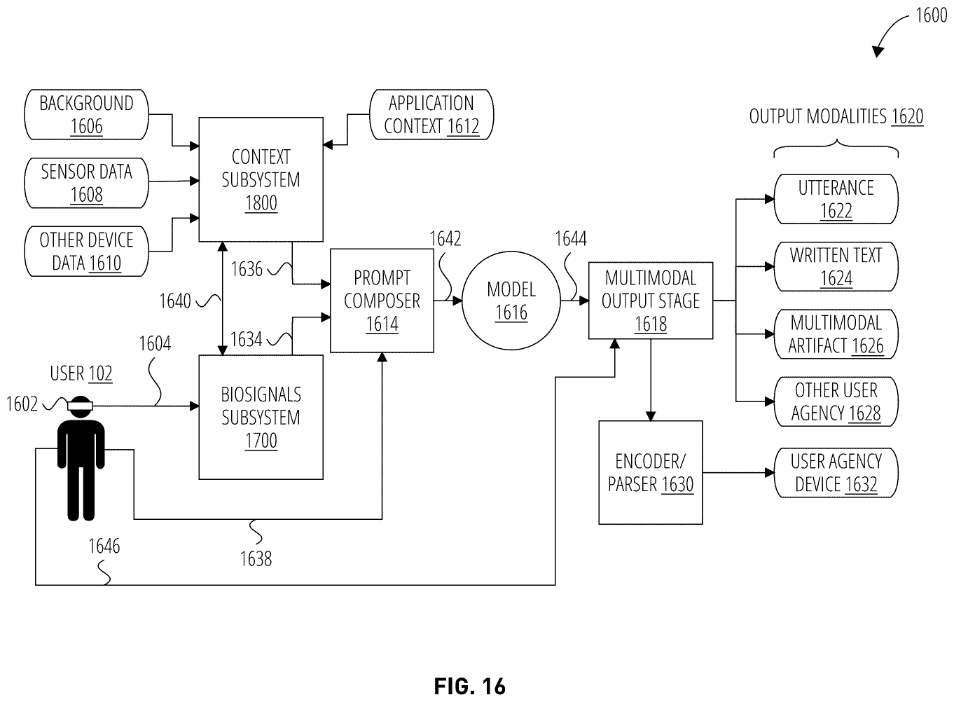

FIG. 1 illustrates a conversation augmentation system 100 in accordance with one embodiment. As will be readily apparent to one of ordinary skill in the art, the conversation augmentation system 100 may be configured as a specialized embodiment of the user agency and capability augmentation system 1600 described in greater detail with respect to FIG. 16 below. Tasks and actions performable by the user agency and capability augmentation system 1600 and its subcomponents described may support operation of the conversation augmentation system 100 disclosed herein.

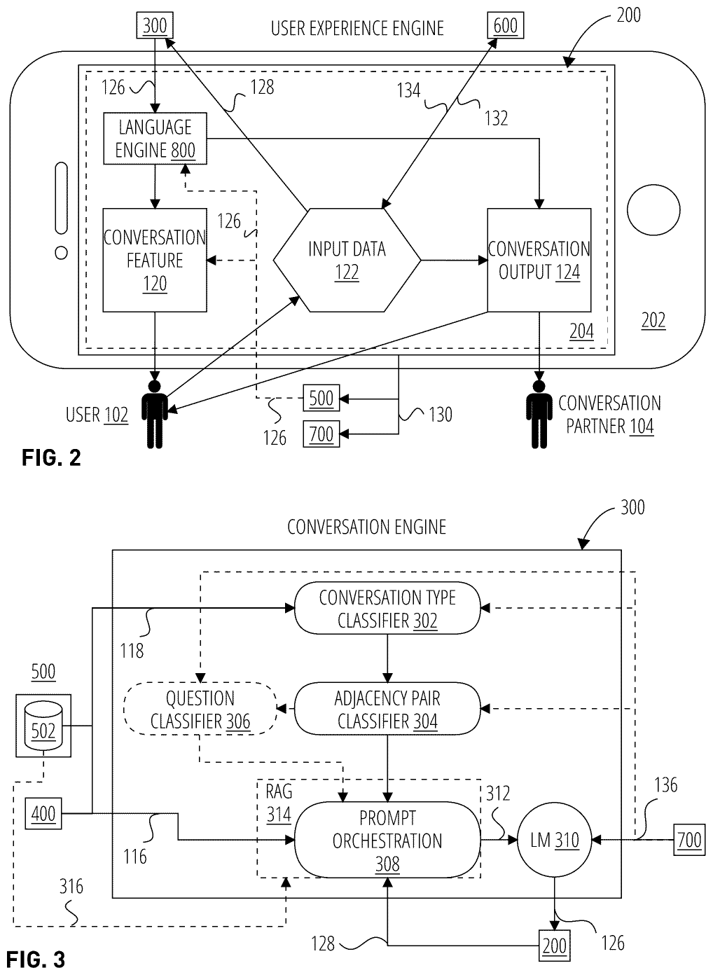

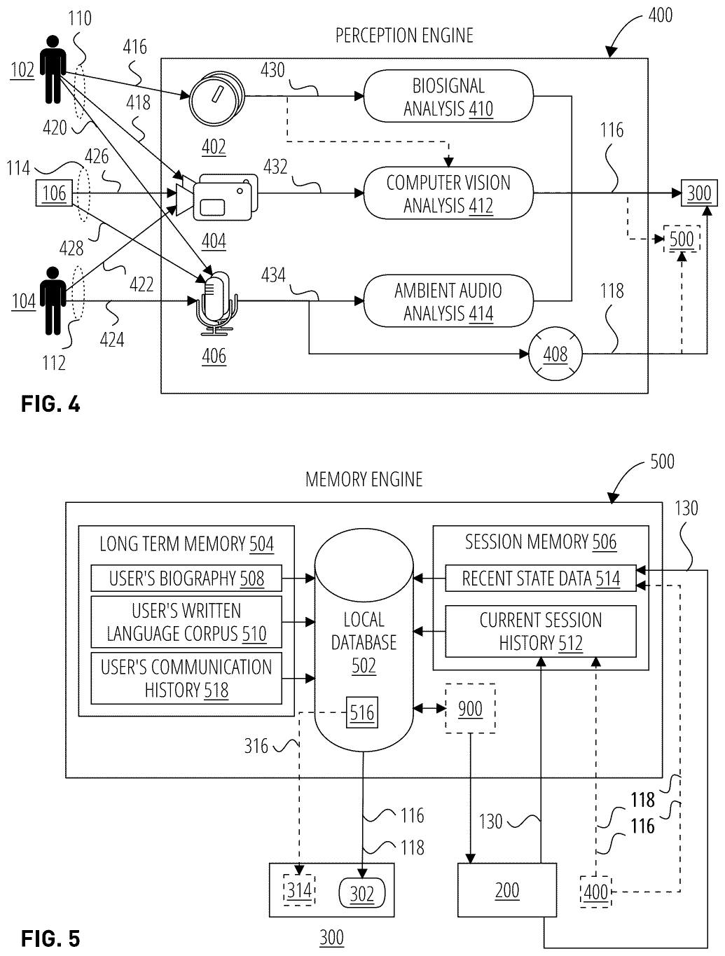

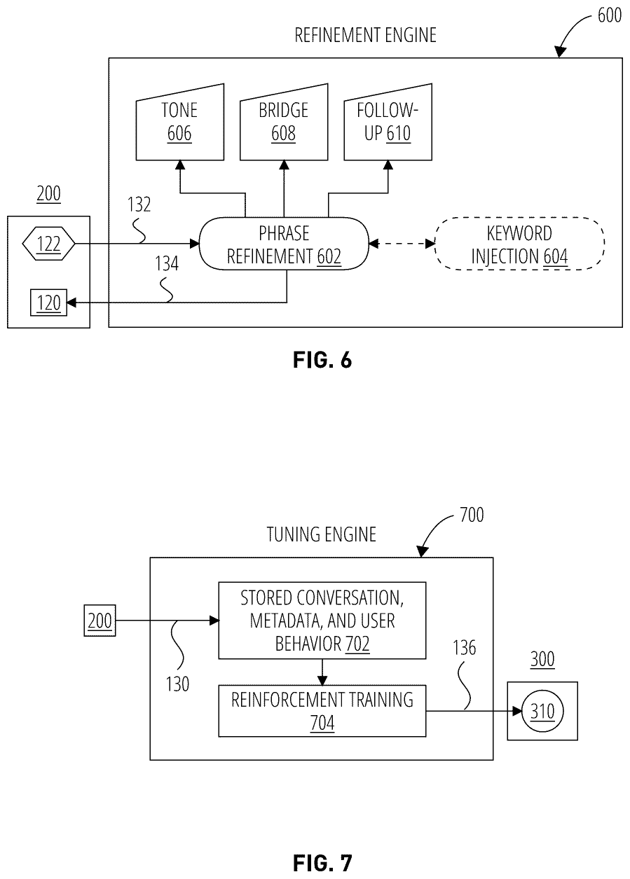

The conversation augmentation system 100 may allow one or more users 102 and one or more conversation partners 104 to engage in a conversation through the action of a user experience engine 200 operable by the user 102 using a mobile computing device 202, a conversation engine 300, a perception engine 400, a memory engine 500, a refinement engine 600, and a tuning engine 700. The user experience engine 200 is described in greater detail with respect to FIG. 2. The conversation engine 300 is described in greater detail with respect to FIG. 3. The perception engine 400 is described in greater detail with respect to FIG. 4. The memory engine 500 is described in greater detail with respect to FIG. 5. The refinement engine 600 is described in greater detail with respect to FIG. 6. The tuning engine 700 is described in greater detail with respect to FIG. 7.

The user 102 may activate the user experience engine 200 to facilitate interaction with one or more conversation partners 104 who may occupy the same environment 106 as the user 102, or who may be remote to the user 102, and may interact with the user 102 via a network 108 connection to the user experience engine 200. In one embodiment, the user may be able to provide user input prompt 128 data to the conversation engine 300 through the user experience engine 200. In another embodiment, the conversation partner 104 may be a generalist agent which has specific domain knowledge. For example, the generalist agent may be trained on a corpus of psychotherapy and may generally engage with the user 102 on therapeutic topics. In another example, the generalist agent may be an expert in a specific contextual domain such as surgery, military equipment, or home repair. In this embodiment the generalist agent may provide advice or guidance to the user 102 through the conversational interface provided by the user experience engine 200.

The perception engine 400 may detect observable user data 110 including biosignals, observable conversation partner data 112 and observable environmental data 114 using various sensors, including biosensors 402, cameras 404, and microphones 406. In one embodiment, the conversation engine 300 may take input from the perception engine 400. This input may include non-language context data 116 related to biosignals provided by the biosensors 402, visual data provided by the cameras 404, and audio data provided by the microphones 406, as well as language context data 118 developed by a speech to text transformer 408 based on vocalizations detected in the audio data. This non-language context data 116 and language context data 118 may be transmitted to the conversation engine 300.

One of ordinary skill in the art will appreciate that similar devices may be present with a remote conversation partner 138. Raw and/or AI-analyzed observable conversation partner data 112 from the remote conversation partner 138 and observable environmental data 114 for the remote environment 140, as well as raw or AI-analyzed non-language context data 116 and language context data 118 from the remote conversation partner 138, may be readily available to the conversation engine 300 as well through a network 108 communication path.

The user experience engine 200 may provide session data 130 to the memory engine 500. The memory engine 500 may store the session data 130 as well as additional background material. The information stored and managed by the memory engine 500 may be provided as non-language context data 116 and language context data 118 to the conversation engine 300. In one embodiment, the perception engine 400 may provide non-language context data 116 and language context data 118 directly to the memory engine 500 for storage and transmission to the conversation engine 300, in addition to and/or as an alternative to transmissions from the user experience engine 200.

Based on the non-language context data 116, language context data 118, user input prompt 128, the conversation engine 300 may develop suggestion data 126 which it may provide to the user experience engine 200, which may use this suggestion data 126 to provide viewable and selectable conversation features 120 to the user 102. The conversation features 120 may include phrase suggestions produced by the conversation engine 300. The user 102 may provide an input data 122 detectable through biosignals, video and audio from the user 102, or touch or other interaction with the mobile computing device 202. The input data may include user input prompt data as well as user selection data indicating a selection among the conversation features 120 presented. In response to the input data 122, the user experience engine 200 may produce conversation outputs 124 available to both the user 102 and the conversation partner 104 directly, or via the network 108 for a remote conversation partner 138.

The user experience engine 200 may interact with a refinement engine 600 to provide refinements upon the suggestion data 126 provided by the conversation engine 300 in order to present better conversation features 120 to the user 102. The user experience engine 200 may present a refinement query 132 to the refinement engine 600 based on input data 122. The refinement engine 600 may then provide refined phrases 134 for presentation as conversation features 120 in the user experience engine 200.

The user experience engine 200 may interact with a tuning engine 700 to provided a closed feedback loop for training of the model or models used by the conversation engine 300. The user experience engine 200 may provide session data 130 to the tuning engine 700, which may analyze the session data 130 and determine model updates 136 to be made. The tuning engine 700 may send the model updates 136 to the memory engine 500, allowing the conversation augmentation system 100 to efficiently train itself and improve over time.

FIG. 2 illustrates a user experience engine 200 in accordance with one embodiment. The user experience engine 200 may present data to and accept data from a user 102 through user 102 interaction with a mobile computing device 202. The mobile computing device 202 may be a smart phone, a tablet, a laptop, an AR-BCI headset, or other device equipped to provide an interface with which a user 102 may interact, as well as host or provide connection to the other elements of the conversation augmentation system 100, such as the conversation engine 300, memory engine 500, refinement engine 600, and tuning engine 700, in order to provide data as previously described.

In one embodiment, the user experience engine 200 may incorporate a generated visual interface 204, which may be available using the mobile computing device 202. The generated visual interface 204 may support text, voice, or gesture inputs to generate text. In one embodiment, the generated visual interface 204 may be provided as part of a companion application installed on the mobile computing device 202. In one embodiment, user experience engine 200 may run on a mobile computing device 202 which may also consume speech without the need of a companion application.

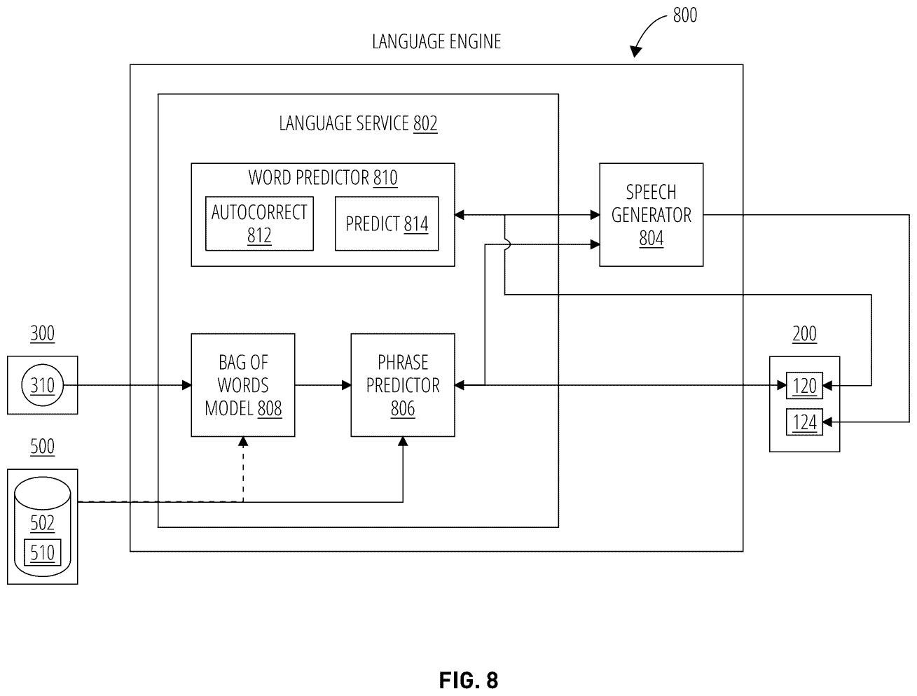

The user experience engine 200 may include a language engine 800 configured to transform the output of the conversation engine 300 into text and/or spoken language for presentation by the user experience engine 200 to the user 102 and/or the conversation partner 104. This is described in greater detail with respect to FIG. 8. In one embodiment, the language engine 800 may be part of the generated visual interface 204 installed on the mobile computing device 202. In one embodiment, the language engine 800 may be available to the user experience engine 200 via a network connection. In one embodiment, a language engine 800 may instead or in addition be included in other portions of the conversation augmentation system 100, such as the conversation engine 300.

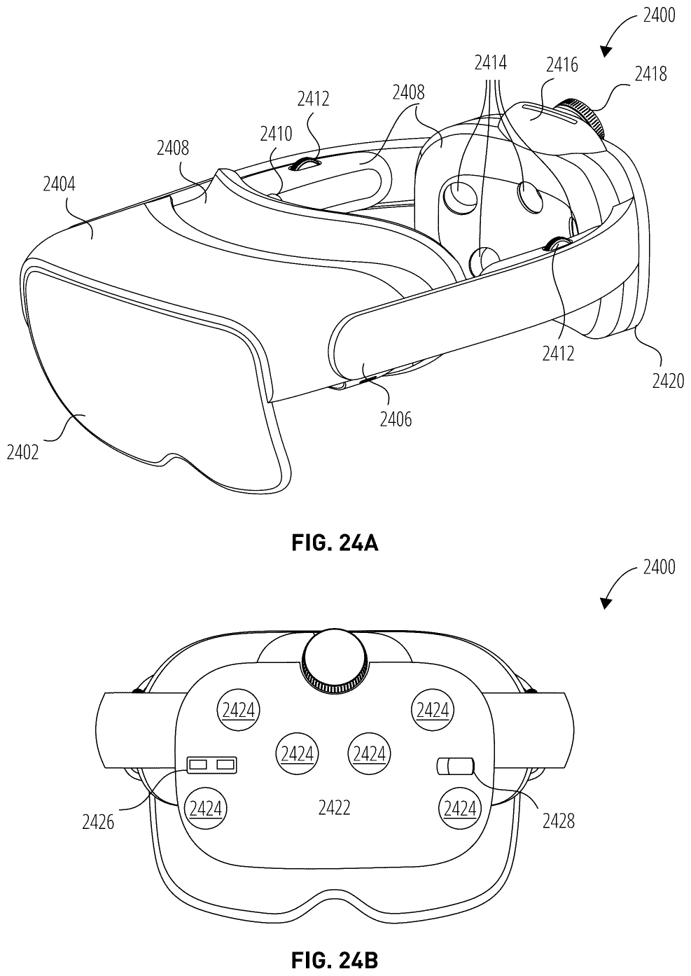

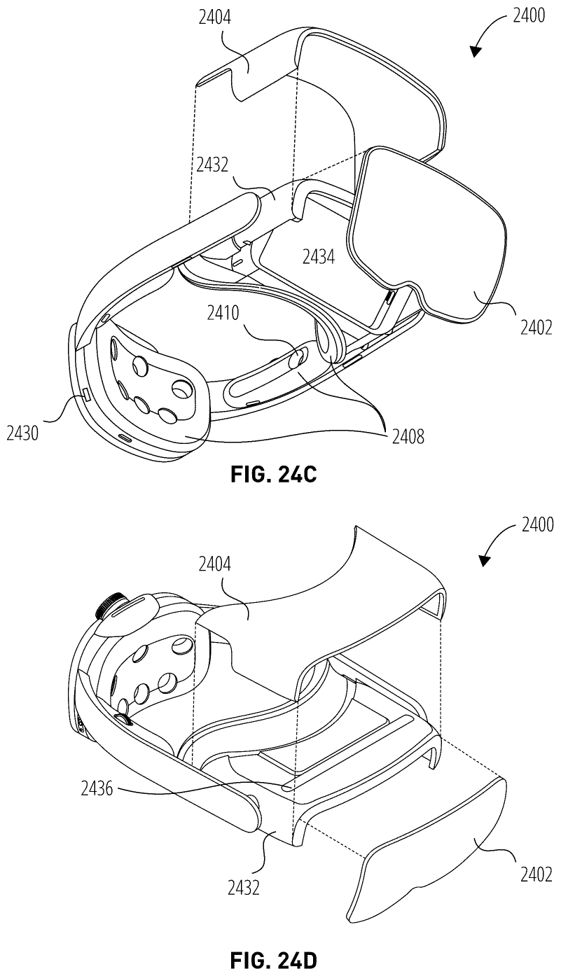

In one embodiment, the mobile computing device 202 providing the user experience engine 200 may be a smart phone 2434, which may stand alone or may be integrated with a wearable computing and biosignal sensing device 1602 such as the BCI headset system 2400, each of which is described in greater detail with respect to FIG. 16 and FIG. 24A-FIG. 24D. The user experience engine 200 may further incorporate the multimodal output stage 1618 and encoder/parser 1630 of the user agency and capability augmentation system 1600.

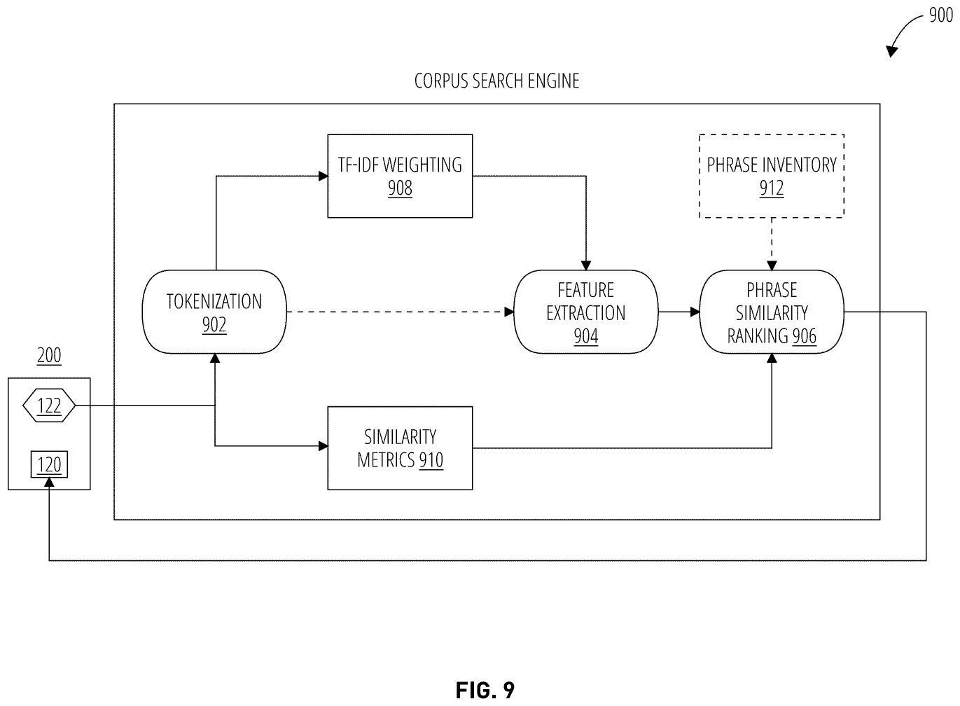

In one embodiment, the memory engine 500 may include a corpus search engine 900 as described in greater detail with respect to FIG. 9. The corpus search engine 900 may allow the memory engine 500 to provide suggestion data 126 directly to the user experience engine 200. This suggestion data 126 may be enhanced or transformed by the language engine 800. Alternatively or in addition, the suggestion data 126 may be available for use in the conversation feature 120 provided to the user 102.

FIG. 3 illustrates a conversation engine 300 in accordance with one embodiment. The conversation engine 300 may include a conversation type classifier 302, an adjacency pair classifier 304, a question classifier 306, a prompt orchestration 308, and a conversation language model 310.

The conversation engine 300 may receive non-language context data 116 from the perception engine 400. The non-language context data 116 may include raw or analyzed audio, video, and biosignal data from the cameras 404, microphones 406, and biosensors 402 of the perception engine 400. In one embodiment, the non-language context data 116 may include sensor data 1608 and other device data 1610 described in more detail below. The non-language context data 116 may be sent to the prompt orchestration 308 for tokenization or other processing in order to inform prompts to be provided to the conversation language model 310.

The conversation engine 300 may receive language context data 118 from both the perception engine 400 and the memory engine 500, as described in greater detail below. In one embodiment, the language context data 118 may include background material 1606 and application context 1612 as are provided with respect to the user agency and capability augmentation system 1600. The conversation engine 300 may use the conversation type classifier 302, adjacency pair classifier 304, and question classifier 306 to analyze, tokenize, or otherwise process the language context data 118 in order to inform the prompt orchestration 308 to develop suitable prompts for the conversation language model 310. The conversation type classifier 302, adjacency pair classifier 304, and question classifier 306 may utilize machine learning or AI to analyze the language context data 118.

In one embodiment, retrieval augmented generation 314 (RAG) may be implemented to improve the performance of prompt orchestration 308 for the conversation language model 310 based on the user-specialized dataset available through the memory engine 500. The local database 502 of the memory engine 500 may be used to store RAG vectors 316 in a vector index 516 for use in retrieval augmented generation 314.

The prompt orchestration 308 may incorporate some or all elements of the context subsystem 1800, biosignals subsystem 1700, and prompt composer 1614. In a manner similar to that described for these elements below, the prompt orchestration 308 may process the non-language context data 116 such as background material 1606 and wearable computing and biosignal sensing device 1602, as well as the biosignals 1604, sensor data 1608, and other device data 1610 to form biosignals prompts 1634 and context prompts 1636 which may be used by a prompt composer 1614 along with a user input prompt 128 received from the user experience engine 200, analogous to the user input prompt 1638 introduced in FIG. 16, to create effective prompts 312 for the conversation language model 310.

The conversation language model 310 may receive prompts 312 from prompt orchestration 308, similar to the manner in which the model 1616 receives prompts 1642 from the prompt composer 1614. Based on the prompts 312, the conversation language model 310 may develop suggestion data 126, which it may send to the user experience engine 200 for presentation to the user 102. In one embodiment, the conversation language model 310 may receive model updates 136 from the tuning engine 700, allowing the conversation language model 310 to be self-improving as it supports a user 102 in additional conversations over the course of time. In one embodiment, the conversation type classifier 302, adjacency pair classifier 304, and question classifier 306 may also receive model updates 136 from the tuning engine 700.

In one embodiment, the conversation language model 310 is a single LLM or GenAI model. In one embodiment, the conversation language model 310 may include multiple LLMs or GenAI models each queryable by prompt orchestration 308. The prompt orchestration 308 may include multiple logic modules able to provide the appropriate weighting and inputs to a specific model among the conversation language models 310 to provide the most efficient and accurate results. Conversation language models 310 may include GPT, Llama, PaLM, or other models as are available in the industry, either as provided off the shelf or trained for specific aspects of conversation augmentation system 100 use, in addition to custom models built and trained for specific applications.

In one embodiment, the conversation engine 300 may include a language engine 800 such as was introduced with respect to FIG. 2 and described in greater detail below. In this manner, the suggestion data 126 from the conversation engine 300 may incorporate natural language text data, and may include audio data for spoken natural language.

FIG. 4 illustrates a perception engine 400 in accordance with one embodiment. The perception engine 400 may comprise one or more biosensors 402, cameras 404, and microphones 406, along with a speech to text transformer 408, as well as logic modules and/or AI models for performing biosignal analysis 410, computer vision analysis 412, and ambient audio analysis 414.

The perception engine 400 may receive observable user data 110 from a user 102. The observable user data 110 may include measurable user physiological activity 416 that may be detected and quantified by the biosensors 402. The measurable user physiological activity 416 may include EEG signals, heart rate, movement and other such activities and motions by the user 102. The observable user data 110 may also include visible user state and activity 418 that may be detected by the cameras 404. The visible user state and activity 418 may indicate gestures, gaze direction, facial expression, and other indications of state or activity of the user 102. The observable user data 110 may include user vocalizations 420 detected by the microphones 406.

The perception engine 400 may receive observable conversation partner data 112 from one or more conversation partners 104 and/or remote conversation partners 138. The observable conversation partner data 112 may include visible conversation partner state and activity 422 detectable by the camera 404. This may include similar data as the visible user state and activity 418. The observable conversation partner data 112 may also include conversation partner vocalizations 424 detectable by the microphones 406, similar to the user vocalizations 420.

The perception engine 400 may receive observable environmental data 114 from the environment 106 around the user 102 and conversation partner 104. In one embodiment, where the conversation partner is a remote conversation partner 138, observable environmental data 114 may include data from the remove remote environment 140 of the remote conversation partner 138, available via sensors in proximity to the remote conversation partner 138 and transmitted over a network 108. The observable environmental data 114 may include visible ambient state and activity 426 detectable by the cameras 404 and ambient sounds 428 detectable by the microphones 406.

The biosensors 402 of the perception engine 400 may provide biosignals 430 for biosignal analysis 410. Such analysis may include digital processing techniques and interpretation techniques that are well understood by those of ordinary skill in the art. In one embodiment, the biosignal analysis 410 may be performed by AI or ML models specially trained for this purpose. The cameras 404 of the perception engine 400 may similarly provide visual data 432 for computer vision analysis 412 and the microphones 406 may provide audio data 434 for both the speech to text transformer 408 and for ambient audio analysis 414. The speech to text transformer 408, computer vision analysis 412, and ambient audio analysis 414 may in one embodiment be performed by specially trained AI or ML models.

Through the action of the speech to text transformer 408, the perception engine 400 may develop language context data 118 that may be transmitted to the conversation engine 300. Through the action of biosignal analysis 410, computer vision analysis 412, and ambient audio analysis 414, the perception engine 400 may develop non-language context data 116 that may be transmitted to the conversation engine 300. In one embodiment, the non-language context data 116 and language context data 118 may also be transmitted from the perception engine 400 to the memory engine 500. In one embodiment, the non-language context data 116 and language context data 118 may also be tokenized by the speech to text transformer 408, biosignal analysis 410, computer vision analysis 412, and ambient audio analysis 414, and these tokens may be provided to the conversation engine 300.

In one embodiment, the biosensors 402 of the perception engine 400 may be included in additional biosensors having wired or wireless connection to the perception engine 400, or on a smartphone or other mobile computing device, such as the mobile computing device 202 used in conjunction with the user experience engine 200. The cameras 404 and microphones 406 may be devices built into commercially available mobile computing devices or may otherwise be in wired or wireless communication with the perception engine 400.

The perception engine 400 may thus embody portions of the wearable computing and biosignal sensing device 1602, the biosignals subsystem 1700, and the context subsystem 1800 of the user agency and capability augmentation system 1600 presented in FIG. 16. The non-language context data 116 may be used as sensor data 1608 and other device data 1610 as described for the user agency and capability augmentation system 1600.

FIG. 5 illustrates a memory engine 500 in accordance with one embodiment. The memory engine 500 may include a local database 502 in communication with long term memory 504 and with session memory 506. Long term memory 504 may store data such as the user's biographical background 508, user's written language corpus 510, and user's communication history 518. Such data may be available as images, videos, audio recordings, etc., in addition to written text.

Session memory 506 may include current session history 512 and recent state data 514. These may be available as session data 130 from the user experience engine 200 and/or as non-language context data 116 and language context data 118 from the perception engine 400. In one embodiment, data in session memory 506 may be written to long term memory 504 during a session or when the session ends, for inclusion in the user's communication history 518, user's written language corpus 510, and/or user's biographical background 508, or an additional category of stored background material.

In one embodiment, retrieval augmented generation 314 (RAG) may be implemented by the conversation engine 300 to improve the performance of prompt orchestration 308 for the conversation language model 310 based on the user-specialized dataset available through the memory engine 500. The data available in the local database 502 and/or the long term memory 504 and session memory 506 may be indexed by a tool such as LlamaIndex or a structured query language (SQL) database for improved retrieval performance through retrieval augmented generation 314. The local database 502 of the memory engine 500 may be used to store the RAG vectors 316 generated for the memory engine 500 data in a vector index 516 for use in retrieval augmented generation 314.

The local database 502 may provide non-language context data 116 and language context data 118 it retrieves from long term memory 504 and/or session memory 506 to the conversation engine 300 as non-language context data 116 and language context data 118. This language context data 118 and session data 130 may comprise, for example, the background material 1606, sensor data 1608, other device data 1610, and application context 1612 described more fully with respect to the user agency and capability augmentation system 1600 illustrated in FIG. 16.

FIG. 6 illustrates a refinement engine 600 in accordance with one embodiment. The refinement engine 600 may include phrase refinement 602, which may develop refinements based on tone 606, bridges 608 between conversation concepts and phrases, and follow-up 610 on previous phrases. The refinement engine 600 may also include keyword injection 604.

The refinement engine 600 may accept refinement queries 132 from the user experience engine 200 based on input data 122. The phrase refinement 602 and keyword injection 604 may be AI or ML modules trained to analyze the data available in the refinement queries 132, such as the present conversation state and specific user input prompts or selections. The phrase refinement 602 may communicate with keyword injection 604 in one embodiment to include specific keywords or concepts related to the present conversation state or user input. The phrase refinement 602 may return refined phrases 134 to the user experience engine 200 for use in the ongoing conversation.

FIG. 7 illustrates a tuning engine 700 in accordance with one embodiment. The tuning engine 700 may accept session data 130 from the user experience engine 200, and may use the session data 130, along with stored conversation, metadata, and user behavior 702, as inputs for reinforcement training 704 of the conversation language model 310. Reinforcement training 704 may be performed and model updates 136 made to the conversation language model 310 of the conversation engine 300.

FIG. 8 illustrates a language engine 800 in accordance with one embodiment. The language engine 800 may include a language service 802 and a speech generator 804. The language service 802 may include a phrase predictor 806, a bag of words model 808, and a word predictor 810 including an autocorrect engine 812 and a prediction engine 814.

The language service 802 may communicate with the conversation language model 310 of the conversation engine 300. In one embodiment, the conversation language model 310 may be a cloud hosted language model. This may include a transformer-based cloud corrector, such as ChatGPT. The language service 802 may also be in communication with a context service, including a context estimator. This may be embodied by the memory engine 500, with access to context data such as the user's written language corpus 510. In this manner, the language engine 800 may prioritize produced language that aligns with a user's known patterns of communication, both textual and non-textual. The memory engine 500 may also provide as context data any of the data available in the local database 502.

The phrase predictor 806 may take in data from the memory engine 500 and may use this data to generate phrase predictions. These phrase predictions may be further informed by data from the bag of words model 808. In one embodiment, the phrase predictor 806 may be called upon by an input from the speech generator 804 or the application hosting the speech generator 804, such as a heads up display (HUD) keyboard event. In one embodiment, the bag of words model 808 may be supported by an on-device model with access to the user's user's written language corpus 510, such as GPT-2. In one embodiment, the bag of words model 808 may be a singular value decomposition (SVD) model with access to related terms and personalized phrases from the memory engine 500.

In one embodiment, the language service 802 may include and the speech generator 804 may call upon a word predictor 810. The word predictor 810 may correct a current word from the speech generator 804 and predict a next word. The word predictor 810 may include an autocorrect engine 812. In one embodiment, the word predictor 810 may include a prediction engine 814 such as NGram Predict.

Through the operation of the phrase predictor 806, bag of words model 808, and word predictor 810, the language service 802 may provide data to the user experience engine 200 in support of the conversation feature 120 text presented by the user experience engine 200 to the user 102. The language service 802 may further provide data to the speech generator 804, which may produce conversation output 124 based on that data, including audible speech, which it may provide to the user experience engine 200.

FIG. 9 illustrates a corpus search engine 900 in accordance with one embodiment. The corpus search engine 900 may include tokenization 902, feature extraction 904 and dimensionality reduction with, e.g., singular value decomposition (SVD), and phrase similarity ranking 906 with a weighting technique such as term frequency-inverse document frequency weighting 908 or BM25 weighting. Additional similarity metrics 910 may be used in retrieval and ranking of results from the corpus search engine. The corpus search engine 900 may provide a rapid path to search existing token sequences stored and managed in the memory engine 500 based on input data 122 from the user experience engine 200 to provide conversation feature 120.

The corpus search engine 900 may take input data 122 from the user experience engine 200, and may pass that data through tokenization 902. In one embodiment the data from input data 122 may be analyzed with respect to the similarity metrics 910.

The tokenized data from tokenization 902 may be passed to term frequency-inverse document frequency weighting 908. The weighted output of the term frequency-inverse document frequency weighting 908 may then be provided to the feature extraction 904 model. In one embodiment, the output from tokenization 902 may pass directly to feature extraction 904.

The output from the feature extraction 904 model and the similarity metrics 910 may be provided to a phrase similarity ranking 906 model. In one embodiment, the phrase similarity ranking 906 may also be applied to the contents of a phrase inventory 912. The phrase similarity ranking 906 may provide phrases exhibiting a high ranking and/or weighting to the user experience engine 200 for use as conversation feature 120. In this manner, context data available in the memory engine 500 may be quickly correlated with information from the current session, and the corpus search engine 900 may thus provide highly relevant text for use in the conversation feature 120 provided to the user 102 by the user experience engine 200.

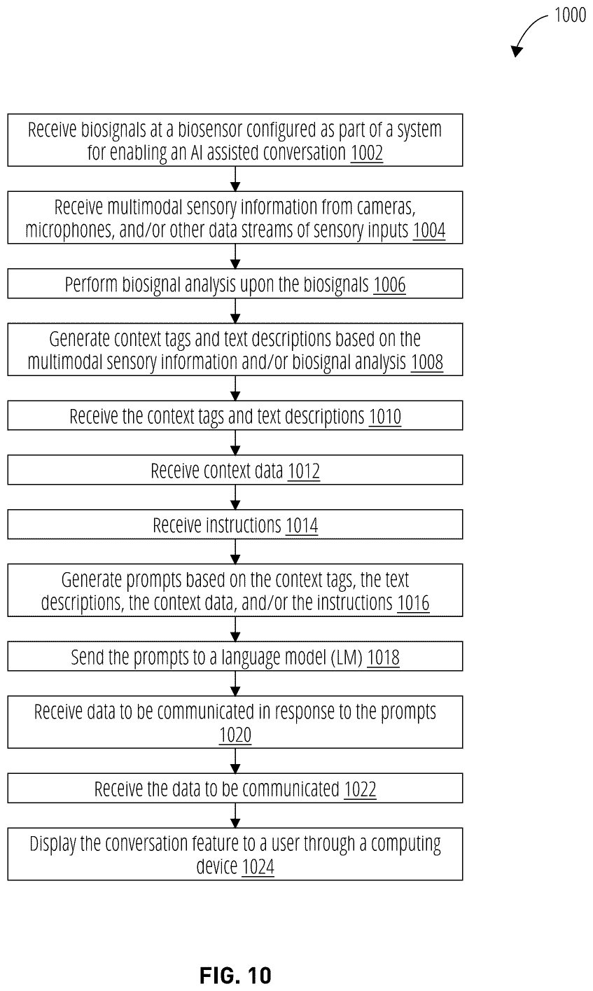

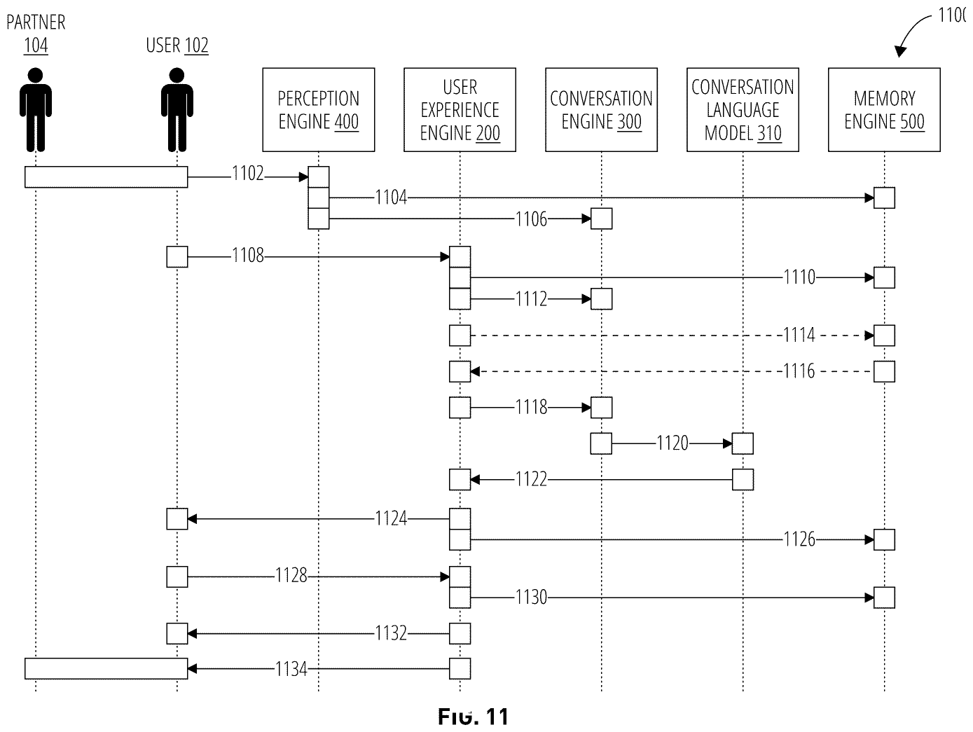

FIG. 10 illustrates an example routine 1000 for operation of the conversation augmentation system 100 introduced in FIG. 1. Although the example routine 1000 depicts a particular sequence of operations, the sequence may be altered without departing from the scope of the present disclosure. For example, some of the operations depicted may be performed in parallel or in a different sequence that does not materially affect the function of the routine 1000. In other examples, different components of an example device or system that implements the routine 1000 may perform functions at substantially the same time or in a specific sequence.

According to some examples, the method includes receiving biosignals at a biosensor configured as part of a system for enabling an AI assisted conversation at block 1002. For example, the perception engine 400 illustrated in FIG. 4 may receive biosignals at a biosensor configured as part of a system for enabling an AI assisted conversation. The perception engine may be configured with biosensors, cameras, and/or microphones, a speech to text transformer, and logic or AI or ML models to perform biosignal analysis, computer vision analysis, and ambient audio analysis.

According to some examples, the method includes receiving multimodal sensory information from cameras, microphones, and/or other data streams of sensory inputs at block 1004. For example, the perception engine 400 illustrated in FIG. 4 may receive multimodal sensory information from cameras, microphones, and/or other data streams of sensory inputs. The perception engine may be configured to receive sensory input and parse biosignals. The sensory input may be audio data, visual data, and/or haptic feedback data.

According to some examples, the method includes performing biosignal analysis upon the biosignals at block 1006. For example, the perception engine 400 illustrated in FIG. 4 may perform biosignal analysis upon the biosignals. The perception engine may further perform computer vision analysis upon visual data from the cameras, ambient audio analysis upon audible data from the microphones, and/or speech to text transformation upon audible data from the microphones.

According to some examples, the method includes generating context tags and text descriptions based on the multimodal sensory information and/or biosignal analysis at block 1008. For example, the perception engine 400 illustrated in FIG. 4 may generate context tags and text descriptions based on the multimodal sensory information and/or biosignal analysis.

According to some examples, the method includes receiving the context tags and text descriptions at block 1010. For example, the conversation engine 300 illustrated in FIG. 3 may receive the context tags and text descriptions.

According to some examples, the method includes receiving context data at block 1012. For example, the conversation engine 300 illustrated in FIG. 3 may receive context data. The context data may be received from a memory engine configured to store, catalog, and/or serve the context data. The memory engine may include a local database in communication with long term memory and session memory. The local database may include biographical background and/or a written language corpus of the user. The session memory may include current session history and/or recent state data. The context data may include conversation history, biographical background, keywords, and/or other ancillary data. The conversation engine may receive non-language context data and/or language context data from the perception engine, and language context data from the memory engine.

According to some examples, the method includes receiving instructions at block 1014. For example, the conversation engine 300 illustrated in FIG. 3 may receive instructions. The instructions may be received from a user experience engine configured to allow a user view and/or select the conversation feature through a generated visual interface. The conversation feature may include communication history, the context data, and data to be communicated, which may be selectable using the biosensor. The conversation engine may include a conversation type classifier, an adjacency pair classifier, a question classifier, a prompt orchestration, and/or a conversation language model.

According to some examples, the method includes generating prompts based on the context tags, the text descriptions, the context data, and/or the instructions at block 1016. For example, the conversation engine 300 illustrated in FIG. 3 may generate prompts based on the context tags, the text descriptions, the context data, and/or the instructions.

According to some examples, the method includes sending the prompts to a language model (LM) at block 1018. For example, the conversation engine 300 illustrated in FIG. 3 may send the prompts to a language model (LM).

According to some examples, the method includes receiving data to be communicated in response to the prompts at block 1020. For example, the conversation engine 300 illustrated in FIG. 3 may receive data to be communicated in response to the prompts. In one embodiment, the language model receives prompts from the prompt orchestration and computes suggestion data that is sent to the user experience engine for presentation to the user.

According to some examples, the method includes receiving the data to be communicated at block 1022. For example, the user experience engine 200 illustrated in FIG. 2 may receive the data to be communicated. The user experience engine may include a language engine configured to transform conversation engine output into text or spoken language for presentation to at least one of the user and the conversation partner.

According to some examples, the method includes displaying the conversation feature to a user through a computing device at block 1024. For example, the user experience engine 200 illustrated in FIG. 2 may display the conversation feature to a user through a computing device. The computing device may be configured to use the user experience engine to present the conversation feature to the user and accept input data from the user. The computing device may be a brain computer interface (BCI) system including at least one wearable biosensor. The user experience engine may further accept the input data from the user. The input data may include a selection of the conversation feature. The user experience engine may further generate a communication to one or more conversation partners based on the conversation feature. The conversation partner may be a human partner and/or a machine agent.

In one embodiment, a refinement engine may accept input data indicating a request to refine the data to be communicated. The refinement engine may be configured to allow the user to approve and modify responses before generating a conversation output. The refinement engine may include phrase refinement configured to develop refinements based on tone, bridges between conversation concepts and phrases, and/or follow-up on previous phrases.

A companion application may in one embodiment present the communication to the conversation partner as written text and/or spoken language. The companion application may be a network-connected companion application. The companion application may in one embodiment be integrated into a network-connected communication application.

A tuning engine may be configured to fine-tune the LM to improve suggestions and personalize the LM for the user. The tuning engine may accept session data from the user experience engine. The tuning engine may use the session data along with stored conversation, metadata, and user behavior, to generate reinforcement training inputs for the LM.

FIG. 11 illustrates an operation sequence diagram 1100 in accordance with one embodiment. The operation sequence diagram 1100 illustrates interactions during operation of the conversation augmentation system 100 as part of a conversation between at least one user 102 and at least one conversation partner 104. These operations primarily involve the illustrated components: namely, the perception engine 400, user experience engine 200, conversation engine 300, conversation language model 310, and memory engine 500. However, operation of these components may involve additional interactions as described above, and the operation sequence diagram 1100 is intended to illustrate operation at a high level, and not to limit operation to the activities and components shown.

A session or a portion of a session may begin with speech or other perceptible actions 1102 on the part of the user 102 and/or the conversation partner 104. The perceptible actions 1102 may be detected by the perception engine 400. The perception engine 400 may send perceived data 1104 based on the perceptible actions 1102 to the memory engine 500 for storage as part of the current session history 512. The perception engine 400 may further send perceived data 1106 to the conversation engine 300. This data may trigger a query operation of the conversation engine 300, may include context for the conversation engine 300 to operate upon, etc.

The user 102 may as part of the current session provide a user input 1108 to the user experience engine 200. The user experience engine 200 may send the user input 1110 to the memory engine 500 for storage as part of the current session history 512. The user experience engine 200 may send the user input 1112 to the conversation engine 300 as well. The user input 1108 may include signals capturing speech, typed text, BCI-supported selections, etc. In one embodiment, the user experience engine 200 may send a request RAG vectors 1114 to the memory engine 500. This may be performed to improve access to the data within the memory engine 500, and thus speed up operation of the conversation engine 300 in generating output for the conversation. The 500 may return RAG vectors 1116 to the user experience engine 200.

Based on the data received from the conversation partner 104, the user 102, and the memory engine 500, the mobile computing device 202 may query 1118 the conversation engine 300 for suggestions to be presented to the user 102 to facilitate conversation with the conversation partner 104. The include data from these named sources and from other portions of the conversation augmentation system 100 as appropriate and previously described. From this data, the conversation engine 300 may generate and transmit a prompt 1120 to the conversation language model 310. In response, the conversation language model 310 may generate and send phrases 1122 to the user experience engine 200.

The user experience engine 200 may display the phrases 1124 to the user 102 for selection among them. The user experience engine 200 may in one embodiment send the displayed phrases 1126 to the memory engine 500 to be stored as part of the current session history 512. The user 102 may make a phrase selection 1128 using the user experience engine 200. The user experience engine 200 may send the user phrase selection 1130 to the memory engine 500 for storage as part of the current session history 512. The user experience engine 200 may also display the user's selected phrase 1132 to the user 102, and may speak the user's selected phrase 1134 such that it is audible to both the user 102 and the conversation partner 104.

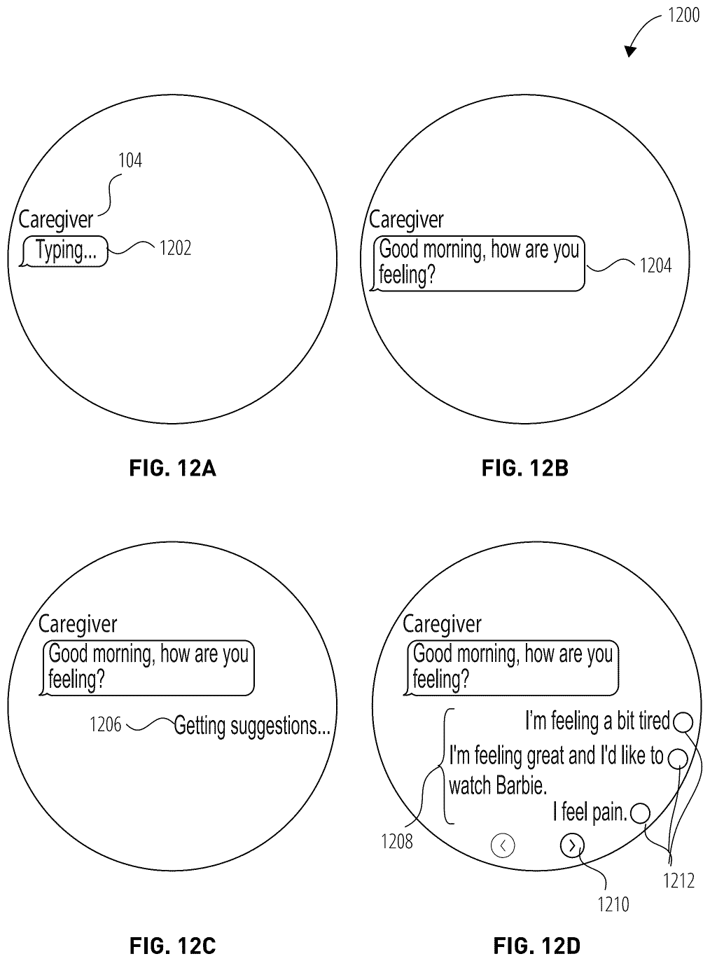

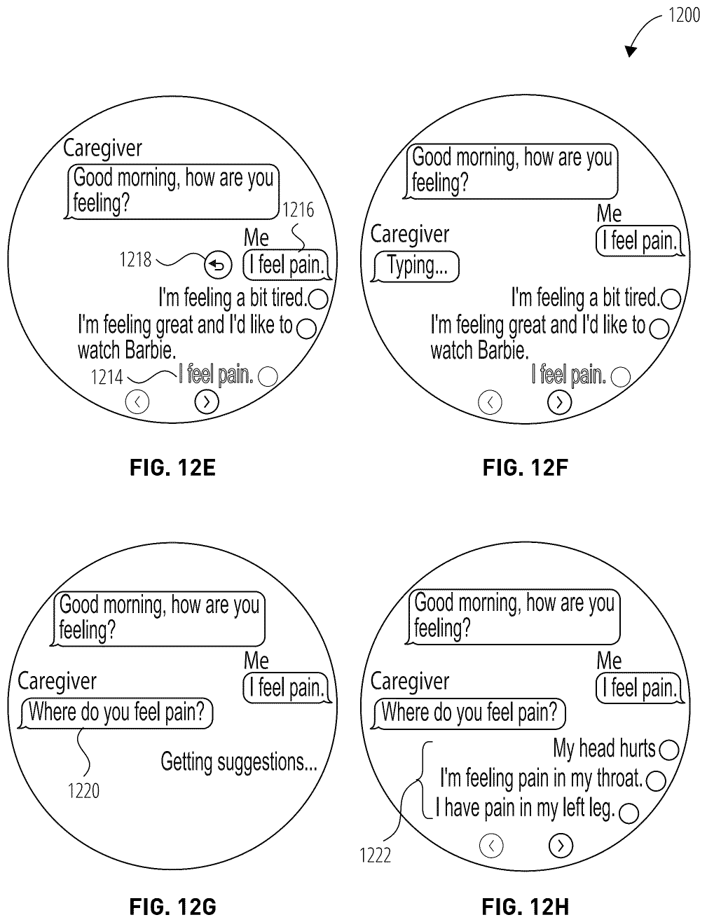

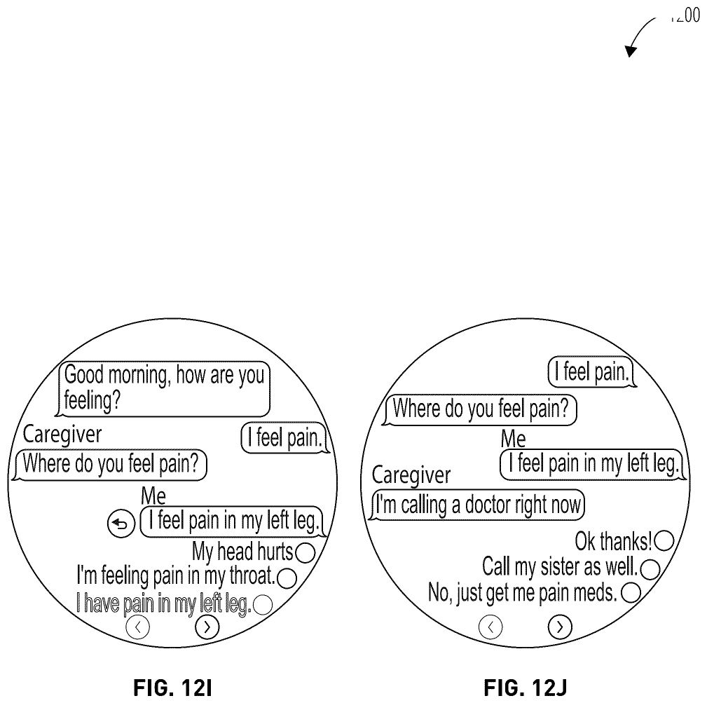

FIG. 12A-FIG. 12J illustrate an exemplary user interface 1200 in accordance with one embodiment. The user 102 may initiate a conversation by activating the conversation augmentation system 100. This activation may include opening an application, and/or the user experience engine 200, on a mobile computing device 202, for example. The mobile computing device 202 may be a laptop computer, a smartphone, a tablet, a personal digital assistant, a BCI headset system as described in FIG. 24A-FIG. 24D, etc.

In one embodiment, a conversation activation signal may be sent to alert a conversation partner 104, such as a caregiver, that a conversation is open. When the conversation partner 104 is engaging with the user experience engine 200, a status message 1202 may be displayed, as shown in FIG. 12A, providing confirmation to the user 102 that the conversation partner 104 is currently typing, for example.

The conversation partner 104 such as a caregiver may begin the conversation with a check-in message 1204 as shown in FIG. 12B. In one embodiment, the conversation partner 104 may initiate or open the conversation with such a check-in message 1204, and a conversation activation signal may be sent to alert the user 102 that a conversation is open.

The user experience engine 200 may analyze the check-in message 1204, as well as context such as conversation history, etc., available from the memory engine 500, to query the conversation engine 300 for response suggestions to display. A status message 1206 may confirm to the user 102 that the conversation augmentation system 100 is working on this task, as shown in FIG. 12C.

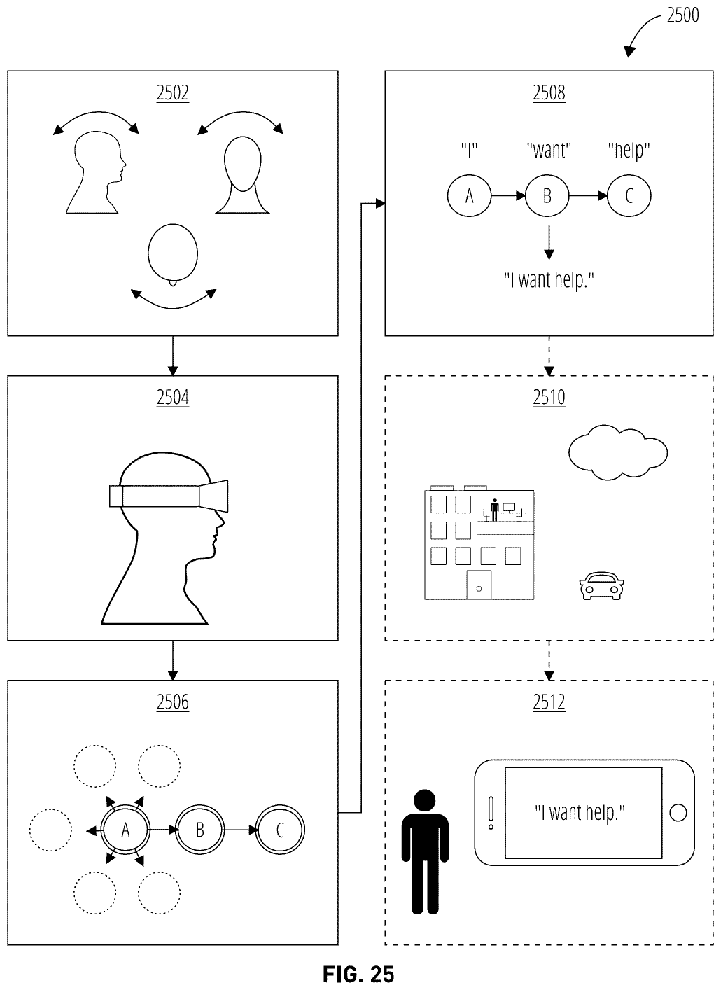

The user experience engine 200 may offer displayed suggestions 1208 as shown in FIG. 12D. In one embodiment, three suggestions deemed the best match for the conversation based on the input data may be displayed, and suggestion navigation controls 1210 may be offered to allow the user 102 to bring additional displayed suggestions 1208 to the screen where those shown are not suitable. The displayed suggestions 1208 may be associated with selection controls 1212. The selection control 1212 may be tapped by the user 102, may be associated with labels that may facilitate vocal selection by the user 102, or may be selectable using biosignals, including visually evoked potentials, as described with respect to FIG. 25-FIG. 29.

The user's selection 1214 made as described above may be visually highlighted and/or provided as a selection preview 1216, as shown in FIG. 12E. A similarly selectable send control 1218 may be provided allowing the user 102 to send their selection 1214 as a message to the conversation partner 104, as shown in FIG. 12F. For example, FIG. 12D-FIG. 12F illustrate how a user may be presented with suggested messages including “I feel pain.” The user 102 may select this option and send it to notify the caregiver conversation partner 104 of this issue.

As shown in FIG. 12G, the conversation partner 104 may send a follow-up message 1220 to get more information about the pain the user 102 is experiencing. The conversation augmentation system 100 may again use available inputs to generate displayed suggestions 1222 as shown in FIG. 12H. Where a user 102 has medical history available as context or background data, the displayed suggestions 1222 could be suggestions containing content and/or prioritized in a manner that is tailored to or weighted toward that medical history.

The integration of the conversation augmentation system 100 with network-based communication systems as described herein may allow the conversation partner 104 to provide direct support of the user 102, as shown in FIG. 12I and FIG. 12J. The user 102 may be able to specify pain in an area that the conversation partner 104 may recognize as being of particular medical import to the user 102. This may guide the conversation partner 104 to call a doctor for the user, as indicated in FIG. 12J, while allowing the user to confirm that action or select a different course of action.

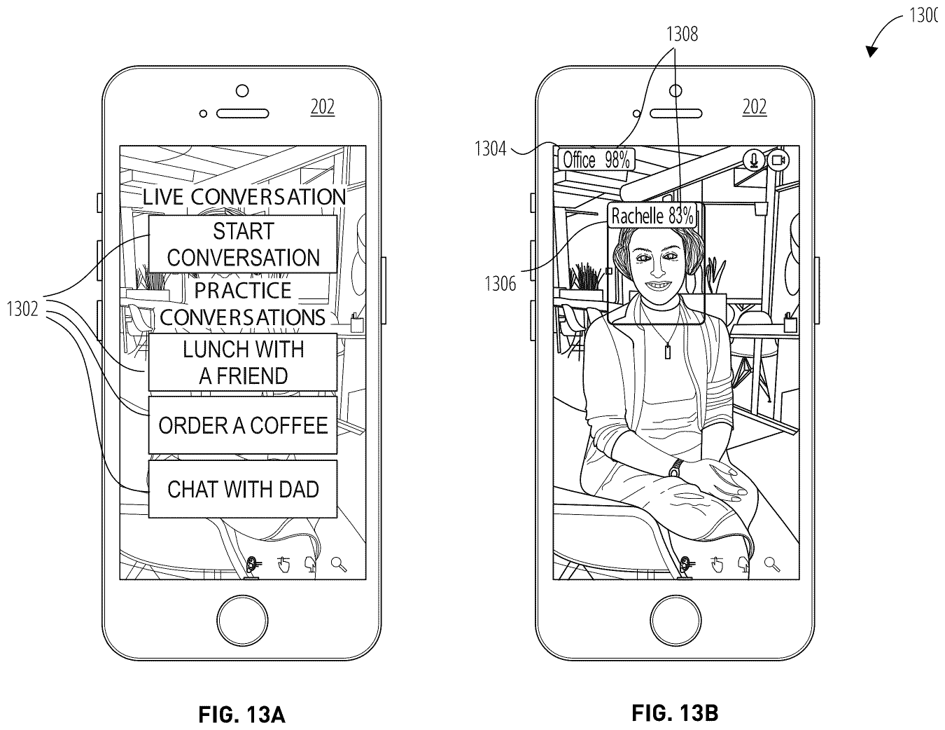

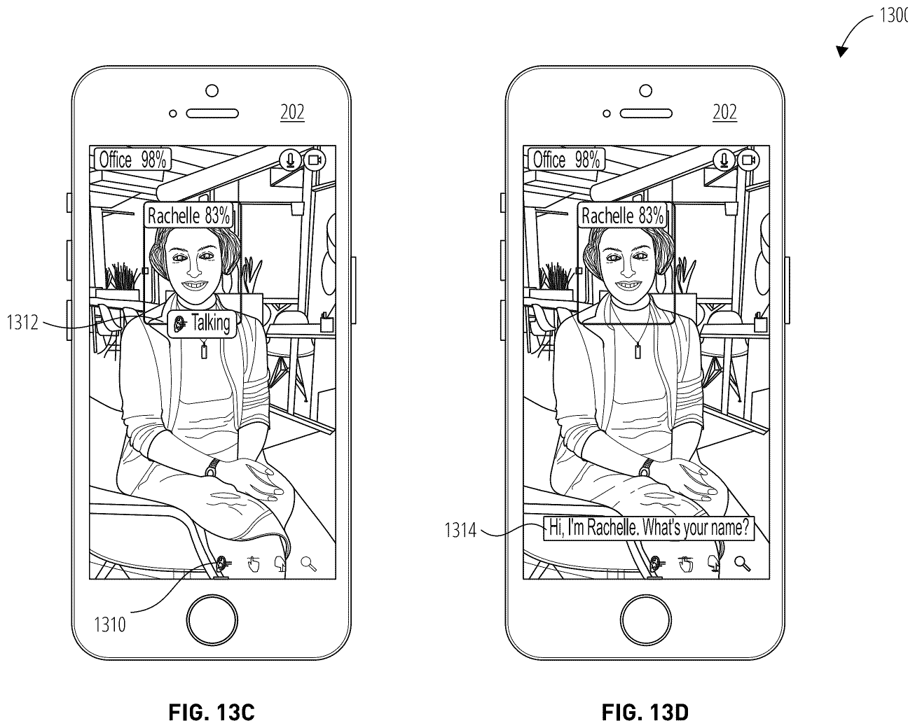

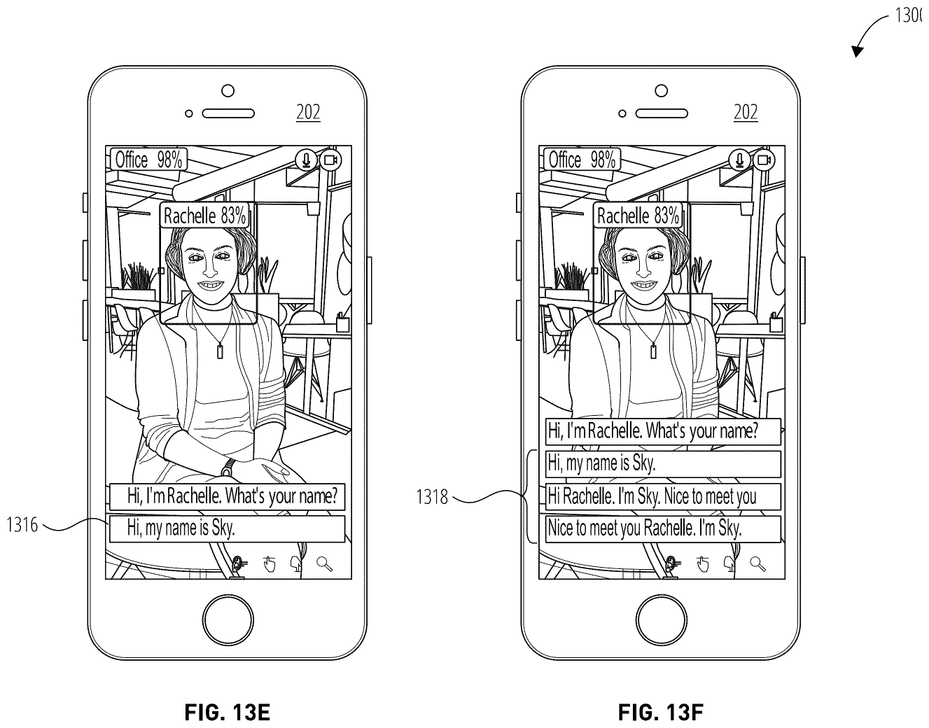

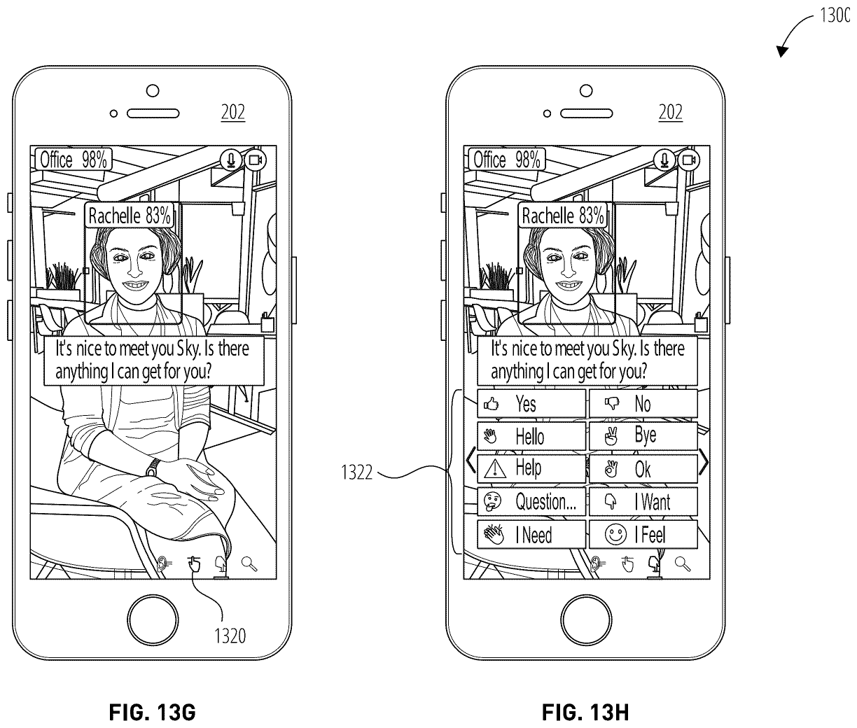

FIG. 13A-FIG. 13H illustrate an exemplary user interface 1300 in accordance with one embodiment. The exemplary user interface 1300 may be presented to a user 102 on a mobile computing device 202 such as a smartphone, as shown.

In one embodiment, the exemplary user interface 1300 may include conversation imitation controls 1302 for different types of conversational situations, as shown in FIG. 13A. For example, the exemplary user interface 1300 may allow the user 102 to start a live conversation with one or more conversation partners 104 that are human partners in their vicinity (or remote conversation partners 138 connected via a network 108). The conversation imitation controls 1302 may also include options for practice conversations, in which the conversation augmentation system 100 may fill the roll of conversation partner 104, or may interface with a specialized model or machine agent tuned to support a specific conversational situation. Conversational situations available might include having lunch with a friend, ordering a coffee, chatting with dad, etc.

In one embodiment, the user 102 may start a live conversation with a conversation partner 104 in their vicinity, as shown in FIG. 13B. The exemplary user interface 1300 may present an identification of the surroundings 1304 and potential conversation partners 1306 as illustrated. The exemplary user interface 1300 may include confidence scores 1308 for the elements displayed that it has identified.

In one embodiment, the exemplary user interface 1300 may support various modes of operation and selectable controls allowing the user 102 to choose which mode to operate in. For example, an audible assist mode may be available for a hearing-impaired user, which may be selectable using an audible assist mode control 1310, as shown in FIG. 13C. In this mode, a status message 1312 may indicate to the user 102 that their conversation partner 104 is talking. The exemplary user interface 1300 may generate then display text 1314 for the utterance spoken by the conversation partner 1306, as shown in FIG. 13D.

The exemplary user interface 1300 may, as shown in FIG. 13E, provide a suggested response based on the text 1314 of the utterance from the conversation partner 1306. This displayed suggestion 1316 may be available to the user 102 for selection. In one embodiment, the user 102 may be able to indicate that they would like to refine the response that the conversation augmentation system 100 has presented through the exemplary user interface 1300. The refinement engine 600 may be employed to provide refined suggestions 1318, such as may be seen in FIG. 13F. These suggestions may be selectable through tapping or other selection methods. Upon receiving a response selection from the user 102, the user experience engine 200 may use the speakers of the mobile computing device 202 to produce an audible representation of the selected response. In one embodiment, recordings of the user 102 stored and managed by the memory engine 500 may be available to present the audible response in a voice similar to that of the user 102.

In one embodiment, the user may select a tap to interact mode control 1320 to enter a tap to interact mode. Such a mode may provide a number of preconfigured tappable or otherwise selectable shortcuts 1322 to facilitate conversation. Examples are shown in FIG. 13G and FIG. 13H.

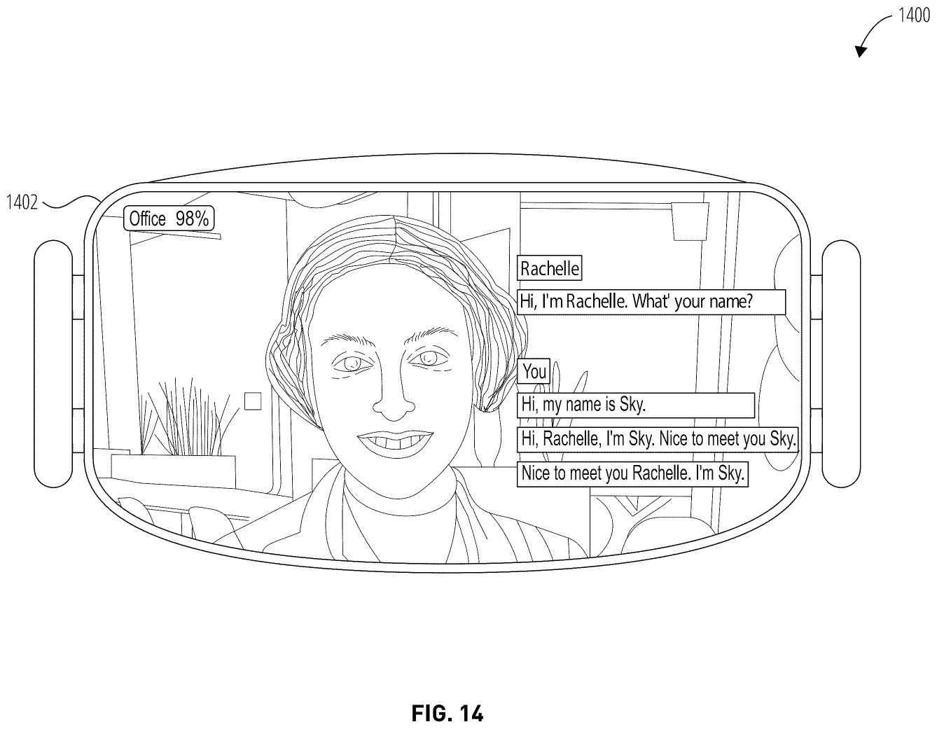

FIG. 14 illustrates an exemplary user interface 1400 in accordance with one embodiment. The exemplary user interface 1400 may be configured substantially as described for the exemplary user interface 1300 introduced with respect to FIG. 13A-FIG. 13H, but may be configured for display through an AR/VR headset 1402, such as the BCI headset system 2400 illustrated in FIG. 24A-FIG. 24D.

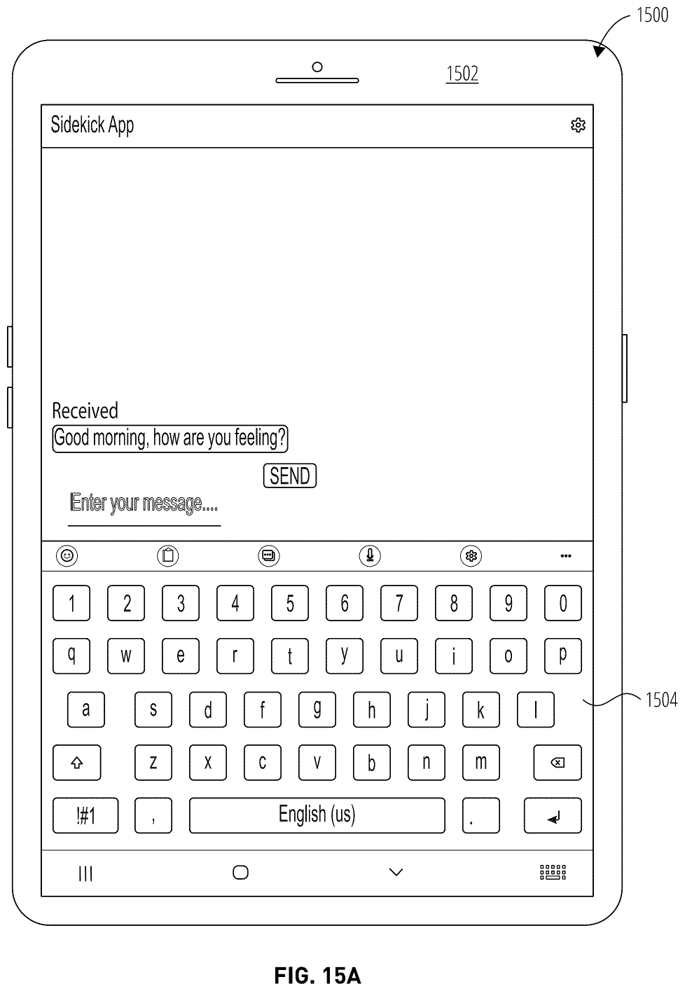

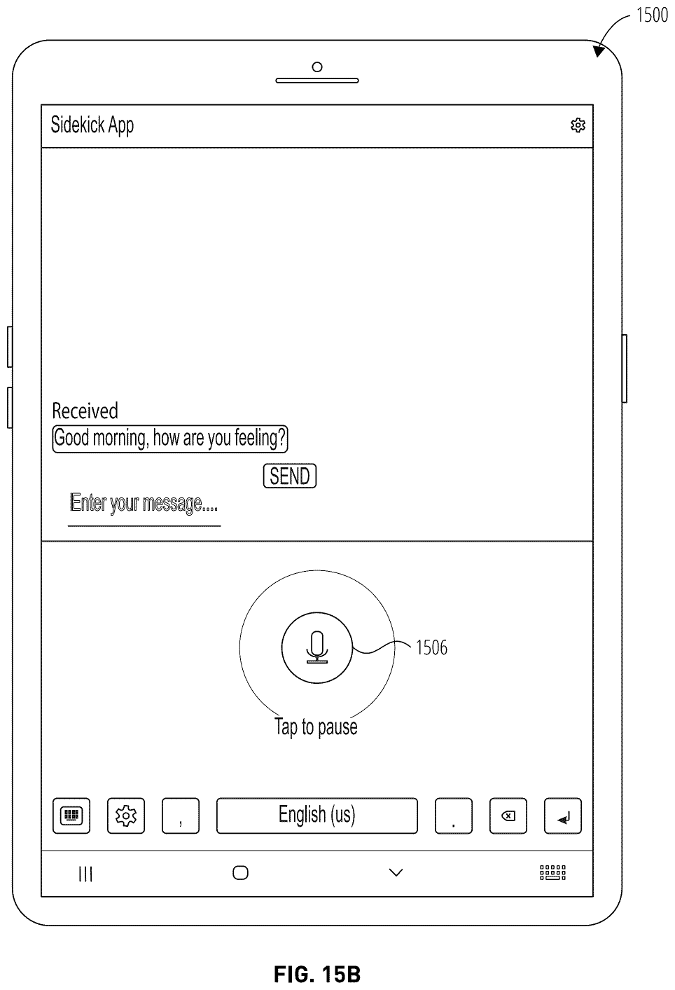

FIG. 15A and FIG. 15B illustrate an exemplary user interface 1500 in accordance with one embodiment. The exemplary user interface 1500 may be an application on a smart tablet 1502, such as the Sidekick App illustrated. In this manner, the user experience engine 200 may take advantage of input and output options available on the smart tablet 1502. For example, the exemplary user interface 1500 may utilize the text entry keyboard 1504 already configured as part of the standard operation of the smart tablet 1502, as shown in FIG. 15A. Alternatively or in addition, the exemplary user interface 1500 may utilize the voice-to-text 1506 functionality of the smart tablet 1502 as shown in FIG. 15B.

FIG. 16 illustrates a user agency and capability augmentation system 1600 in accordance with one embodiment. The user agency and capability augmentation system 1600 comprises a user 102, a wearable computing and biosignal sensing device 1602, biosignals 1604, background material 1606, sensor data 1608, other device data 1610, application context 1612 a prompt composer 1614, a model 1616, a multimodal output stage 1618, an encoder/parser 1630, output modalities 1620 such as an utterance 1622, a written text 1624, a multimodal artifact 1626, an other user agency 1628, and a non-language user agency device 1632, a biosignals subsystem 1700, and a context subsystem 1800.

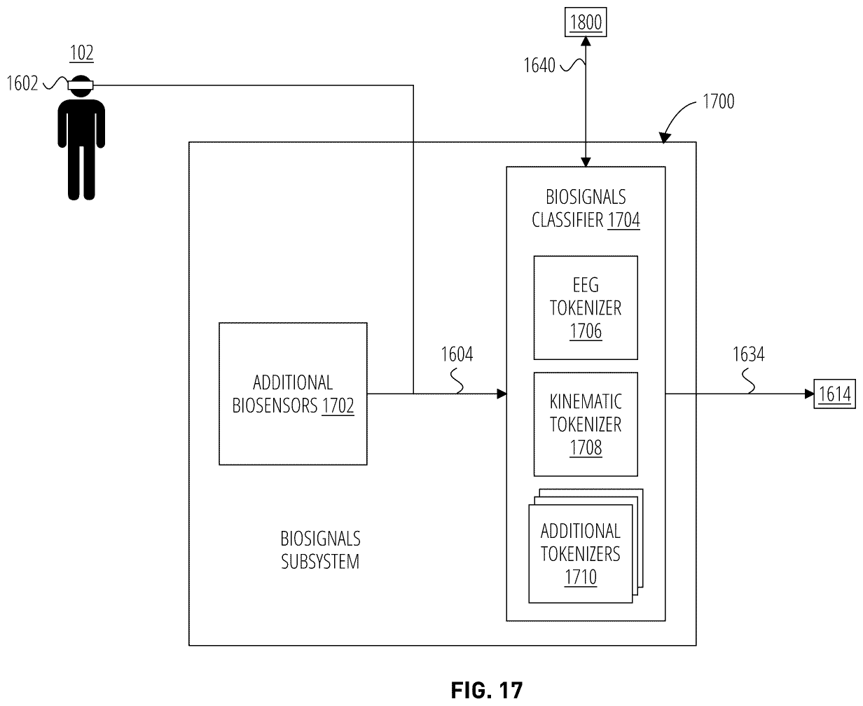

The user 102 in one embodiment may be equipped with and interact with a wearable computing and biosignal sensing device 1602. The wearable computing and biosignal sensing device 1602 may be a device such as the brain computer interface or BCI headset system 2400 described in greater detail with respect to FIG. 24A through FIG. 24D. This embodiment may provide the user 102 with capability augmentation or agency support by utilizing biosignals 1604, such as neurologically sensed signals and physically sensed signals, detected from the wearable computing and biosignal sensing device 1602 and sent to a biosignals subsystem 1700, in addition to data from biosignal sensors that may be part of the biosignals subsystem 1700. The biosignals subsystem 1700 may produce as its output a tokenized biosignals prompt 1634. The action of the biosignals subsystem 1700 is described in detail with respect to FIG. 17.

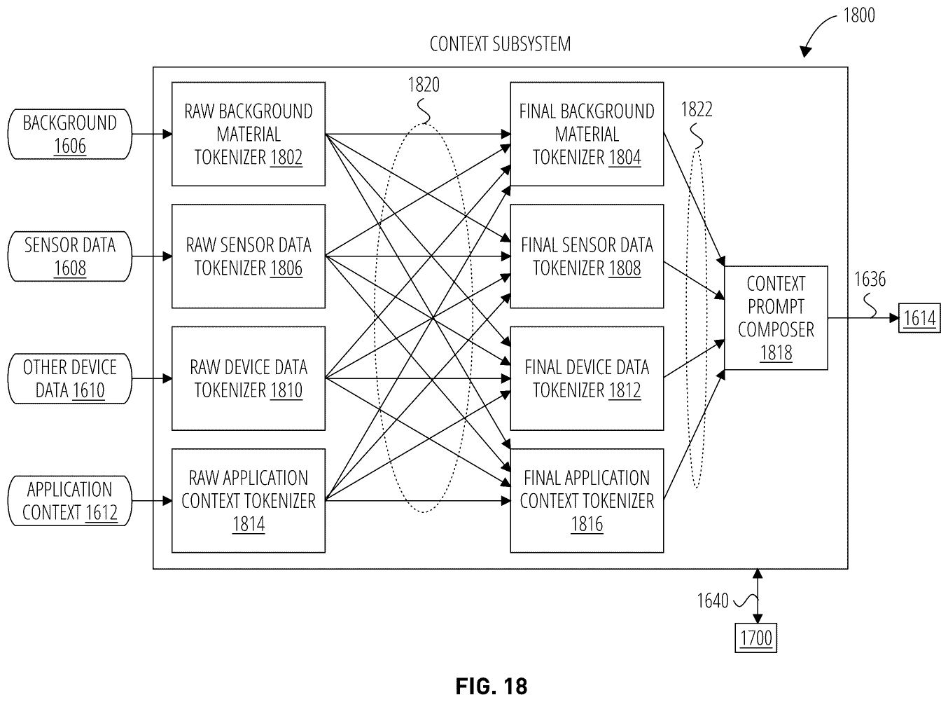

This embodiment may provide the user 102 with capability augmentation or agency support by utilizing inference of the user's environment, physical state, history, and current desired capabilities as a user context, to be gathered at a context subsystem 1800, described in greater detail with respect to FIG. 18. This data may be provided as background material 1606 on the user stored in a database or other storage structure, sensor data 1608 and other device data 1610 from a range of devices and on-device and off-device sensors, and application context 1612 provided by applications, interfaces, or parameters configured to provide the capability augmentation sought by the user 102. The context subsystem 1800 may produce as its output a tokenized context prompt 1636.

In one embodiment, the biosignals subsystem 1700 and the context subsystem 1800 may be coupled or configured to allow shared data 1640 to flow between them. For instance, some sensor data 1608 or other device data 1610 may contain biosignal information that may be useful to the biosignals subsystem 1700. Or the biosignals subsystem 1700 may capture sensor data 1608 indicative of the user 102 context. These systems may communicate such data, in raw, structured, or tokenized forms, between themselves through wired or wireless communication. In one embodiment, these systems may operate as part of a device that is also configured and utilized to run other services.

This embodiment may finally provide the user 102 capability augmentation or agency support by utilizing direct user 102 input in the form of a user input prompt 1638, such as mouse, keyboard, or biosignal-based selections, typed or spoken language, or other form of direct interaction the user 102 may have with a computational device that is part of or supports the user agency and capability augmentation system 1600 disclosed. In one embodiment, the user 102 may provide an additional token sequence in one or more sensory modes, which may include a sequence of typed or spoken words, an image or sequence of images, and a sound or sequence of sounds. The biometric and optional multimodal prompt input from the user may be tokenized using equivalent techniques as for the context data.

The biosignals prompt 1634, context prompt 1636, and user input prompt 1638 may be sent to a prompt composer 1614. The prompt composer 1614 may consume the data including the biosignals prompt 1634, context prompt 1636, and user input prompt 1638 tokens, and may construct a single token, a set of tokens, or a series of conditional or unconditional commands suitable to use as a prompt 1642 for a model 1616 such as an LLM, GenAI, a Generative Pre-trained Transformer (GPT) like GPT-4, or a generalist agent such as Gato. For example, a series such as “conditional on command A success, send command B, else send command C” may be built and sent all at once given a specific data precondition, rather than being built and sent separately.

The prompt composer 1614 may also generate tokens that identify a requested or desired output modality (text vs. audio/visual vs. commands to a computer or robotic device, etc.) from among available output modalities 1620 such as those illustrated. In one embodiment, the prompt composer 1614 may further generate an embedding which may be provided separately to the model 1616 for use in an intermediate layer of the model 1616. In another embodiment, the prompt composer 1614 may generate multiple tokenized sequences at once that constitute a series of conditional commands. In one exemplary use case, the user 102 submits a general navigational command to an autonomous robot or vehicle, such as “go to the top of the hill.” The prompt composer 1614 may then interact with satellite and radar endpoints to construct specific motor commands, such as “Move forward 20 feet and turn left,” that navigate the robot or vehicle to the desired destination.

In one exemplary use case, the context subsystem 1800 may generate a context prompt 1636 that contains information about the user's doctor, notes about previous appointments, and the user's questions or comments. Such a context prompt 1636 may be generated by utilizing sensors on a computing device worn or held by the user 102, such as a smart phone or the wearable computing and biosignal sensing device 1602. Such sensors may include global positioning system (GPS) components, as well as microphones configured to feed audio to a speech to text (STT) device or module in order to identify the doctor and the questions. The biosignals subsystem 1700 may generate a biosignals prompt 1634 including a token sequence corresponding to the user selecting “speak” with a computing device to select this directive using an electroencephalography-based brain computer interface. The user input prompt 1638 may include an instruction token sequence corresponding to the plaintext, “summarize my recent disease experience.” In this case, the prompt composer 1614 may append these three token sequences into a single prompt 1642 and may then pass it to the model 1616. In an alternate embodiment, the prompt composer 1614 may add to the biosignals prompt 1634 and context prompt 1636 a token sequence corresponding to the instruction “Generate summary in a multimedia presentation.”

In some embodiments, the prompt composer 1614 may utilize a formal prompt composition language such as Microsoft Guidance. In such a case, the composition language may utilize one or more formal structures that facilitate deterministic prompt composition as a function of mixed modality inputs. For example, the prompt composer 1614 may contain subroutines that process raw signal data and utilize this data to modify context prompt 1636 and/or biosignals prompt 1634 inputs in order to ensure specific types of model 1616 outputs.

A more intricate exemplary prompt from the prompt composer 1614 to the model 1616, incorporating information detected from user 102 context and biosignals 1604, may be as follows:

″I cannot speak. You are my helpful assistant who provides me
with suggestions of phrases for my speech-generating device
to say. Read the context information and conversation history
below, then generate three appropriate and safe phrases I can
say to my partner that continue our conversation. The phrases
you suggest should be short and complete sentences, presented
in a list in this order of sentiment without labels: 1)
positive 2) neutral 3) negative. Context information which
may help your suggestions is below. This may include
questions from an interview with me and autobiographical
text. \n------------------------\n Context: Day: Friday 9 27
2024 Time: 09:26 \n Biography: These are the topics I am most
interested in and enjoy talking about: WWII, cars, Gardening,
Small engine repair, Songwriting, Woodworking, San Francisco
49ers, Golden State Warriors, Seinfeldisms, Robotics \n\n
Conversation History: Partner: Tell me about your wife? \n---
---------------------\n Given the context information and not
prior knowledge, respond in first person with the three
phrase suggestions in JSON in this
format:\n{\″suggestions\″:[str, str, str]}″

The model 1616 may take in the prompt 1642 from the prompt composer 1614 and use this to generate a multimodal output 1644. The model 1616 may consist of a pre-trained machine learning model, such as GPT. The model 1616 may generate a multimodal output 1644 in the form of a token sequence that may be converted back into plaintext, or which may be consumed by a user agency process directly as a token sequence. In an alternate embodiment, the output of the model 1616 further constitutes embeddings that may be decoded into multimodal or time-series signals capable of utilization by agency endpoints. Once determined, the output is digitally communicated to an agency endpoint capable of supporting the various output modalities 1620.

In some embodiments, the model 1616 may generate two or more possible multimodal outputs 1644 and the user 102 may be explicitly prompted at the multimodal output stage 1618 to select between the choices. In the case of language generation, the user 102 may at the multimodal output stage 1618 select between alternative utterances 1622. In the case of robot control, the choices may consist of alternative paths that a robot could take in order to achieve a user-specified goal. In these embodiments, there may be an output mode selection signal 1646 provided by the user 102 explicitly or indicated through biosignals 1604, to the multimodal output stage 1618. The output mode selection signal 1646 may instruct a choice between the multimodal outputs 1644 available from the model 1616 at the multimodal output stage 1618. In one embodiment, the user 102 may further direct one or more of the alternatives to alternate endpoints supporting the various output modalities 1620. For example, the user 102 may select one utterance 1622 for audible presentation and a different one for transformation and/or translation to written text 1624.

In an alternate configuration, the user agency and capability augmentation system 1600 may contain multiple models 1616, each of which is pre-trained on specific application, context, or agency domains. In this configuration, the context subsystem 1800 may be responsible for selecting the appropriate model 1616 or models 1616 for the current estimated user context. In some embodiments, mixture-of-experts models such as a generalist language model may be used for this.

In some embodiments, models 1616 may be fine-tuned with the user's chat and choice data. For example, the user 102 may provide the tuning engine 700 with exemplars of prompts and user choices that they rated highly. The multimodal outputs 1644 may be made available to the user 102 through the agency endpoints supporting the various output modalities 1620, and the user 102 may respond in a manner detectable through the user's biosignals 1604, or directly through an additional user input prompt 1638, and in this manner may also provide data through which the user's personal models 1616 may be trained or tuned.

The multimodal outputs 1644 may be used to extend and support user 102 agency and augment user 102 capability into real and virtual endpoints. In one embodiment, the selected user agency process may be a speech synthesis system capable of synthesizing a token sequence or text string as a spoken language utterance 1622 in the form of a digital audio signal. In another embodiment, the system's output may be constrained to a subset of domain-relevant utterances 1622 for applications such as employment, industry, or medical care. This output constraint may be implemented using a domain specific token post-processing system or it may be implemented with an alternate model that has been pre-trained on the target domain. In another embodiment, the endpoint may be a written text 1624 composition interface associated with a communication application such as email, social media, chat, etc., or presented on the user's or their companions' mobile or wearable computing device. In a further embodiment, the output may be a multimodal artifact 1626 such as a video with text, an audio file, etc. In another embodiment, the output may augment some other user agency 1628, such as by providing haptic stimulation, or through dynamic alteration of a user's interface, access method, or complexity of interaction, to maximize utility in context.

In some embodiments, the multimodal outputs 1644 may be additionally encoded using an encoder/parser 1630 framework such as an autoencoder. In this system, the output of the encoder/parser 1630 framework may be a sequence of control commands to control a non-language user agency device 1632 or robotic system such as a powered wheelchair, prosthetic, powered exoskeleton, or other smart, robotic, or AI-powered device. In one embodiment, the prompt 1642 from the prompt composer 1614 may include either biosignals prompt 1634 or user input prompt 1638 tokens which represent the user's desired configuration, and the multimodal output includes detailed steps that a robotic controller may digest, once encoded by the encoder/parser 1630. In this embodiment, the user 102 may express a desire to move from location A to location B, and the combination of the model 1616 and the robot controller may generate an optimal path as well as detailed control commands for individual actuators. In another embodiment, biosignals 1604 may be used to infer a user's comfort with the condition of their surroundings, their context indicating that they are at home, and a prompt may be developed such that the model 1616 provides multimodal outputs 1644 instructing a smart home system to adjust a thermostat, turn off music, raise light levels, or perform other tasks to improve user comfort. In a further embodiment, the model 1616 may generate a novel control program which is encoded by parsing or compiling it for the target robot control platform at the encoder/parser 1630. The multimodal output 1644 may through these methods be available as information or feedback to the user 102, through presentation via the wearable computing and biosignal sensing device 1602 or other devices in the user's immediate surroundings. The multimodal output 1644 may be stored and become part of the user's background material 1606. The user 102 may respond to the multimodal output 1644 in a manner detectable through biosignals 1604, and thus a channel may be provided to train the model 1616 based on user 102 response to multimodal output 1644.

In general, the user agency and capability augmentation system 1600 may be viewed as a kind of application framework that uses the biosignals prompt 1634, context prompt 1636, and user input prompt 1638 sequences to facilitate interaction with an application, much as a user 102 would use their finger to interact with a mobile phone application running on a mobile phone operating system. Unlike a touchscreen or mouse/keyboard interface, this system incorporates real time user inputs along with an articulated description of their physical context and historical context to facilitate extremely efficient interactions to support user agency. FIG. 16 shows the pathways signals take from input, by sensing devices, stored data, or the user 102, to output in the form of text-to-speech utterances 1622, written text 1624, multimodal artifacts 1626, other user agency 1628 supportive outputs, and/or commands to a non-language user agency device 1632. It will be well understood by one of skill in the art that not all components of the disclosed user agency and capability augmentation system 1600 may be used in every application such a system may operate within or may not be used with equal weight. Some applications may make greater use of biosignals 1604 than of context indicating the user history and surroundings. Some applications may necessitate operation completely independent from user input prompt 1638 data. The disclosed user agency and capability augmentation system 1600 may be used in support of such user applications as are described in the embodiments disclosed herein.

FIG. 17 illustrates a biosignals subsystem 1700 in accordance with one embodiment. The biosignals subsystem 1700 may comprise additional biosensors 1702, a biosignals classifier 1704, an electroencephalography or EEG tokenizer 1706, a kinematic tokenizer 1708, and additional tokenizers 1710, each of which may be suitable for one or more streams of biosignal data.

In addition to sensors which may be available on the wearable computing and biosignal sensing device 1602 worn by the user 102, additional biosensors 1702 may be incorporated into the biosignals subsystem 1700. These may be of a mixture of physical sensors on or near the user's body that connect with network-connected and embedded data sources and models to generate a numerical representation of a biosignal estimate. An appropriate biosignal tokenizer may encode the biosignal estimate with associated data to generate at least one biosignal token sequence. In some embodiments, the mobile or wearable computing and biosignal sensing device 1602 may include a set of sensory peripherals designed to capture user 102 biometrics. In this manner, the biosignals subsystem 1700 may receive biosignals 1604, which may include at least one of a neurologically sensed signal and a physically sensed signal.

Biosignals 1604 may be tokenized through the use of a biosignals classifier 1704. In some embodiments, these biometric sensors may include some combination of wired or wirelessly connected wearable or implantable devices such as a BCI, FMRI, EEG, electrocorticography (ECoG), electrocardiogram (ECG or EKG), electromyography (EMG), or implantable brain chips, motion remote gesture sensing controllers, breathing tube sip and puff controllers, EOG or eye gaze sensing controllers, pulse sensing, heart rate variability sensing, blood sugar sensing, dermal conductivity sensing, etc. These biometric data may be converted into a biosignal token sequence in the biosignals classifier 1704, through operation of the EEG tokenizer 1706, kinematic tokenizer 1708, or additional tokenizers 1710, as appropriate.

It is common practice for biosignal raw signal data to be analyzed in real time using a classification system. For EEG signals, a possible choice for an EEG tokenizer 1706 may be canonical correlation analysis (CCA), which ingests multi-channel time series EEG data and outputs a sequence of classifications corresponding to stimuli that the user may be exposed to. However, one skilled in the art will recognize that many other signal classifiers may be chosen that may be better suited to specific stimuli or user contexts. These may include but are not limited to independent component analysis (ICA), xCCA (CCA variants), power spectral density (PSD) thresholding, and machine learning. One skilled in the art will recognize that there are many possible classification techniques. In one example, these signals may consist of steady state visually evoked potentials (SSVEP) which occur in response to specific visual stimuli. In other possible embodiments, the classification may consist of a binary true/false sequence corresponding to an event-related positive voltage occurring 300 ms following stimulus presentation (P300) or other similar neural characteristic. In some embodiments, there will be a user or stimuli specific calibrated signal used for the analysis. In other embodiments, a generic reference may be chosen. In yet other possible embodiments, the classes may consist of discrete event related potential (ERP) responses. It may be clear to one of ordinary skill in the art that other biosignals including EOG, EMG, and EKG, may be similarly classified and converted into symbol sequences. In other embodiments, the signal data may be directly tokenized using discretization and a codebook. The resulting tokens may be used as part of the biosignals prompt 1634.

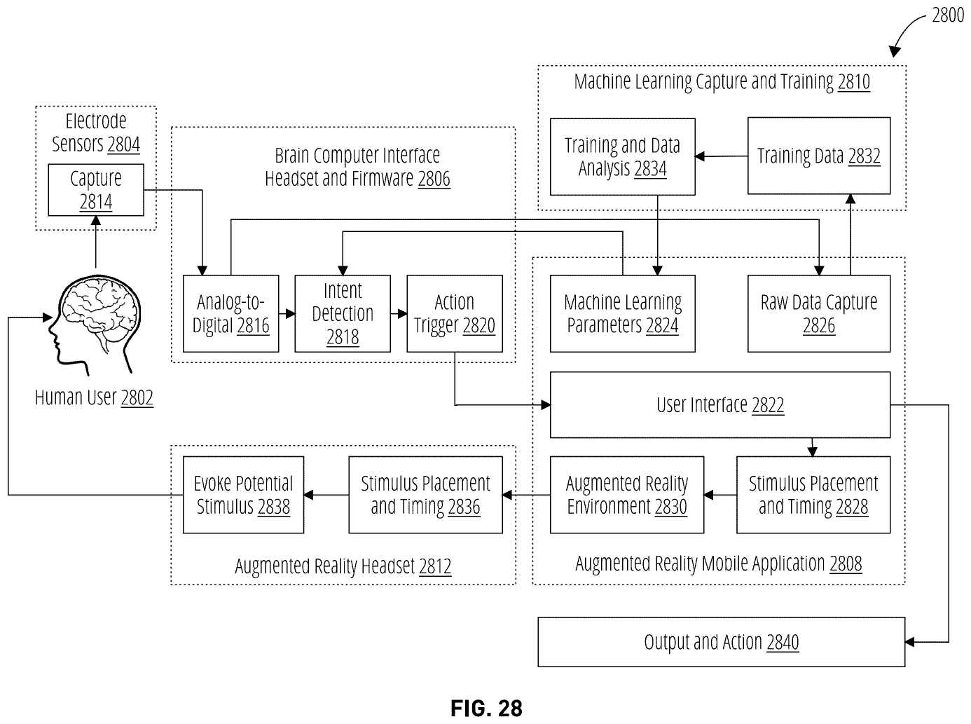

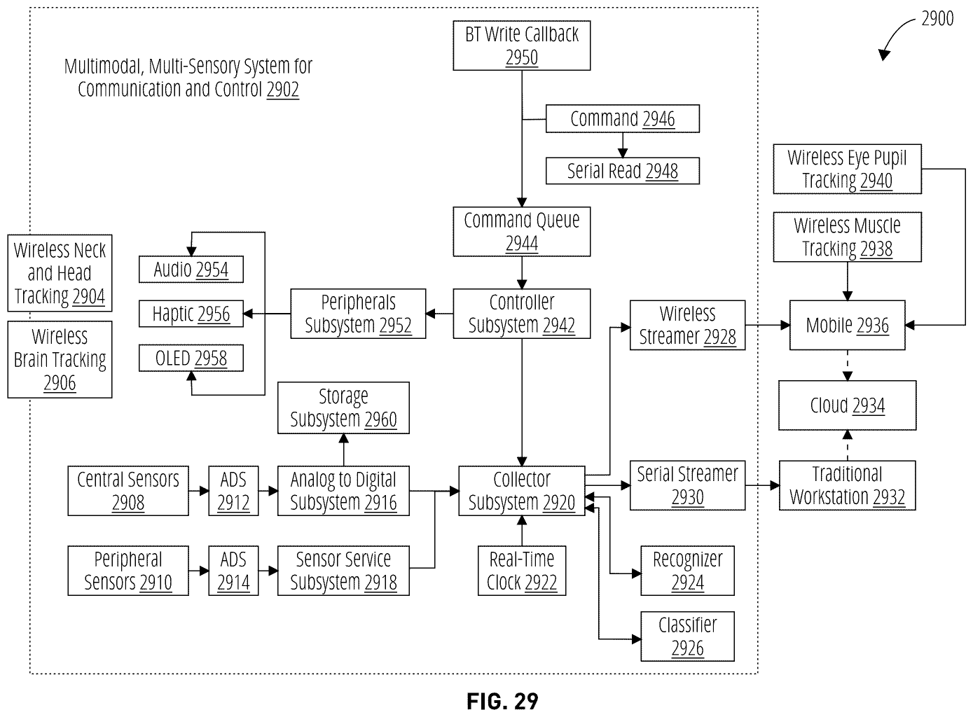

The kinematic tokenizer 1708 may receive biosignals 1604 indicative of user 102 motion, or motion of some part of a user's body, such as gaze detection based on the orientation and dilation of a user's pupils, through eye and pupil tracking discussed with reference to FIG. 28 or FIG. 29. Such kinematic biosignals 1604 may be tokenized through the operation of the kinematic tokenizer 1708 for inclusion in the biosignals prompt 1634. Additional tokenizers 1710 may operate similarly upon other types of biosignals 1604. In one possible embodiment, the kinematic tokenizer 1708 may utilize a codebook that maps state-space values (position/orientation, velocity/angular velocity) into codes which form the sequence of codes. In other embodiments, a model-based tokenizer may be used to convert motion data into discrete code sequences.

The final output from the biosignals subsystem 1700 may be a sequence of text tokens containing a combination of the token sequences generated from the biosignals 1604, in the form of the biosignals prompt 1634. The biosignals subsystem 1700 may also have a connection with the context subsystem 1800 in advance of any prompt composition. This shared data 1640 connection may bidirectionally inform each of the subsystems to allow more precise, or more optimal token generation.

FIG. 18 illustrates a context subsystem 1800 in accordance with one embodiment. The context subsystem 1800 may comprise a raw background material tokenizer 1802, a final background material tokenizer 1804, a raw sensor data tokenizer 1806, a final sensor data tokenizer 1808, a raw device data tokenizer 1810, a final device data tokenizer 1812, a raw application context tokenizer 1814, a final application context tokenizer 1816, and a context prompt composer 1818.

Broadly speaking, the user's context consists of prompts generated from a variety of different data sources, including background material 1606 that provides information about the user's previous history, sensor data 1608 and other device data 1610 captured on or around the user 102, and application context 1612, i.e., information about the current task or interaction the user 102 may be engaged in.

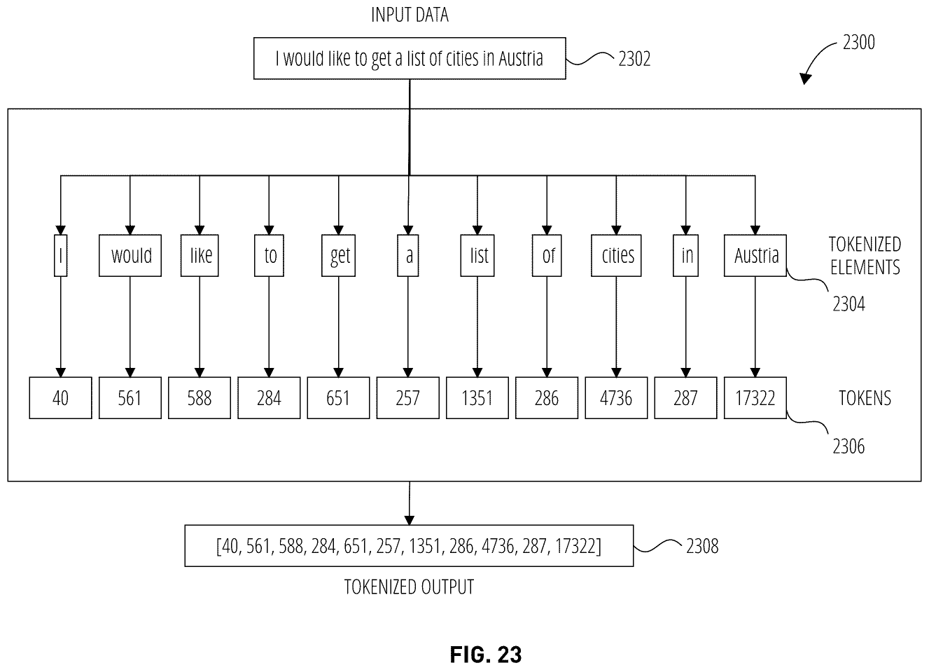

Background material 1606 may be plain text, data from a structured database or cloud data storage (structured or unstructured), or any mixture of these data types. In one embodiment background material 1606 may include textual descriptions of activities that the user 102 has performed or requested in a similar context and their prior outcomes, if relevant. In one embodiment, background material 1606 may include general information about the user 102, about topics relevant to the user's current environment, the user's conversational histories, a body of written or other work produced by the user 102, or notes or other material related to the user's situation which is of a contextual or historical nature. In some embodiments, the background material 1606 may first be converted into a plain text stream and then tokenized using a plaintext tokenizer. This is illustrated in greater detail with respect to FIG. 23.

Sensor data 1608 may include microphone output indicative of sound in the user's environment, temperature, air pressure, and humidity data detected by climactic sensors, etc., output from motion sensors, and a number of other sensing devices available and pertinent to the user's surroundings and desired application of the user agency and capability augmentation system 1600. Other device data 1610 may include camera output data, either still or video, indicating visual data available from the user's surrounding environment, geolocation information from a global positioning system device, date and time data, information available via a network based on the user's location, and data from a number of other devices readily available and of use in the desired application of the user agency and capability augmentation system 1600. Scene analysis may be used in conjunction with object recognition to identify objects and people present in the user's environment, which may then be tokenized. The context subsystem may also include a mixture of physical sensors such as microphones and cameras that connect with network-connected and embedded data sources and models to generate a numerical representation of a real-time context estimate.

In some instances, the user 102 may interact with an application on a computing device, and this interaction may be supported and expanded through the integration of a user agency and capability augmentation system 1600. In these instances, explicit specification of the application may greatly enhance the context subsystem 1800 knowledge of the user 102 context and may facilitate a more optimal context token set. Application context 1612 data may in such a case be made available to the user agency and capability augmentation system 1600, and data from the application context 1612 data source may be tokenized as part of the operation of the context subsystem 1800, for inclusion in the context prompt 1636. Application context 1612 data may include data about the current application (e.g., web browser, social media, media viewer, etc.) along with the user's interactions associated with the application, such as a user's interaction with a form for an online food order, data from a weather application the user is currently viewing, etc.

For each data source, a raw data tokenizer may generate a set of preliminary tokens 1820. These preliminary tokens 1820 may be passed to final tokenizers for all of the data sources to be consumed as input for the final tokenizers for each data source. Each data source final tokenizer may refine its output based on the preliminary tokens 1820 provided by other data sources. This may be particularly important for background material 1606. For example, the context used by the final background material tokenizer 1804 to determine which background material 1606 elements are likely to be relevant may be the prompt generated by the raw data source tokenizers. For example, camera data and microphone data may indicate the presence and identity of another person within the user's immediate surroundings. Background material 1606 may include emails, text messages, audio recordings, or other records of exchanges between this person and the user, which the final background material tokenizer 1804 may then include and tokenize as of particular interest to the user's present context.

The context subsystem 1800 may send the final tokens output from the final tokenizers for each data source to a context prompt composer 1818. The context prompt composer 1818 may use these final tokens 1822, in whole or in part, to generate a context prompt 1636, which may be the final output from the context subsystem 1800. The context prompt 1636 may be a sequence of text tokens containing the combination of the background, audio/video, and other final tokens 1822 from the final background material tokenizer 1804, final sensor data tokenizer 1808, final device data tokenizer 1812, and final application context tokenizer 1816. In the simplest embodiment, the context prompt composer 1818 concatenates all the final tokens 1822. In other possible embodiments, the context prompt composer 1818 creates as its context prompt 1636 a structured report that includes additional tokens to assist the GenAI in parsing the various final tokens 1822 or prompts.

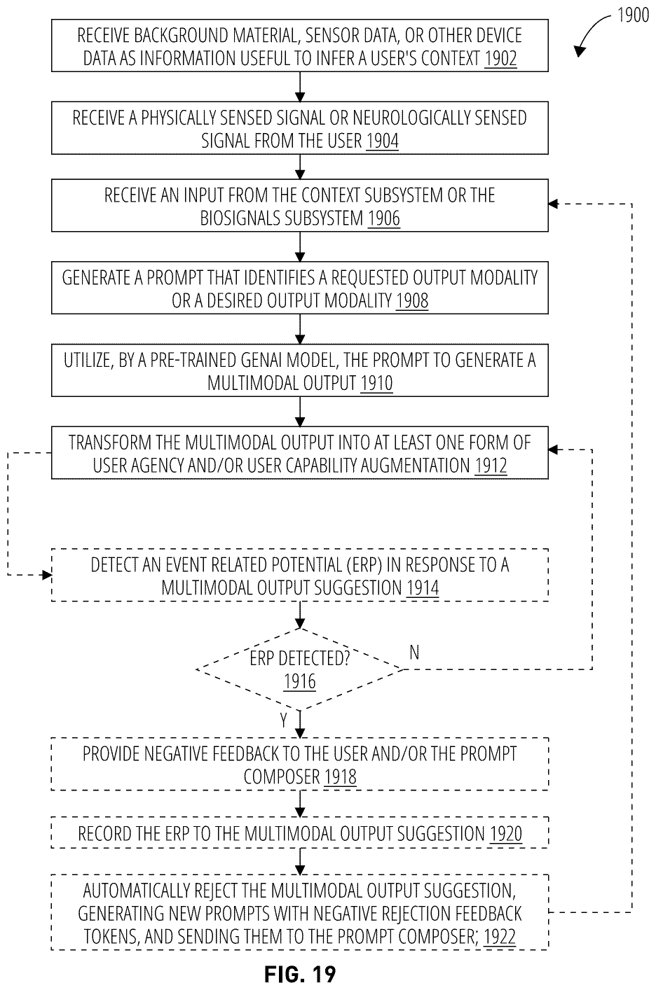

FIG. 19 illustrates an example routine 1900 for implementation using a human augmentation platform using context, biosignals, and Generative AI. Such a routine 1900 may be performed through the operation of a user agency and capability augmentation system 1600 such as that illustrated and described with respect to FIG. 16. Although the example routine 1900 depicts a particular sequence of operations, the sequence may be altered without departing from the scope of the present disclosure. For example, some of the operations depicted may be performed in parallel or in a different sequence that does not materially affect the function of the routine 1900. In other examples, different components of an example device or system that implements the routine 1900 may perform functions at substantially the same time or in a specific sequence.

According to some examples, the method includes receiving, by a context subsystem, at least one of background material, sensor data, and other device data as information useful to infer a user's context at block 1902. For example, the context subsystem 1800 illustrated in FIG. 18 may receive background material, sensor data, or other device data as information useful to infer a user's context. In one embodiment, the at least one of the sensor data and the other device data may be received by the context subsystem from at least one of a camera and a microphone array. In one embodiment, the context subsystem may also receive application context from applications installed on computing or smart devices in communication with the context subsystem.

According to some examples, the method includes receiving, by a biosignals subsystem, at least one of a physically sensed signal and a neurologically sensed signal from the user at block 1904. For example, the biosignals subsystem 1700 illustrated in FIG. 17 may receive a physically sensed signal or neurologically sensed signal from the user as the biosignals 1604 introduced in FIG. 16. In one embodiment, the biosignals subsystem may receive biosignals data from biometric sensors for at least one of electroencephalography (EEG), electrocorticography (ECoG), electrocardiogram (ECG or EKG), electromyography (EMG), electrooculography (EOG), pulse determination, heart rate variability determination, blood sugar sensing, and dermal conductivity determination.

According to some examples, the method includes receiving, by a prompt composer, an input from at least one of the context subsystem and the biosignals subsystems; at block 1906. For example, the prompt composer 1614 illustrated in FIG. 16 may receive an input from the context subsystem or the biosignals subsystem. In one embodiment, the prompt composer may additionally receive a user input prompt. In this manner, a user may directly and explicitly provide instruction to the prompt composer.

According to some examples, the method includes generating, by the prompt composer, a prompt that identifies at least one of a requested output modality and a desired output modality at block 1908. For example, the prompt composer 1614 illustrated in FIG. 16 may generate a prompt that identifies a requested output modality or a desired output modality. In one embodiment, the prompt composer may generate at least one of a single token, a string of tokens, a series of conditional or unconditional commands suitable to prompt the GenAI model, tokens that identify at least one of the requested output modality and the desired output modality, an embedding to be provided separately to the GenAI model for use in an intermediate layer of the GenAI model, and multiple tokenized sequences at once that constitute a series of conditional commands.

According to some examples, the method includes utilizing, by a model, the prompt to generate a multimodal output at block 1910. For example, the model 1616 illustrated in FIG. 16 may be prompted to generate a multimodal output. In one embodiment, the GenAI model may be at least one of large language models (LLMs), Generative Pre-trained Transformer (GPT) models, deep learning models, decision trees, diffusion models, text-to-image creators, visual art creators, and generalist agent models.

According to some examples, the method includes transforming, by an output stage, the multimodal output into at least one form of user agency, user capability augmentation, and combinations thereof at block 1912. For example, the multimodal output stage 1618 illustrated in FIG. 16 may transform the multimodal output into at least one form of user agency and/or user capability augmentation. In one embodiment, the at least one form of the user agency includes neural stimulation to the user with Transcranial Direct Current Stimulation (tDCS), direct brain stimulation (DBS), or other known neural stimulation techniques. In one embodiment, the multimodal output may be in the form of at least one of text-to-speech utterances, written text, multimodal artifacts, other user agency supportive outputs, and commands to a non-language user agency device. In one embodiment, the output stage may receive an output mode selection signal from the user. The output mode selection signal may be a direct selection or may be generated from the user's biosignals. The output mode selection signal may instruct the output stage of a choice between multimodal outputs or may direct one or more alternative multimodal outputs to alternate endpoints. In one embodiment, an encoder/parser framework, such as the encoder/parser 122 of FIG. 16, may encode the multimodal output to provide control commands to control at least one of a non-language user agency device, a robot system, and smart AI-powered devices.

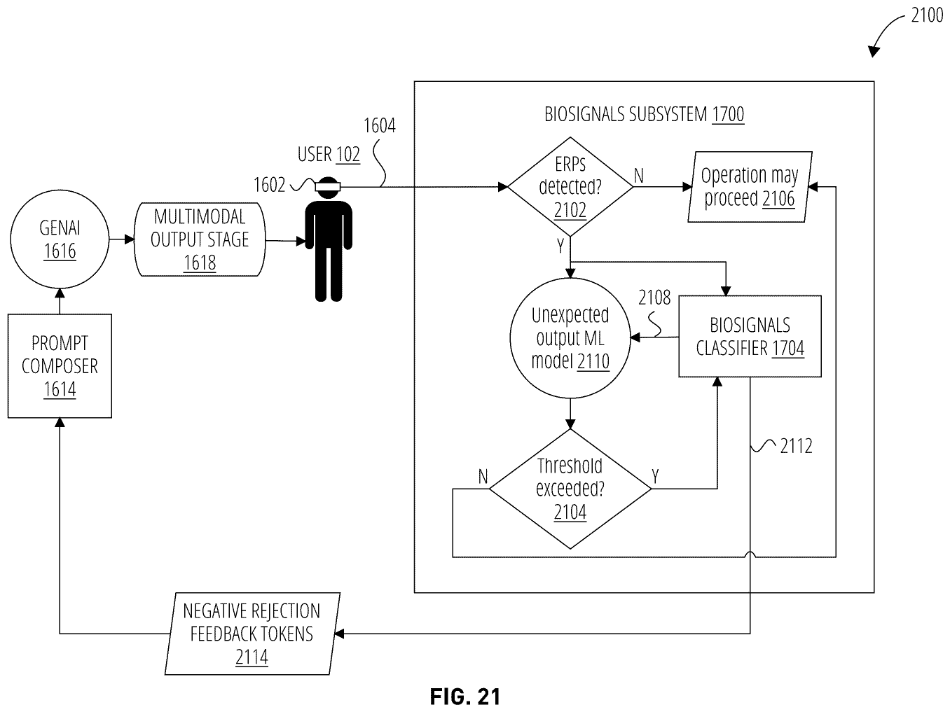

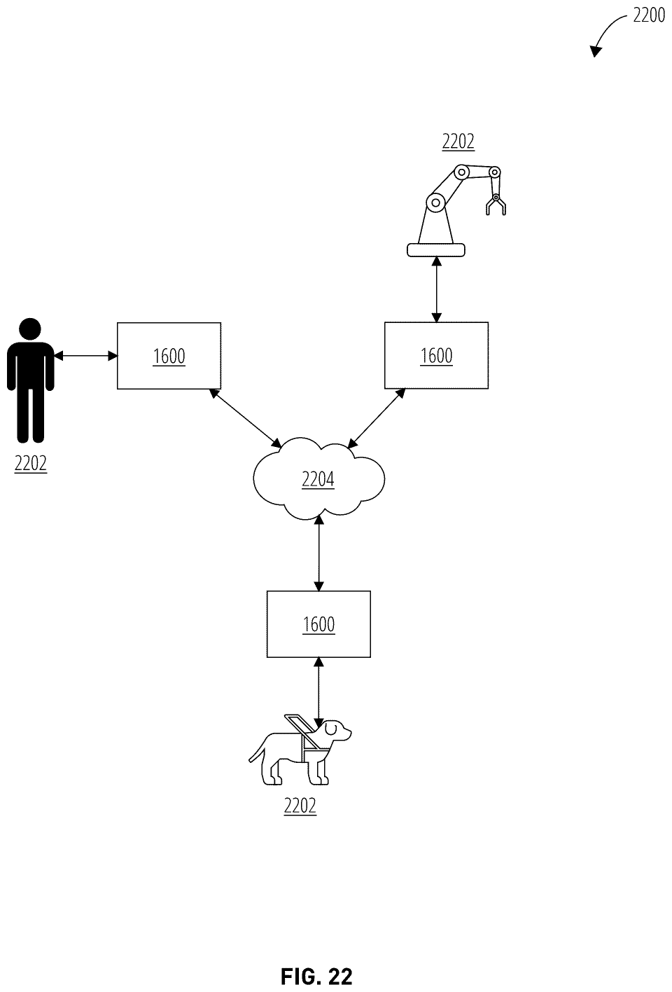

According to some examples, the method includes detecting, using an output adequacy feedback system, an ERP which may be an error-related negativity in response to a multimodal output suggestion at block 1914. For example, the user agency and capability augmentation system with output adequacy feedback 2100 illustrated in FIG. 21 may support detection of an ERP in response to a multimodal output suggestion. If an ERP is not detected at decision block 1916, the method may include allowing the multimodal output suggestion to proceed.

According to some examples, the method includes, if an ERP is detected at decision block 1916, providing negative feedback to at least one of the user and the prompt composer at block 1918. The prompt composer may provide the negative feedback to the GenAI model.

According to some examples, the method includes, if an ERP is detected at decision block 1916, recording the ERP to the multimodal output suggestion at block 1920.

According to some examples, the method includes, if an ERP is detected at decision block 1916, automatically rejecting the multimodal output suggestion, generating new prompts with negative rejection feedback tokens, and sending the negative rejection feedback tokens to the prompt composer at block 1922.

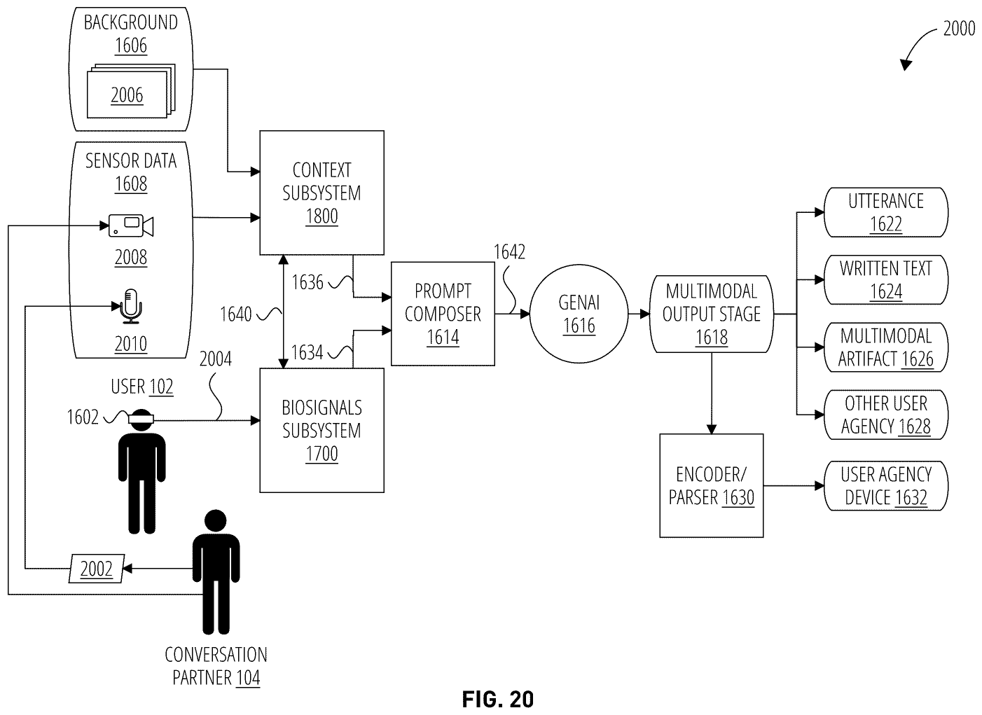

FIG. 20 illustrates a turn-taking capability augmentation system 2000 in accordance with one embodiment. In the turn-taking capability augmentation system 2000, the biosignals subsystem 1700, context subsystem 1800, prompt composer 1614, and model 1616 may work together to detect when it is time for the user 102 to respond to a conversation partner 104 contributing audible speech 2002. The turn-taking capability augmentation system 2000 may comprise all components of the user agency and capability augmentation system 1600, though certain elements are shown in additional detail or are simplified herein for ease of illustration and description.

The biosignals subsystem 1700 may utilize brain sensing to capture and tokenize EEG or similar biosignals 2004 indicating that the user 102 has detected or is anticipating a question or declination in speech which they are expected to respond to. The tokenized EEG or similar biosignals 2004 may be used as the biosignals prompt 1634 and may include anticipatory speech response EEG tokens. Microphone data 2010 may record speech 2002 from the conversation partner 104 for use in determining the appropriate response. At an experimentally determined threshold level of brain sensing anticipation and microphone data 2010 silence, the conversation partner 104 speech 2002 may be converted to text and tokenized by the context subsystem 1800, along with conversation history and user knowledge of a topic 2006. Camera data 2008 showing the motion, stance, lip movements, etc., of the conversation partner 104 may also be tokenized by the context subsystem 1800. This tokenized data may be used to generate the context prompt 1636.

The biosignals prompt 1634 and context prompt 1636 may be combined by the prompt composer 1614 as an automatic response to receiving the conversation partner 104 input. The prompt composer 1614 may send a resulting prompt 1642 to the model 1616. The model 1616 may take this input and generate multimodal outputs that may be used to produce responses that are tonally, semantically, modally, and temporally appropriate to the context provided, including but not limited to the new anticipatory brain sensing data, the speech to text from the conversation partner 104 microphone data 2010, and the rest of the conversation history and user knowledge of a topic 2006. In at least one embodiment, the user 102 may further provide input or direction to the turn-taking capability augmentation system 2000 to select from among possible responses generated by the model 1616.

FIG. 21 illustrates a user agency and capability augmentation system with output adequacy feedback 2100 in accordance with one embodiment. The biosignals subsystem 1700 of the user agency and capability augmentation system with output adequacy feedback 2100 may be configured to detect whether or not the multimodal output of a model 1616 may be automatically rejected based on a user's biosignals 1604 in response to the output at the multimodal output stage 1618. The user agency and capability augmentation system with output adequacy feedback 2100 may comprise all components of the user agency and capability augmentation system 1600, though certain elements are shown in additional detail or are simplified herein for ease of illustration and description.

In one embodiment, after the model 1616 has generated a suggested item in the form of multimodal output, that multimodal output may be available to the perception of the user 102 through various endpoint devices, as previously described. Biosensors configured in the wearable computing and biosignal sensing device 1602 or biosignals subsystem 1700 may detect biosignals 1604 indicating user 102 surprised or negative response, potentially indicating an unexpected or undesired multimodal output. ERPs are well known to those of skill in the art as indicating user surprise when presented with unexpected or erroneous stimuli. If no ERPs are detected in the biosignals 1604 at decision block 2102, Operation may proceed 2106 as usual.

If the user agency and capability augmentation system with output adequacy feedback 2100 detects error/surprise in the form of an ERP at decision block 2102, the user's response and actions in response to the multimodal output stage 1618 output suggestion may be recorded, whether the multimodal output is ultimately accepted or rejected. The user 102 response itself, the strength of the response, and the number of sensors agreeing with the response, may be used in combination with the input tokens to the system (from the original prompt 2108 for which the model 1616 produced the undesired multimodal output) to feed into an unexpected output machine learning model 2110. This model may use supervised learning to determine what combination of error/surprise response+prompt token may be relied upon to predict when a user will reject or accept a suggestion. If the likelihood of suggestion rejection is too low (below an experimentally determined threshold or a user configured threshold), Operation may proceed 2106 as usual.

If the likelihood of suggestion rejection is sufficient to exceed the experimentally determined threshold or user configured threshold at decision block 2104, the system may automatically reject the suggestion and generate a new prompt 2112 including negative rejection feedback tokens 2114. The automatic rejection feedback in the form of the new prompt 2112 with negative rejection feedback tokens 2114 may then be passed back into the prompt composer 1614 to provide negative feedback to the model 1616. Feedback to the model 1616 may include the current context state (e.g. user heart rate, location, conversation partner, history, etc.) as well as the negative ERP.

For example, the model 1616 may generate an utterance that is positive in tone. However, the user 102 may be expecting a message with a negative tone. This incongruity may be detected in the user's biosignals 1604. Sensing in the user agency and capability augmentation system with output adequacy feedback 2100 may include a wearable computing and biosignal sensing device 1602, such as a BCI headset system 2400, which may be capable of eye and pupil tracking, smart device sensors, third-party sensing integrations, etc. These sensors may be capable of detecting EEG signals, EKG signals, heart rate, gaze direction, and facial expression. Such biosignals 1604 as detected herein may show an elevation in heart rate, a widening of the user's eyes, a user's facial expression indicative of puzzlement or displeasure, etc. The biosignals subsystem 1700 may then operate to generate a new prompt 2112 that includes a rejection of the statements generated by the model 1616 in response to the original prompt 2108. In some embodiments, the sensed user response information may be collected and used to refine the model after some period of time.

In the above embodiments, it may be understood by one skilled in the art that a record of inputs and responses may be used to retrain and enhance the performance of any of the system components. For example, a record of natural language outputs from the model 1616 may be scored based on some external measure and this data may then be used to retrain or fine-tune the model 1616.

All of the disclosed embodiments may provide for some type of feedback to a user 102 or another entity. One of ordinary skill in the art will readily apprehend that this feedback may be in the form of a sensory stimuli such as visual, auditory or haptic feedback. However, it may also be clear that this feedback may be transmitted over a network to a server which may be remote from the user 102. This remote device may further transmit the output from the system and/or it may transform the output into some other type of feedback which may then be communicated back to the user 102 and rendered as visual, auditory or haptic stimuli.

Some or all of the elements of the processing steps of the system may be local or remote to the user 102. In some embodiments, processing may be both local and remote while in others, key steps in the processing may leverage remote compute resources. In some embodiments, these remote resources may be edge compute while in others they may be cloud compute.

In some of the embodiments, the user 102 may explicitly select or direct components of the system. For example, the user 102 may be able to choose between Models 1616 that have been trained on a different corpus or training set if they prefer to have a specific type of interaction. In one example, the user 102 may select between a model 1616 trained on clinical background data or a model 1616 trained on legal background data. These models may provide distinct output tokens that are potentially more appropriate for a specific user-intended task or context.

### Simultaneous Users

In some embodiments more than one user 102 may be interacting simultaneously with a common artifact, environment, or in a social scenario. In these embodiments, each simultaneous user 2202 may interact with an instance of one or more of the user agency and capability augmentation system 1600 embodiments described herein.

Further, when multiple such user agency and capability augmentation systems 1600 are present, they may establish direct, digital communication with each other via a local area or mesh network 2204 to allow direct context transmission and exchange of model 1616 outputs.

In some instances, one or more of the simultaneous users 102 may be a robot or other autonomous agent. In yet other instances, one or more of the users 102 may be an assistive animal such as a sight impairment support dog.

FIG. 23 illustrates an exemplary tokenizer 2300 in accordance with one embodiment. Input data 2302 may be provided to the exemplary tokenizer 2300 in the form of a text string typed by a user. In one embodiment, the text string may be generated by performing voice-to-text conversion on an audio stream. The exemplary tokenizer 2300 may detect tokenizable elements 2304 within the input data 2302. Each tokenizable element 2304 may be converted into a token 2306. The set of tokens 2306 created from the tokenizable elements 2304 of the input data 2302 may be sent from the exemplary tokenizer 2300 as tokenized output 2308. The set of tokens 2306 may be such as are used to create the prompt 1642 of FIG. 16.

For structured historical data such as plaintext, database, or web-based textual content, tokens may consist of the numerical indexes in an embedded or vectorized (e.g., word2vec or similar) representation of the text content such as are shown here. In some embodiments, a machine learning technique called an autoencoder may be utilized to transform plaintext inputs into high dimensional vectors that are suitable for indexing and tokenization ingestion by the prompt composer 1614 introduced with respect to FIG. 16.

In some embodiments, data to be tokenized may include audio, visual, or other multimodal data. For images, video, and similar visual data, tokenization may be performed using a convolution-based tokenizer such as a vision transformer. In some alternate embodiments, multimodal data may be quantized and converted into tokens 2306 using a codebook. In yet other alternate embodiments, multimodal data may be directly encoded and for presentation to a language model as a vector space encoding. An exemplary system that utilizes this tokenizer strategy is Gato, a generalist agent capable of ingesting a mixture of discrete and continuous inputs, images, and text as tokens.

FIG. 24A illustrates an isometric view of a BCI headset system 2400 in accordance with one embodiment. The BCI headset system 2400 comprises an augmented reality display lens 2402, a top cover 2404, an adjustable strap 2406, a padding 2408, a ground/reference electrode 2410, a ground/reference electrode adjustment dial 2412, a biosensor electrodes 2414, a battery cell 2416, a fit adjustment dial 2418, and a control panel cover 2420.

The augmented reality display lens 2402 may be removable from the top cover 2404 as illustrated in FIG. 24C. The augmented reality display lens 2402 and top cover 2404 may have magnetic portions that facilitate removably securing the augmented reality display lens 2402 to the top cover 2404. The augmented reality display lens 2402 may in one embodiment incorporate a frame around the lens material allowing the augmented reality display lens 2402 to be handled without depositing oils on the lens material.

The adjustable strap 2406 may secure the BCI headset system 2400 to a wearer's head. The adjustable strap 2406 may also provide a conduit for connections between the forward housing 2432 shown in FIG. 24C and the components located along the adjustable strap 2406 and to the rear of the BCI headset system 2400. Padding 2408 may be located at the front and rear of the BCI headset system 2400, as well as along the sides of the adjustable strap 2406, as illustrated. A fit adjustment dial 2418 at the rear of the BCI headset system 2400 may be used to tighten and loosen the fit of the BCI headset system 2400 by allowing adjustment to the adjustable strap 2406.

A snug fit of the BCI headset system 2400 may facilitate accurate readings from the ground/reference electrodes 2410 at the sides of the BCI headset system 2400, as illustrated here in FIG. 24A as well as in FIG. 24C. A snug fit may also facilitate accurate readings from the biosensor electrodes 2414 positioned at the back of the BCI headset system 2400. Further adjustment to these sensors may be made using the ground/reference electrode adjustment dials 2412 shown, as well as the biosensor electrode adjustment dials 2424 illustrated in FIG. 24B.

In addition to the padding 2408, biosensor electrodes 2414, and fit adjustment dial 2418 already described, the rear of the BCI headset system 2400 may incorporate a battery cell 2416, such as a rechargeable lithium battery pack. A control panel cover 2420 may protect additional features when installed, those features being further discussed with respect to FIG. 24B.

FIG. 24B illustrates a rear view of a BCI headset system 2400 in accordance with one embodiment. The control panel cover 2420 introduced in FIG. 24B is not shown in this figure, so that underlying elements may be illustrated. The BCI headset system 2400 further comprises a control panel 2422, a biosensor electrode adjustment dials 2424, an auxiliary electrode ports 2426, and a power switch 2428.

With the control panel cover 2420 removed, the wearer may access a control panel 2422 at the rear of the BCI headset system 2400. The control panel 2422 may include biosensor electrode adjustment dials 2424, which may be used to calibrate and adjust settings for the biosensor electrodes 2414 shown in FIG. 24A.

The control panel 2422 may also include auxiliary electrode ports 2426, such that additional electrodes may be connected to the BCI headset system 2400. For example, a set of gloves containing electrodes may be configured to interface with the BCI headset system 2400, and readings from the electrodes in the gloves may be sent to the BCI headset system 2400 wirelessly, or via a wired connection to the auxiliary electrode ports 2426.

The control panel 2422 may comprise a power switch 2428, allowing the wearer to power the unit on and off while the control panel cover 2420 is removed. Replacing the control panel cover 2420 may then protect the biosensor electrode adjustment dials 2424 and power switch 2428 from being accidentally contacted during use. In one embodiment, a power light emitting diode (LED) may be incorporated onto or near the power switch 2428 as an indicator of the status of unit power, e.g., on, off, battery low, etc.

FIG. 24C illustrates an exploded view of a BCI headset system 2400 in accordance with one embodiment. The BCI headset system 2400 further comprises a universal serial bus or USB port 2430 in the rear of the BCI headset system 2400 as well as a forward housing 2432 which may be capable of holding a smart phone 2434. The USB port 2430 may in one embodiment be a port for a different signal and power connection type. The USB port 2430 may facilitate charging of the battery cell 2416 and may allow data transfer through connection to additional devices and electrodes.

The top cover 2404 may be removed from the forward housing 2432 as shown to allow access to the forward housing 2432, in order to seat and unseat a smart phone 2434. The smart phone 2434 may act as all or part of the augmented reality display. In a BCI headset system 2400 incorporating a smart phone 2434 in this manner, the augmented reality display lens 2402 may provide a reflective surface such that a wearer is able to see at least one of the smart phone 2434 display and the wearer's surroundings within their field of vision.

The top cover 2404 may incorporate a magnetized portion securing it to the forward housing 2432, as well as a magnetized lens reception area, such that the augmented reality display lens 2402 may, through incorporation of a magnetized frame, be secured in the front of the top cover 2404, and the augmented reality display lens 2402 may also be removable in order to facilitate secure storage or access to the forward housing 2432.

FIG. 24D illustrates an exploded view of a BCI headset system 2400 in accordance with one embodiment. The BCI headset system 2400 further comprises a smart phone slot 2436 in the forward housing 2432. When the augmented reality display lens 2402 and top cover 2404 are removed to expose the forward housing 2432 as shown, the smart phone slot 2436 may be accessed to allow a smart phone 2434 (not shown in this figure) to be inserted.

FIG. 25 illustrates a logical diagram of a user wearing an augmented reality headset 2500 that includes a display, speakers and vibration haptic motors and an accelerometer/gyroscope and magnetometer. FIG. 25 shows the flow of activity from head motion analog input 2502 as captured by a headset with head motion detection sensors 2504, through how a user selects options through head motion 2506 and the application creates output based on the user's selected options 2508. On the condition that system detects the user is away from home 2510, FIG. 25 shows that the system may send output to a caregiver via text message 2512.

The user may calibrate the headset based on the most comfortable and stable neck and head position which establishes the X/Y/Z position of 0/0/0. Based on this central ideal position, the user interface is adjusted to conform to the user's individual range of motion, with an emphasis of reducing the amount of effort and distance needed to move a virtual pointer in augmented reality from the 0/0/0 position to outer limits of their field of view and range of motion. The system may be personalized with various ergonomic settings to offset and enhance the users ease of use and comfort using the system. A head motion analog input 2502 may be processed as analog streaming data and acquired by the headset with head motion detection sensors 2504 in real-time, and digitally processed, either directly on the sensory device or via a remotely connected subsystem. The system may include embedded software on the sensory device that handles the pre-processing of the analog signal. The system may include embedded software that handles the digitization and post-processing of the signals. Post-processing may include but not be limited to various models of compression, feature analysis, classification, metadata tagging, categorization. The system may handle preprocessing, digital conversion, and post-processing using a variety of methods, ranging from statistical to machine learning. As the data is digitally post-processed, system settings and metadata may be referred to determine how certain logic rules in the application are to operate, which may include mapping certain signal features to certain actions. Based on these mappings, the system operates by sending these post-processed data streams as tokens to the GenAI models and may include saving data locally on the sensory device or another storage device, streaming data to other subsystems or networks.

In the case illustrated in FIG. 25, the user is looking at a display that may include characters, symbols, pictures, colors, videos, live camera footage or other visual, oral or interactive content. In this example, the user is looking at a set of “radial menus” or collection of boxes or circles with data in each one that may be a symbol, character, letter, word or entire phrase. The user has been presented a set of words that surround a central phrase starter word in the middle like a hub and spoke to choose from based on typical functional communication with suggested fringe words and access to predictive keyboard, structured and unstructured language. The user selects options through head motion 2506 and may rapidly compose a phrase by selecting the next desired word presented in the radial menus or adding a new word manually via another input method. The user traverses the interface using head movement gestures, similar to 3-dimensional swipe movements, to compose communication. The user progressively chooses the next word until they're satisfied with the phrase they've composed and may determine how to actuate the phrase. Algorithms may be used to predict the next character, word, or phrase, and may rearrange or alter the expression depending on its intended output including but not limited to appending emoji, symbols, colors, sounds or rearranging to correct for spelling or grammar errors. The user may desire for the phrase to be spoken aloud to a person nearby, thus selecting a “play button” or simply allowing the sentence to time out to be executed automatically. The application creates output based on the user's selected options 4208. If they compose a phrase that is a control command like “turn off the lights”, they may select a “send button” or may, based on semantic natural language processing and understanding, automatically send the phrase to a third party virtual assistant system to execute the command, and turn off the lights. The potential use of metadata, in this example, could simply be geolocation data sourced from other systems such as a geographic information system (GIS) or a global positioning system (GPS) data or WiFi data, or manually personalized geofencing in the application personalization settings, where the system would know if the user is “at home” or “away from home”. On condition that system detects the user is away from home 2510, for example, the metadata may play a role in adapting the language being output to reflect the context of the user. For instance, the system could be configured to speak aloud when at home but send output to a caregiver via text message 2512 and append GPS coordinates when away from home. The system may support collecting and processing historical data from the sensory device, system, subsystems, and output actions to improve the performance and personalization of the system, subsystems, and sensory devices.

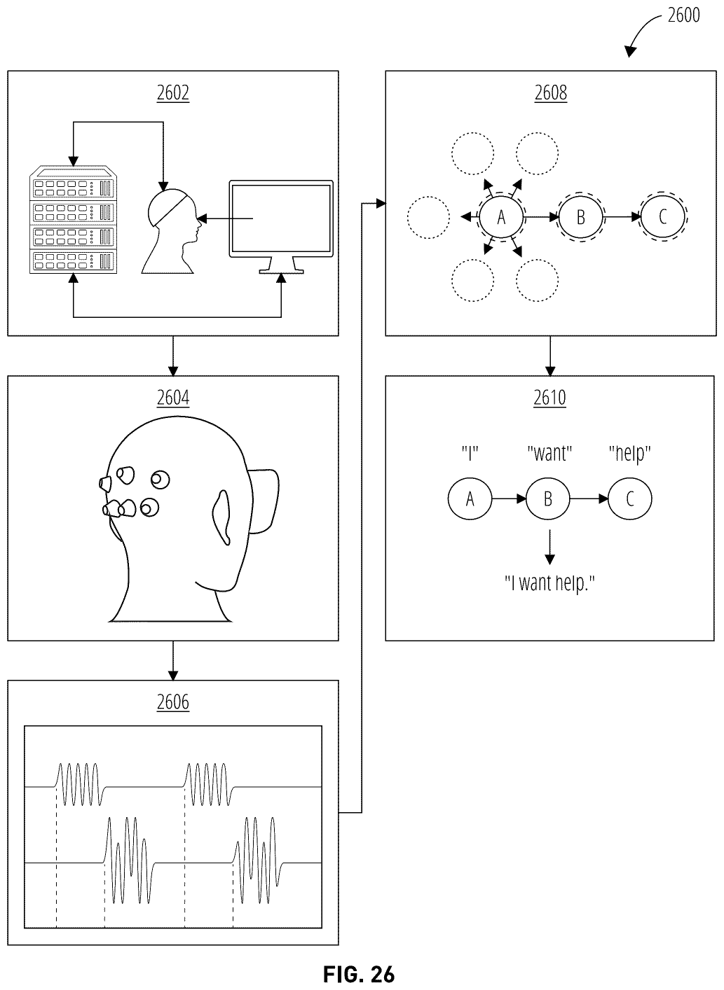

FIG. 26 illustrates a logical diagram of a user wearing an augmented reality headset 2600, in which user wears an EEG-based brain-computer interface headset 2602 containing electrodes that are contacting the scalp 2604. FIG. 26 shows that streaming analog data may be acquired from the brainwave activity 2606. In this manner, the user may be presented a set of words to choose from 2608, compose a phrase, and select what action the system takes using the phrase they've composed 2610.

A user wears an EEG-based brain-computer interface headset 2602 containing electrodes that are contacting the scalp 2604. The electrodes are connected to an amplifier and analog-to-digital processing pipeline. The sensory device (BCI) acquires streaming electrical current data measured in microvolts (μV). The more electrodes connected to the scalp and to the BCI, the more streaming analog data may be acquired from the brainwave activity 2606. The analog streaming data is acquired by the electrodes, pre-processed through amplification, and digitally processed, either directly on the sensory device or via a remotely connected subsystem. The system may include embedded software on the sensory device that handles the pre-processing of the analog signal. The system may include embedded software that handles the digitization and post-processing of the signals. Post-processing may include but not be limited to various models of compression, feature analysis, classification, metadata tagging, categorization. The system may handle preprocessing, digital conversion, and post-processing using a variety of methods, ranging from statistical to machine learning. As the data is digitally post-processed, system settings and metadata may be referred to determine how certain logic rules in the application are to operate, which may include mapping certain signal features to certain actions. Based on these mappings, the system operates by executing commands and may include saving data locally on the sensory device or another storage device, streaming data to other subsystems or networks.

In the case illustrated in FIG. 26, the user is looking at a display that may include characters, symbols, pictures, colors, videos, live camera footage or other visual, oral or interactive content. In this example, the user is looking at a group of concentric circles, arranged in a radial layout, with characters on each circle. The user has been presented a set of words to choose from 2608 based on typical functional communication with suggested fringe words and access to predictive keyboard and may rapidly compose a phrase by selecting the next desired word presented in the outer ring of circles or adding a new word manually. The user progressively chooses the next word until they're satisfied with the phrase they've composed 2610 and may determine how to actuate the phrase. GenAI may be used to predict the next character, word, or phrase, and may rearrange or alter the expression depending on its intended output including but not limited to appending emoji, symbols, colors, sounds or rearranging to correct for spelling or grammar errors. The user may desire for the phrase to be spoken aloud to a person nearby, thus selecting a “play button” or simply allowing the sentence to time out to be executed automatically. If they compose a phrase that is a control command like “turn off the lights”, they may select a “send button” or may, based on semantic natural language processing and understanding, automatically send the phrase to a third party virtual assistant system to execute the command, and turn off the lights. The potential use of metadata, in this example, could simply be geolocation data sourced from other systems such as GIS or GPS data or WiFi data, or manually personalized geofencing in the application personalization settings, where the system may know if the user is “at home” or “away from home”. In this case, the metadata may play a role in adapting the language being output to reflect the context of the user. For instance, the system could be configured to speak aloud when at home but send to a caregiver via text message and append GPS coordinates when away from home. The system may support collecting and processing historical data from the sensory device, system, subsystems, and output actions to improve the performance and personalization of the system, subsystems, and sensory devices.

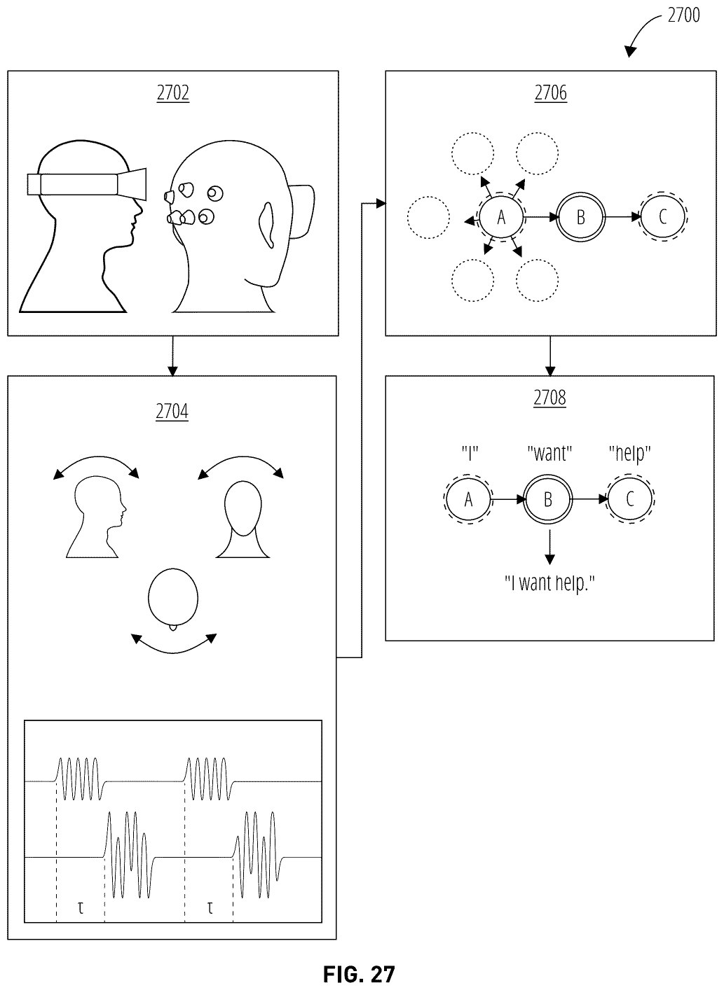

FIG. 27 illustrates a diagram of a use case including a user wearing an augmented reality headset 2700, in which a user wears an augmented reality headset combined with a brain computer interface 2702, having the capabilities described with respect to FIG. 25 and FIG. 26. Both head motion analog input and brainwave activity 2704 may be detected and may allow a user to select from a set of words to choose from 2706, as well as what to do with the phrase they've composed 2708 by selecting those words.

A user is wearing an augmented reality headset combined with a brain computer interface on their head. The headset contains numerous sensors as a combined sensory device including motion and orientation sensors and temporal bioelectric data generated from the brain detected via EEG electrodes contacting the scalp of the user, specifically in the regions where visual, auditory and sensory/touch is processed in the brain. The AR headset may produce visual, auditory or haptic stimulation that is detectible via the brain computer interface, and by processing brainwave data with motion data, the system may provide new kinds of multi-modal capabilities for a user to control the system. The analog streaming data is acquired by the Accelerometer, Gyroscope, Magnetometer and EEG analog-to-digital processor, and digitally processed, either directly on the sensory device or via a remotely connected subsystem. The system may include embedded software on the sensory device that handles the pre-processing of the analog signal. The system may include embedded software that handles the digitization and post-processing of the signals. Post-processing may include but not be limited to various models of compression, feature analysis, classification, metadata tagging, categorization. The system may handle preprocessing, digital conversion, and post-processing using a variety of methods, ranging from statistical to machine learning. As the data is digitally post-processed, system settings and metadata may be referred to determine how certain logic rules in the application are to operate, which may include mapping certain signal features to certain actions. Based on these mappings, the system operates by executing commands and may include saving data locally on the sensory device or another storage device, streaming data to other subsystems or networks.

In the case illustrated in FIG. 27, the user is looking at a display that may include characters, symbols, pictures, colors, videos, live camera footage or other visual, oral or interactive content. In this example, the user is looking at a visual menu system in AR with certain hard to reach elements flickering at different frequencies. The user has been presented a set of items to choose from based on typical functional communication with suggested fringe words and access to predictive keyboard and may rapidly compose a phrase by selecting the next desired word presented in the AR head mounted display or adding a new word manually. Enabling the user affordances of extra-sensory reach of visible objects out of reach within the comfortable range of motion of neck movement. The user progressively chooses the next word until they're satisfied with the phrase they've composed and may determine how to actuate the phrase. Algorithms may be used to predict the next character, word, or phrase, and may rearrange or alter the expression depending on its intended output including but not limited to appending emoji, symbols, colors, sounds or rearranging to correct for spelling or grammar errors. The user may desire for the phrase to be spoken aloud to a person nearby, thus selecting a “play button” or simply allowing the sentence to time out to be executed automatically. If they compose a phrase that is a control command like “turn off the lights”, they may select a “send button” or may, based on semantic natural language processing and understanding, automatically send the phrase to a third party virtual assistant system to execute the command, and turn off the lights. The potential use of metadata, in this example, could simply be geolocation data sourced from other systems such as GIS or GPS data or WiFi data, or manually personalized geofencing in the application personalization settings, where the system may know if the user is “at home” or “away from home”. In this case, the metadata may play a role in adapting the language being output to reflect the context of the user. For instance, the system could be configured to speak aloud when at home but send to a caregiver via text message and append GPS coordinates when away from home. The system may support collecting and processing historical data from the sensory device, system, subsystems, and output actions to improve the performance and personalization of the system, subsystems, and sensory devices.

FIG. 28 is a flow diagram 2800 showing a closed loop bio-signal data flow for a nonverbal multi-input and feedback device such as herein. It may be performed by inputs or a computer of the device. The flow diagram 2800 comprises a human user 2802, electrode sensors 2804, a brain computer interface headset and firmware 2806, an augmented reality mobile application 2808, machine learning capture and training 2810 that may be performed in an edge, peer, or cloud device, and an augmented reality headset 2812. The electrode sensors 2804 may capture 2814 data that is sent for analog-to-digital 2816 conversion. The digital signal may be used for intent detection 2818 resulting in an action trigger 2820 to a user interface 2822. The digital data may further be sent to raw data capture 2826 and may be used as training data 2832 for training and data analysis 2834. Training and data analysis 2834 may yield machine learning parameters 2824 which may be fed back for use in intent detection 2818. The user interface 2822 may determine stimulus placement and timing 2828, which may be used in the augmented reality environment 2830 created by the augmented reality mobile application 2808. The stimulus placement and timing 2836 resulting in the augmented reality headset 2812 and may evoke potential stimulus 2838 in the human user 2802. The user interface 2822 may also generate an output and action 2840.

The flow diagram 2800 includes computer stimulates visual, auditory and somatosensory cortex with evoked potentials; signal processing of real time streaming brain response; human controls computer based on mental fixation of stimulation frequencies; and system may determine different output or actions on behalf of the user for input data received via one or more sensors of the device. Flow diagram 2800 may apply to a user wearing any of the nonverbal multi-input and feedback devices and/or sensors herein. As a result of this being closed-loop biofeedback and sensory communication and control system that stimulates the brains senses of sight, sound, and touch and reads specific stimulation time-based frequencies, and tags them with metadata in real-time as the analog data is digitized, the user may rapidly learn how to navigate and interact with the system using their brain directly. This method of reinforcement learning is known in the rapid development process of the brain's pattern recognition abilities and the creation of neural plasticity to develop new neural connections based on stimulation and entrainment. This further allows the system to become a dynamic neural prosthetic extension of their physical and cognitive abilities. The merging of context awareness metadata, vocabulary, and output and action logic into the central application in addition to a universal interface for signal acquisition and data processing is what makes this system extremely special. Essentially, this system helps reduce the time latency between detecting cognitive intention and achieving the associated desired outcome, whether that be pushing a button, saying a word or controlling robots, prosthetics, smart home devices or other digital systems.

FIG. 29 is a flow diagram 2900 showing multimodal, multi-sensory system for communication and control 2902 for a nonverbal multi-input and feedback device such as herein. It may be performed by inputs or a computer of the device. The flow diagram 2900 comprises multimodal, multi-sensory systems for communication and control 2902 that includes wireless neck and head tracking 2904 and wireless brain tracking 2906. The multimodal, multi-sensory system for communication and control 2902 may further comprise central sensors 2908 for EEG, peripheral sensors 2910 such as EMG, EOG, ECG, and others, an analog to digital signal processor 2912 processing data from the central sensors 2908, and an analog to digital signal processor 2914 processing data from the peripheral sensors 2910. The analog to digital subsystem 2916 and sensor service subsystem 2918 manage output from the analog to digital signal processor 2912 and the analog to digital signal processor 2914, respectively. Output from the analog to digital subsystem 2916 may be sent to a storage subsystem 2960.

Outputs from the analog to digital subsystem 2916 and sensor service subsystem 2918 go to a collector subsystem 2920, which also receives a real-time clock 2922. The collector subsystem 2920 communicates with a recognizer 2924 for EEG data and a classifier 2926 for EMG, EOG, and ECG data, and data from other sensing. The collector subsystem 2920 further communicates to a wireless streamer 2928 and a serial streamer 2930 to interface with a miniaturized mobile computing system 2936 and a traditional workstation 2932, respectively. The traditional workstation 2932 and miniaturized mobile computing system 2936 may communicate with a cloud 2934 for storage or processing. The miniaturized mobile computing system 2936 may assist in wireless muscle tracking 2938 (e.g., EMG data) and wireless eye pupil tracking 2940.

A controller subsystem 2942 accepts input from a command queue 2944 which accepts input from a Bluetooth or BT write callback 2950. The BT write callback 2950 may send commands 2946 to a serial read 2948. The controller subsystem 2942 may send output to the controller subsystem 2942 and a peripherals subsystem 2952. The peripherals subsystem 2952 generates audio feedback 2954, haptic feedback 2956, and organic LED or OLED visual feedback 2958 for the user.

The flow diagram 2900 includes synchronizing signals from multiple biosensors including brain, body (see skin colored arm), eye and movement; processing multiple models concurrently for multi-sensory input; and directing and processing biofeedback through peripheral subsystems. Flow diagram 2900 may apply to a user wearing any of the nonverbal multi-input and feedback devices and/or sensors herein.

### Identifying Conversation Participants

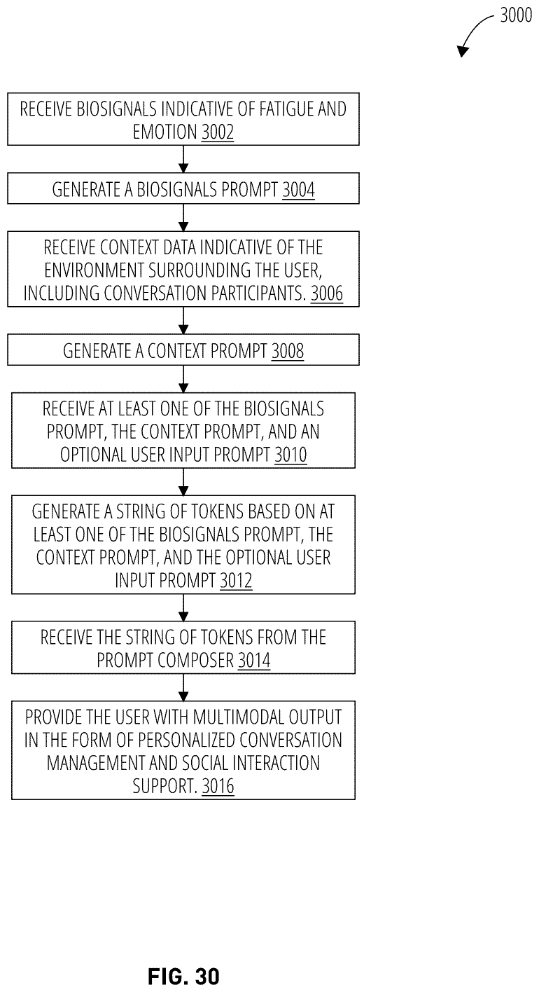

FIG. 30 illustrates an example routine 3000 for identifying conversation participants. Although the example routine 3000 depicts a particular sequence of operations, the sequence may be altered without departing from the scope of the present disclosure. For example, some of the operations depicted may be performed in parallel or in a different sequence that does not materially affect the function of the routine 3000. In other examples, different components of an example device or system that implements the routine 3000 may perform functions at substantially the same time or in a specific sequence.

According to some examples, the method includes receiving biosignals indicative of fatigue and emotion at block 3002. For example, the biosignals subsystem 1700 illustrated in FIG. 17 may receive biosignals indicative of fatigue and emotion. These biosignals 1604 may include EEG data, heart rate and respiratory rate data, gaze detection data, and other biosignals capable of providing information on a user's energy levels and emotional state.

According to some examples, the method includes generating a biosignals prompt at block 3004. For example, the biosignals subsystem 1700 illustrated in FIG. 17 may generate a biosignals prompt. The biosignals prompt 1634 may be generated by tokenizing the received biosignals 1604.

According to some examples, the method includes receiving context data indicative of the environment surrounding the user, including conversation participants at block 3006. In one embodiment, the system may include a Bluetooth antenna capable of detecting IoT devices in close proximity to the user, although one skilled in the art will readily recognize that other discovery methods are also possible. This data may be included in sensor data 1608 to the context subsystem 1800. Such devices may be used to identify persons in proximity to the user. Camera data may also be used to detect conversation participants, who may be identified through analysis of captured video. Background material 1606 to the context subsystem 1800 may include previous conversations the user has had with the detected conversation participants, or other details stored about the identified participants. In one embodiment, the system may utilize computational auditory scene analysis (CASA) to identify nearby speakers and associate them with known or unknown contacts. Other possible sensing methods may include computer vision, network-based user registration such as in mobile location tracking applications, or calendar attendance entries. As alternative/additional inputs to this system, if a conversation partner has previously been identified, nearby Bluetooth device identifiers (IDs) may be stored as relevant context information, and the system may use a machine learning model or other model type to learn which partner(s) is (are) likely to be present given a particular constellation of Bluetooth device IDs

According to some examples, the method includes generating a context prompt at block 3008. The context subsystem 1800 may form a context prompt 1636 by tokenizing received context data. The context prompt 1636 may indicate an inference of the user's conversation intent based on data such as historical speech patterns and known device identities.

According to some examples, the method includes receiving at least one of the biosignals prompt, the context prompt, and an optional user input prompt at block 3010. For example, the prompt composer 1614 illustrated in FIG. 16 may receive at least one of the biosignals prompt, the context prompt, and an optional user input prompt. The user input prompt 1638 may include keywords or phrases related to desired speech output.

According to some examples, the method includes generating a string of tokens based on at least one of the biosignals prompt, the context prompt, and the optional user input prompt at block 3012. For example, the prompt composer 1614 illustrated in FIG. 16 may generate a string of tokens based on at least one of the biosignals prompt, the context prompt, and the optional user input prompt.

According to some examples, the method includes receiving the string of tokens from the prompt composer at block 3014. For example, the model 1616 illustrated in FIG. 16 may receive the string of tokens from the prompt composer. The model 1616 may be a pre-trained natural language model configured to provide conversation management and social interaction support.

According to some examples, the method includes providing the user with multimodal output in the form of personalized conversation management and social interaction support at block 3016. For example, the model 1616 illustrated in FIG. 16 may provide the user with multimodal output in the form of personalized conversation management and social interaction support. This may come in the form of visual, audible, or haptic feedback provided to the user by the wearable computing and biosignal sensing device 1602, as text overlay presented on a computing device, etc.

### Emotion Prediction/Estimation

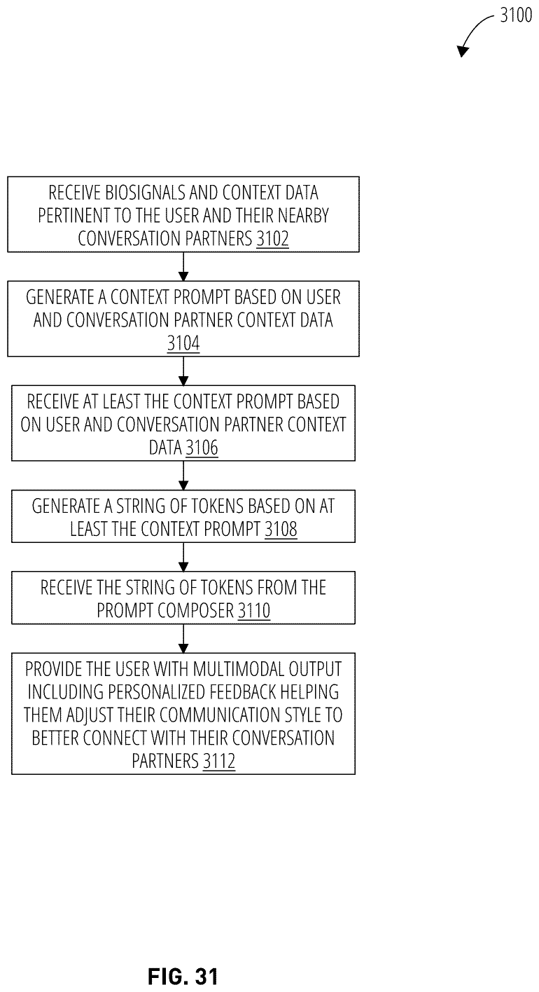

FIG. 31 illustrates an example routine 3100 for emotion prediction/estimation. Although the example routine 3100 depicts a particular sequence of operations, the sequence may be altered without departing from the scope of the present disclosure. For example, some of the operations depicted may be performed in parallel or in a different sequence that does not materially affect the function of the routine 3100. In other examples, different components of an example device or system that implements the routine 3100 may perform functions at substantially the same time or in a specific sequence. The routine 3100 may be performed in whole or part by an AR communication app. This app may be valuable in contexts where individuals with social communication difficulties desire additional support in understanding their conversation partner's feelings. In particular, individuals with cognitive and social disorders such as Autism may utilize this type of information to gain additional feedback on social interactions.

According to some examples, the method includes receiving biosignals and context data pertinent to the user and their nearby conversation partners at block 3102. For example, the context subsystem 1800 illustrated in FIG. 18 may receive biosignals and context data pertinent to the user and their nearby conversation partners. The sensor data 1608 received by the context subsystem 1800 may include phone sensor data, biosignals from the wearable computing and biosignal sensing device 1602 or shared data 1640 from the biosignals subsystem 1700. Background material 1606 may be received by the context subsystem 1800 which includes data about previous interactions between the user and particular conversation partners. The context subsystem 1800 may incorporate a machine learning algorithm to estimate the user's emotions and provide real-time feedback on their conversation partner's emotional state based on facial expressions, body language, and biosignals.

According to some examples, the method includes generating a context prompt based on user and conversation partner context data at block 3104. For example, the context subsystem 1800 illustrated in FIG. 18 may generate a context prompt based on user and conversation partner context data. The context prompt 1636 may be a tokenization of the biosignals 1604 and context data received by the context subsystem 1800.

According to some examples, the method includes receiving at least the context prompt based on user and conversation partner context data at block 3106. For example, the prompt composer 1614 illustrated in FIG. 16 may receive at least the context prompt based on user and conversation partner context data. The prompt composer 1614 may be configured to provide tokens in addition to the tokenized context data. In one embodiment, the user may provide a user input prompt 1638 to the prompt composer 1614 which may be used to modify the content prompt.

According to some examples, the method includes generating a string of tokens based on at least the context prompt at block 3108. For example, the prompt composer 1614 illustrated in FIG. 16 may generate a string of tokens based on at least the context prompt.

According to some examples, the method includes receiving the string of tokens from the prompt composer at block 3110. For example, the model 1616 illustrated in FIG. 16 may receive the string of tokens from the prompt composer.

According to some examples, the method includes providing the user with multimodal output including personalized feedback helping them adjust their communication style to better connect with their conversation partners at block 3112. For example, the model 1616 illustrated in FIG. 16 may provide the user with multimodal output including personalized feedback helping them adjust their communication style to better connect with their conversation partners. The large multimodal output stage 1618 may include a set of suggestions that are rendered into private audio for the user 102. In another embodiment, the output is visually rendered into a heads-up display. In yet another embodiment, the output may be rendered into a multimodal feedback that expresses an affect grid coordinate to the user using a mixture of output modalities (e.g., valence may be mapped to an auditory pattern and arousal may be mapped to a haptic pattern). In one embodiment, the system may further provide context information (e.g., background material 1606) summarizing prior engagements with specific individuals and proposing suggestions for improving social outcomes.

### Enhancing Autonomous Vehicle Safety and Comfort

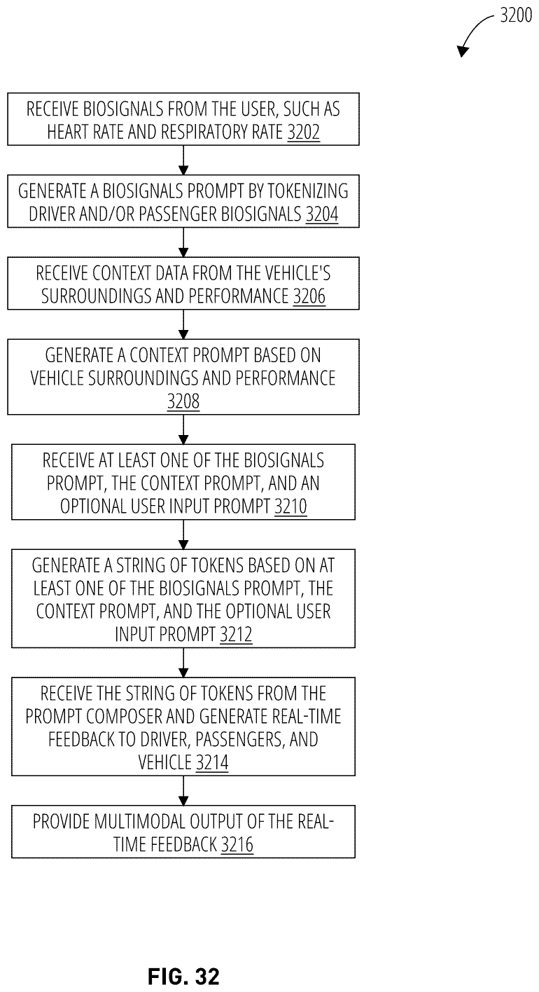

FIG. 32 illustrates an example routine 3200 for enhancing autonomous vehicle safety and comfort. Although the example routine 3200 depicts a particular sequence of operations, the sequence may be altered without departing from the scope of the present disclosure. For example, some of the operations depicted may be performed in parallel or in a different sequence that does not materially affect the function of the routine 3200. In other examples, different components of an example device or system that implements the routine 3200 may perform functions at substantially the same time or in a specific sequence.

According to some examples, the method includes receiving biosignals from the user, such as heart rate and respiratory rate at block 3202. For example, the biosignals subsystem 1700 illustrated in FIG. 17 may receive biosignals from the user, such as EEG (event-related potential or similar), heart rate and respiratory rate. The biosignals 1604 may be detected using a wearable computing and biosignal sensing device 1602 or the additional biosensors 1702 configured in the biosignals subsystem 1700. In one embodiment, biosensors may be integrated into portions of the vehicle and may detect biosignals 1604 from the driver and any passengers present.

According to some examples, the method includes generating a biosignals prompt by tokenizing driver and/or passenger biosignals at block 3204. For example, the biosignals subsystem 1700 illustrated in FIG. 17 may generate a biosignals prompt by tokenizing driver and/or passenger biosignals. The biosignals prompt 1634 may be generated by tokenizing the received biosignals 1604.

According to some examples, the method includes receiving context data from the vehicle's surroundings and performance at block 3206. For example, the context subsystem 1800 illustrated in FIG. 18 may receive context data from the vehicle's surroundings and performance. Such data may be in the form of sensor data 1608 from cameras and lidar, in addition to other device data 1610 from the vehicle's computerized vehicle management unit.

According to some examples, the method includes generating a context prompt based on vehicle surroundings and performance at block 3208. For example, the context subsystem 1800 illustrated in FIG. 18 may generate a context prompt based on vehicle surroundings and performance.

According to some examples, the method includes receiving at least one of the biosignals prompt, the context prompt, and an optional user input prompt at block 3210. For example, the prompt composer 1614 illustrated in FIG. 16 may receive at least one of the biosignals prompt, the context prompt, and an optional user input prompt. The user input prompt 1638 may include data from vehicle passengers.

According to some examples, the method includes generating a string of tokens based on at least one of the biosignals prompt, the context prompt, and the optional user input prompt at block 3212. For example, the prompt composer 1614 illustrated in FIG. 16 may generate a string of tokens based on at least one of the biosignals prompt, the context prompt, and the optional user input prompt.

According to some examples, the method includes receiving the string of tokens from the prompt composer and generating real-time feedback to driver, passengers, and vehicle at block 3214. For example, the model 1616 illustrated in FIG. 16 may receive the string of tokens from the prompt composer and generate real-time feedback to driver, passengers, and vehicle.

According to some examples, the method includes providing multimodal output of the real-time feedback at block 3216. For example, the model 1616 illustrated in FIG. 16 may provide multimodal output of the real-time feedback. In one embodiment, the real-time feedback may instruct the vehicle's autonomous control system to adjust speed, route, and other factors to improve passenger safety and comfort. The output of the model 1616 may be converted into multimodal sensations through vehicle instruments such as the steering wheel, driver heads up display and/or over the in-vehicle audio system. In one embodiment the system may utilize estimates of the user's anxiety or comfort, derived from one or more biosensors, in order to adapt the navigation or driving style of an autonomous vehicle.

### Enhancing Social Media Engagement

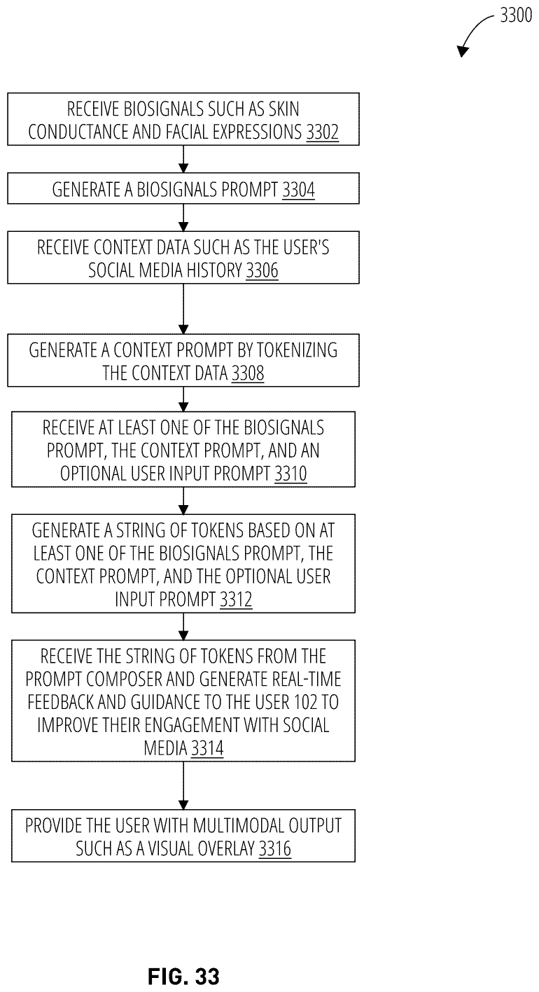

FIG. 33 illustrates an example routine 3300 for enhancing social media engagement and/or assisting a user 102 in achieving social goals. Although the example routine 3300 depicts a particular sequence of operations, the sequence may be altered without departing from the scope of the present disclosure. For example, some of the operations depicted may be performed in parallel or in a different sequence that does not materially affect the function of the routine 3300. In other examples, different components of an example device or system that implements the routine 3300 may perform functions at substantially the same time or in a specific sequence.

According to some examples, the method includes receiving biosignals such as skin conductance and facial expressions at block 3302. For example, the biosignals subsystem 1700 illustrated in FIG. 17 may receive biosignals such as skin conductance and facial expressions.

According to some examples, the method includes generating a biosignals prompt at block 3304. For example, the biosignals subsystem 1700 illustrated in FIG. 17 may generate a biosignals prompt. The biosignals prompt 1634 may be generated by tokenizing the received biosignals 1604.

According to some examples, the method includes receiving context data such as the user's social media history at block 3306. For example, the context subsystem 1800 illustrated in FIG. 18 may receive context data such as the user's social media history.

According to some examples, the method includes generating a context prompt by tokenizing the context data at block 3308. For example, the context subsystem 1800 illustrated in FIG. 18 may generate a context prompt by tokenizing the context data.

According to some examples, the method includes receiving at least one of the biosignals prompt, the context prompt, and an optional user input prompt at block 3310. For example, the prompt composer 1614 illustrated in FIG. 16 may receive at least one of the biosignals prompt, the context prompt, and an optional user input prompt. The user input prompt 1638 may include keywords or commands from the user indicating enhancements they desire or a self-assessment of their emotional state.

According to some examples, the method includes generating a string of tokens based on at least one of the biosignals prompt, the context prompt, and the optional user input prompt at block 3312. For example, the prompt composer 1614 illustrated in FIG. 16 may generate a string of tokens based on at least one of the biosignals prompt, the context prompt, and the optional user input prompt.

According to some examples, the method includes receiving the string of tokens from the prompt composer and generating real-time feedback and guidance to the user 102 to improve their engagement with social media at block 3314. For example, the model 1616 illustrated in FIG. 16 may receive the string of tokens from the prompt composer and generate real-time feedback and guidance to the user 102 to improve their engagement with social media. Such guidance may include personalized recommendations for content, real-time feedback on the user's emotional state, and suggestions for alternate phrasing of posts.

According to some examples, the method includes providing the user with multimodal output such as a visual overlay at block 3316. For example, the model 1616 illustrated in FIG. 16 may provide the user 102 with multimodal output such as a visual overlay. In some embodiments the feedback may be provided via transformation of the of biosignals 1604 and a valence estimate based on the user's generated content. This feedback may be in the form of visual, auditory or haptic sensations that are displayed, rendered, or otherwise generated on a wearable or other computing interface device.

### Reducing Social Isolation

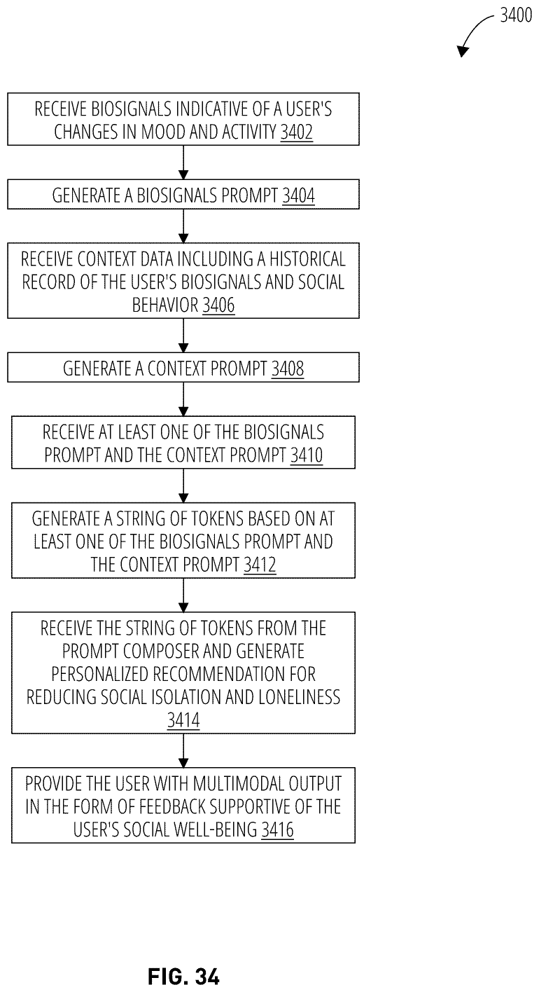

FIG. 34 illustrates an example routine 3400 for reducing social isolation. Although the example routine 3400 depicts a particular sequence of operations, the sequence may be altered without departing from the scope of the present disclosure. For example, some of the operations depicted may be performed in parallel or in a different sequence that does not materially affect the function of the routine 3400. In other examples, different components of an example device or system that implements the routine 3400 may perform functions at substantially the same time or in a specific sequence.

According to some examples, the method includes receiving biosignals indicative of a user's changes in mood and activity at block 3402. For example, the biosignals subsystem 1700 illustrated in FIG. 17 may receive biosignals indicative of a user's changes in mood and activity.

According to some examples, the method includes generating a biosignals prompt at block 3404. For example, the biosignals subsystem 1700 illustrated in FIG. 17 may generate a biosignals prompt. The biosignals prompt 1634 may be generated by tokenizing the received biosignals 1604.

According to some examples, the method includes receiving context data including a historical record of the user's biosignals and social behavior at block 3406. For example, the context subsystem 1800 illustrated in FIG. 18 may receive context data including a historical record of the user's biosignals and social behavior. The user's biosignals 1604 history may be tracked by storing as background material 1606 the biosignals 1604 received from the wearable computing and biosignal sensing device 1602 and additional biosensors 1702, which may be shared to the context subsystem 1800 as shared data 1640 from the biosignals subsystem 1700. The user's history of social behavior and activity on social media may be tracked through the online record and received as application context 1612 and/or background material 1606.

According to some examples, the method includes generating a context prompt at block 3408. For example, the context subsystem 1800 illustrated in FIG. 18 may generate a context prompt. The context prompt 1636 may be generated by tokenizing the received context data. The context prompt 1636 may indicate predictions for changes in the user's mood, activity, and social behavior.

According to some examples, the method includes receiving at least one of the biosignals prompt and the context prompt at block 3410. For example, the prompt composer 1614 illustrated in FIG. 16 may receive at least one of the biosignals prompt and the context prompt.

According to some examples, the method includes generating a string of tokens based on at least one of the biosignals prompt and the context prompt at block 3412. For example, the prompt composer 1614 illustrated in FIG. 16 may generate a string of tokens based on at least one of the biosignals prompt and the context prompt.

According to some examples, the method includes receiving the string of tokens from the prompt composer and generating personalized recommendation for reducing social isolation and loneliness at block 3414. For example, the model 1616 illustrated in FIG. 16 may receive the string of tokens from the prompt composer and generate personalized recommendation for reducing social isolation and loneliness.

According to some examples, the method includes providing the user with multimodal output in the form of feedback supportive of the user's social well-being at block 3416. For example, the model 1616 illustrated in FIG. 16 may provide the user with multimodal output in the form of feedback supportive of the user's social well-being. This feedback may be provided in the form of visual, auditory or haptic stimulation. The feedback may include personalized recommendations, activities, or connections to support the user's social well-being. In some embodiments, the user agency and capability augmentation system 1600 may be further enhanced by incorporating therapist or physician guidance background material 1606 or other context input in order to achieve a long-term mental health care objective.

### Improving Language Translation

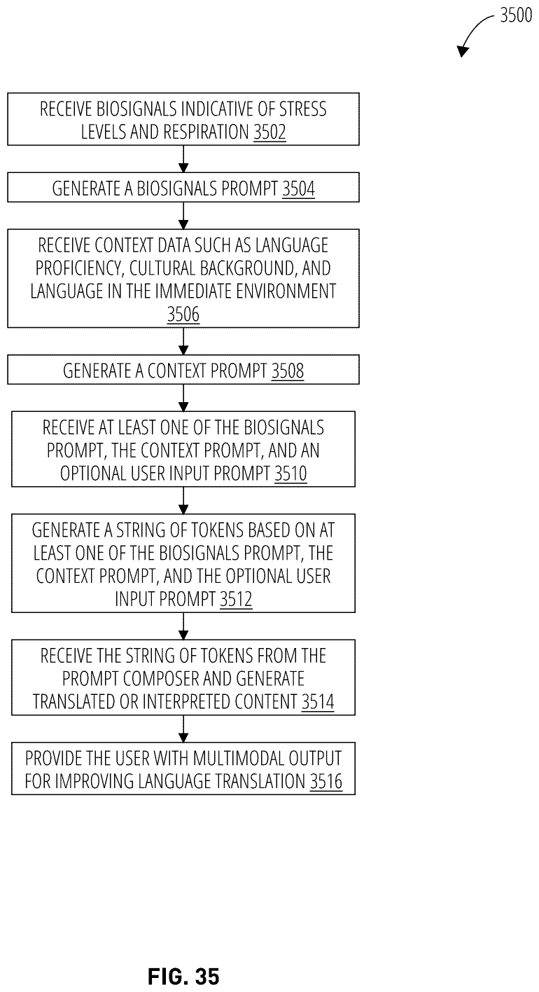

FIG. 35 illustrates an example routine 3500 for improving language translation. Although the example routine 3500 depicts a particular sequence of operations, the sequence may be altered without departing from the scope of the present disclosure. For example, some of the operations depicted may be performed in parallel or in a different sequence that does not materially affect the function of the routine 3500. In other examples, different components of an example device or system that implements the routine 3500 may perform functions at substantially the same time or in a specific sequence.

According to some examples, the method includes receiving biosignals indicative of stress levels and respiration at block 3502. For example, the biosignals subsystem 1700 illustrated in FIG. 17 may receive biosignals indicative of stress levels and respiration. These biosignals 1604 may be provided by the wearable computing and biosignal sensing device 1602 or by additional biosensors 1702 in the biosignals subsystem 1700. Such biosignals 1604 may include EEG data, heart and respiratory rate data, skin conductivity, etc.

According to some examples, the method includes generating a biosignals prompt at block 3504. For example, the biosignals subsystem 1700 illustrated in FIG. 17 may generate a biosignals prompt. The biosignals prompt 1634 may be generated by tokenizing the received biosignals 1604.

According to some examples, the method includes receiving context data such as language proficiency, cultural background, and language in the immediate environment at block 3506. For example, the context subsystem 1800 illustrated in FIG. 18 may receive context data such as language proficiency, cultural background, and language in the immediate environment. This context data may be provided as background material 1606 and may be used to infer the user's translation needs. Context data may also include sensor data 1608 such as audible spoken language detected by microphones, or video from cameras which may be analyzed for written text content.

According to some examples, the method includes generating a context prompt at block 3508. For example, the context subsystem 1800 illustrated in FIG. 18 may generate a context prompt. The context prompt 1636 may be generated by tokenizing the received context data.

According to some examples, the method includes receiving at least one of the biosignals prompt, the context prompt, and an optional user input prompt at block 3510. For example, the prompt composer 1614 illustrated in FIG. 16 may receive at least one of the biosignals prompt, the context prompt, and an optional user input prompt. The user input prompt 1638 may include keywords, queries, or commands related to spoken or written language in the user's environment desired speech output.

According to some examples, the method includes generating a string of tokens based on at least one of the biosignals prompt, the context prompt, and the optional user input prompt at block 3512. For example, the prompt composer 1614 illustrated in FIG. 16 may generate a string of tokens based on at least one of the biosignals prompt, the context prompt, and the optional user input prompt.

According to some examples, the method includes receiving the string of tokens from the prompt composer and generating translated or interpreted content at block 3514. For example, the model 1616 illustrated in FIG. 16 may receive the string of tokens from the prompt composer and generate translated or interpreted content. The model 1616 may be a pre-trained natural language 1616 configured to provide personalized language translation and interpretation services to the user 102.

According to some examples, the method includes providing the user with multimodal output for improving language translation at block 3516. For example, the model 1616 illustrated in FIG. 16 may provide the user with multimodal output for improving language translation. Translations and interpretations may be provided to the user 102 via visual stimuli of an AR/VR display, such as the wearable computing and biosignal sensing device 1602, and/or by auditory stimuli.

### Dialog System Using Biosensing to Drive Responses

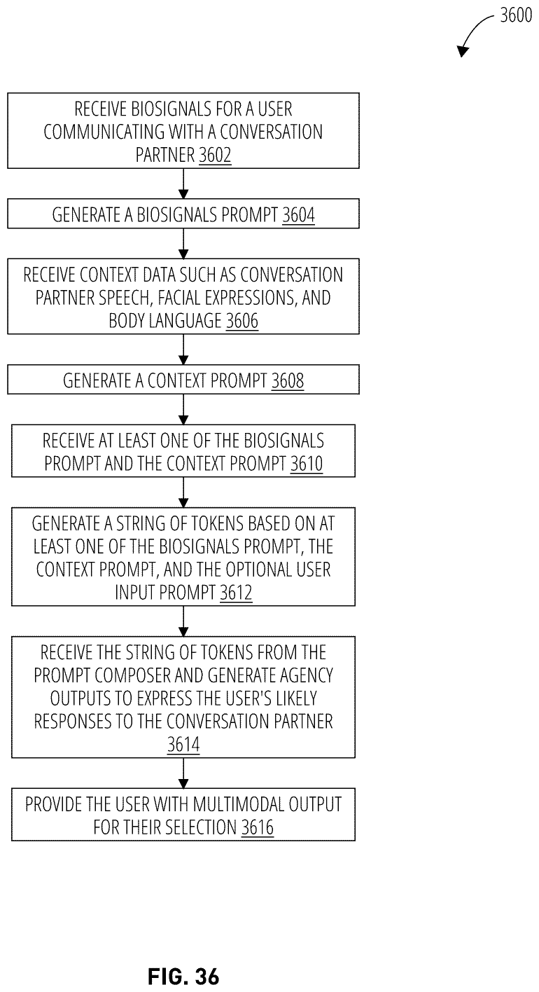

FIG. 36 illustrates an example routine 3600 for dialog system using biosensing to drive responses. Although the example routine 3600 depicts a particular sequence of operations, the sequence may be altered without departing from the scope of the present disclosure. For example, some of the operations depicted may be performed in parallel or in a different sequence that does not materially affect the function of the routine 3600. In other examples, different components of an example device or system that implements the routine 3600 may perform functions at substantially the same time or in a specific sequence.

According to some examples, the method includes receiving biosignals for a user communicating with a conversation partner at block 3602. For example, the biosignals subsystem 1700 illustrated in FIG. 17 may receive biosignals for a user communicating with a conversation partner. The biosignals 1604 may be provided by a wearable computing and biosignal sensing device 1602 worn by the user 102 or additional biosensors 1702.

According to some examples, the method includes generating a biosignals prompt at block 3604. For example, the biosignals subsystem 1700 illustrated in FIG. 17 may generate a biosignals prompt. The biosignals prompt 1634 may be generated by tokenizing the received biosignals 1604 to indicate the user's physiological and cognitive responses.

According to some examples, the method includes receiving context data such as conversation partner speech, facial expressions, and body language at block 3606. For example, the context subsystem 1800 illustrated in FIG. 18 may receive context data such as conversation partner speech, facial expressions, and body language.

According to some examples, the method includes generating a context prompt at block 3608. For example, the context subsystem 1800 illustrated in FIG. 18 may generate a context prompt. The context prompt 1636 may be generated by tokenizing the audio and video capturing the conversation partner's communication.

According to some examples, the method includes receiving at least one of the biosignals prompt and the context prompt at block 3610. For example, the prompt composer 1614 illustrated in FIG. 16 may receive at least one of the biosignals prompt and the context prompt. In this embodiment, no user input prompt 1638 may be needed to drive predictions.

According to some examples, the method includes generating a string of tokens based on at least one of the biosignals prompt, the context prompt, and the optional user input prompt at block 3612. For example, the prompt composer 1614 illustrated in FIG. 16 may generate a string of tokens based on at least one of the biosignals prompt, the context prompt, and the optional user input prompt.

According to some examples, the method includes receiving the string of tokens from the prompt composer and generating agency outputs to express the user's likely responses to the conversation partner at block 3614. For example, the model 1616 illustrated in FIG. 16 may receive the string of tokens from the prompt composer and generate agency outputs to express the user's likely responses to the conversation partner.

According to some examples, the method includes providing the user with multimodal output for their selection at block 3616. For example, the model 1616 illustrated in FIG. 16 may provide the user with multimodal output for their selection. The user 102 may then select appropriate responses and have them communicated to their conversation partner. In one embodiment, “nodding head and listening with interest” may be an output from the model 1616, which may then be used to drive a robotic system, an avatar representing the user 102, or simply an emoji response that is rendered back to the conversation partner. In another embodiment, a user's physical state may be used to prioritize utterances 1622 that address their immediate needs or activities, such as requesting assistance or exposing health monitor information to the user 102 when exercise activities are detected.

### Using Biosignals to Infer a Tone or Style for Model Output

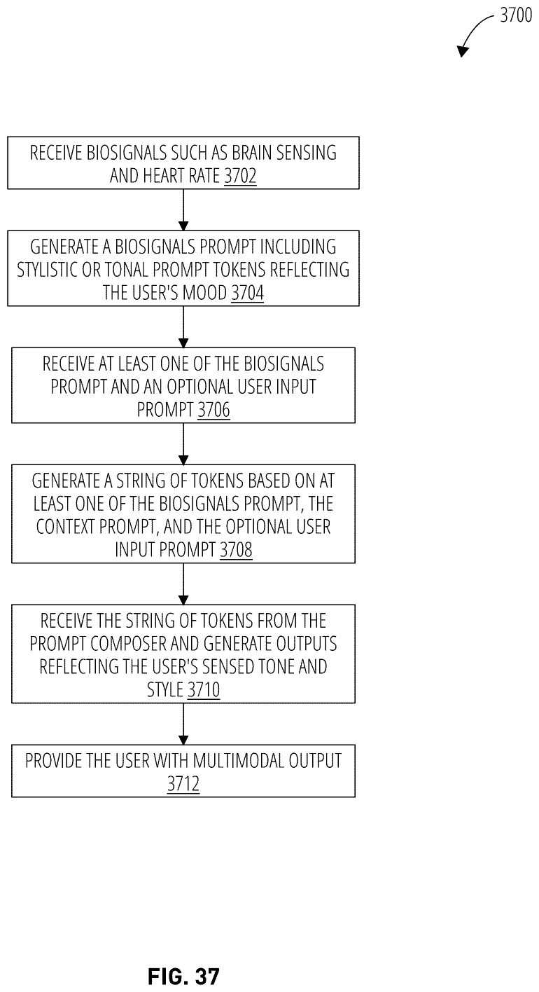

FIG. 37 illustrates an example routine 3700 for using biosignals to infer a tone or style for model output. Although the example routine 3700 depicts a particular sequence of operations, the sequence may be altered without departing from the scope of the present disclosure. For example, some of the operations depicted may be performed in parallel or in a different sequence that does not materially affect the function of the routine 3700. In other examples, different components of an example device or system that implements the routine 3700 may perform functions at substantially the same time or in a specific sequence.

According to some examples, the method includes receiving biosignals such as brain sensing and heart rate at block 3702. For example, the biosignals subsystem 1700 illustrated in FIG. 17 may receive biosignals such as brain sensing and heart rate. Biosignals 1604 may be detected from the wearable computing and biosignal sensing device 1602 or additional biosensors 1702. Biosignals 1604 may include EEG data in one embodiment. The user agency and capability augmentation system 1600 may use brain sensing data and/or heart rate data to estimate the user's level of arousal or engagement with the context.

According to some examples, the method includes generating a biosignals prompt including stylistic or tonal prompt tokens reflecting the user's mood at block 3704. For example, the biosignals subsystem 1700 illustrated in FIG. 17 may generate a biosignals prompt including stylistic or tonal prompt tokens reflecting the user's mood. When arousal is high, the biosignals subsystem 1700 may generate more emphatic or excited tokens, such as “excited, happy, engaged”. When arousal is low, the biosignals subsystem 1700 tokenizer may generate tokens with less interest or excitement, such as “bored, disinterested”.

According to some examples, the method includes receiving at least one of the biosignals prompt and an optional user input prompt at block 3706. For example, the prompt composer 1614 illustrated in FIG. 16 may receive at least one of the biosignals prompt and an optional user input prompt. The user input prompt 1638 may include keywords or commands from the user 102, such as selecting as the user input prompt 1638 an emoji to alter the output's persona, tone, or “mood.”.

According to some examples, the method includes generating a string of tokens based on at least one of the biosignals prompt, the context prompt, and the optional user input prompt at block 3708. For example, the prompt composer 1614 illustrated in FIG. 16 may generate a string of tokens based on at least one of the biosignals prompt, the context prompt, and the optional user input prompt.

According to some examples, the method includes receiving the string of tokens from the prompt composer and generating outputs reflecting the user's sensed tone and style at block 3710. For example, the model 1616 illustrated in FIG. 16 may receive the string of tokens from the prompt composer and generate outputs reflecting the user's sensed tone and style.

According to some examples, the method includes providing the user with multimodal output at block 3712. For example, the model 1616 illustrated in FIG. 16 may provide the user with multimodal output.

### Background is the User's Collected Works in a Specific Topic Area

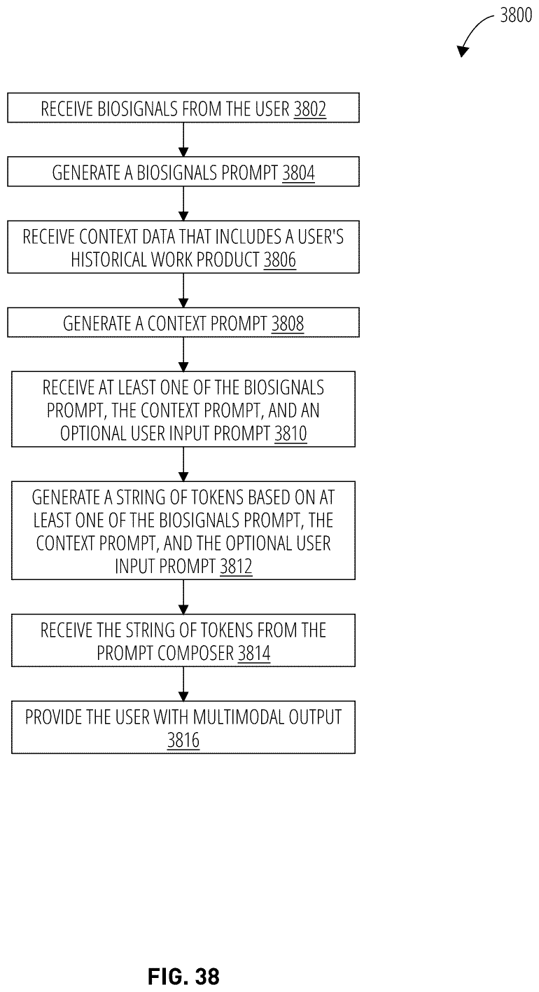

FIG. 38 illustrates an example routine 3800 when the background material 1606 is the user's collected works in a specific topic area. Although the example routine 3800 depicts a particular sequence of operations, the sequence may be altered without departing from the scope of the present disclosure. For example, some of the operations depicted may be performed in parallel or in a different sequence that does not materially affect the function of the routine 3800. In other examples, different components of an example device or system that implements the routine 3800 may perform functions at substantially the same time or in a specific sequence.

According to some examples, the method includes receiving biosignals from the user at block 3802. For example, the biosignals subsystem 1700 illustrated in FIG. 17 may receive biosignals from the user. Biosignals 1604 may be detected from the wearable computing and biosignal sensing device 1602 or additional biosensors 1702.

According to some examples, the method includes generating a biosignals prompt at block 3804. For example, the biosignals subsystem 1700 illustrated in FIG. 17 may generate a biosignals prompt. The biosignals prompt 1634 may be generated by tokenizing the received biosignals 1604.

According to some examples, the method includes receiving context data that includes a user's historical work product at block 3806. For example, the context subsystem 1800 illustrated in FIG. 18 may receive context data that includes a user's historical work product. The context subsystem 1800 may receive background material 1606 that a user's historical work product, such as a collection of documents, images, or other media that represent the user's collected works in a specific topic area. For example, the user 102 might be an expert in a specific topic such as eighteenth-century literature or electrical engineering. The user 102 may have written articles, curricula, videos, etc. These may be incorporated into the historical work product and summarized or tokenized as appropriate.

According to some examples, the method includes generating a context prompt at block 3808. For example, the context subsystem 1800 illustrated in FIG. 18 may generate a context prompt. The context prompt 1636 may be generated by tokenizing the received context data. The background material 1606 (historical information) may be incorporated into the context token stream and provided as background to the prompt composer 1614.

According to some examples, the method includes receiving at least one of the biosignals prompt, the context prompt, and an optional user input prompt at block 3810. For example, the prompt composer 1614 illustrated in FIG. 16 may receive at least one of the biosignals prompt, the context prompt, and an optional user input prompt.

According to some examples, the method includes generating a string of tokens based on at least one of the biosignals prompt, the context prompt, and the optional user input prompt at block 3812. For example, the prompt composer 1614 illustrated in FIG. 16 may generate a string of tokens based on at least one of the biosignals prompt, the context prompt, and the optional user input prompt. In this configuration, the biosignals prompt 1634, context prompt 1636, and user input prompt 1638 may be used to construct a prompt that specifically relates to the historical work product.

According to some examples, the method includes receiving the string of tokens from the prompt composer at block 3814. For example, the model 1616 illustrated in FIG. 16 may receive the string of tokens from the prompt composer. In some embodiments, the amount of background material 1606 in the form of historical work product may be substantial and may alternatively need the model 1616 itself be retrained with this additional information.

According to some examples, the method includes providing the user with multimodal output at block 3816. For example, the model 1616 illustrated in FIG. 16 may provide the user with multimodal output. In one use case, this may cause output text from the model 1616 to be in the style of the background material 1606 or framed in the technical jargon of a specific technical discipline.

Pretraining the GenAI with Historical User Works for Improved Response to Compositional Prompts

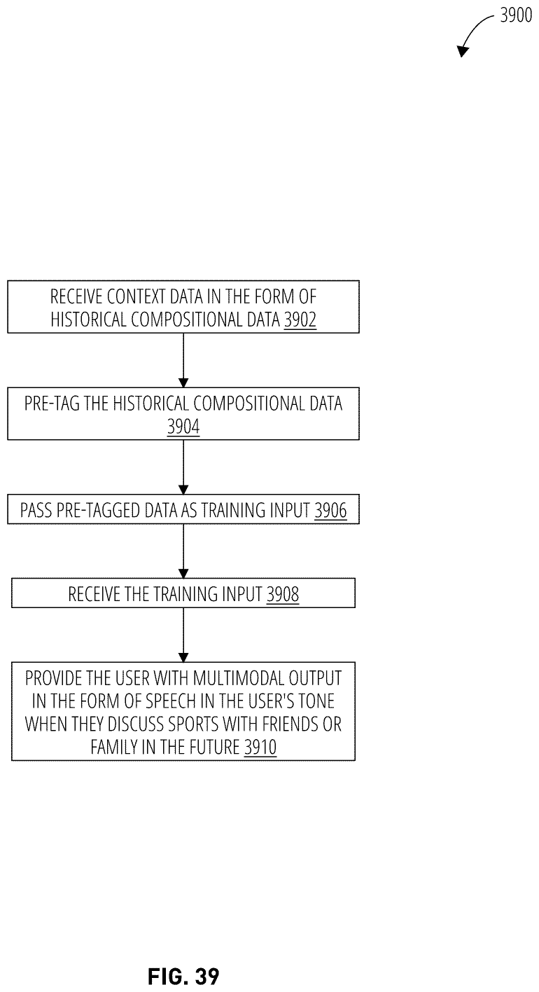

FIG. 39 illustrates an example routine 3900 for pretraining the GenAI with historical user works for improved response to compositional prompts. Although the example routine 3900 depicts a particular sequence of operations, the sequence may be altered without departing from the scope of the present disclosure. For example, some of the operations depicted may be performed in parallel or in a different sequence that does not materially affect the function of the routine 3900. In other examples, different components of an example device or system that implements the routine 3900 may perform functions at substantially the same time or in a specific sequence.

According to some examples, the method includes receiving context data in the form of historical compositional data at block 3902. For example, the context subsystem 1800 illustrated in FIG. 18 may receive context data in the form of historical compositional data. In one embodiment, the background material 1606 (historical compositional data) may be pre-tagged with relevant semantic context tokens prior to any utterances being generated.

According to some examples, the method includes pre-tagging the historical compositional data at block 3904. For example, the prompt composer 1614 illustrated in FIG. 16 may pre-tag the historical compositional data. For example, a user 102 may import their chat history, which may be tagged not only with the conversation partner but also with the type of conversation, such as an informal one about sports. In one embodiment, the context subsystem 1800 may perform the pre-tagging.

According to some examples, the method includes passing pre-tagged data as training input at block 3906. For example, the prompt composer 1614 illustrated in FIG. 16 may pass pre-tagged data as training input.

According to some examples, the method includes receiving the training input at block 3908. For example, the model 1616 illustrated in FIG. 16 may receive the training input. Using the training input, the model 1616 may be tuned so that it is capable of generating output that contains more user-specific knowledge, as well as tone appropriate to the target output format.

According to some examples, the method includes providing the user with multimodal output in the form of speech in the user's tone when they discuss sports with friends or family in the future at block 3910. For example, the model 1616 illustrated in FIG. 16 may provide the user with multimodal output in the form of speech in the user's tone when they discuss sports with friends or family in the future.

Various functional operations described herein may be implemented in logic that is referred to using a noun or noun phrase reflecting said operation or function. For example, an association operation may be carried out by an “associator” or “correlator”. Likewise, switching may be carried out by a “switch”, selection by a “selector”, and so on.

Within this disclosure, different entities (which may variously be referred to as “units,” “circuits,” other components, etc.) may be described or claimed as “configured” to perform one or more tasks or operations. This formulation—[entity] configured to [perform one or more tasks]—is used herein to refer to structure (i.e., something physical, such as an electronic circuit). More specifically, this formulation is used to indicate that this structure is arranged to perform the one or more tasks during operation. A structure may be said to be “configured to” perform some task even if the structure is not currently being operated. A “credit distribution circuit configured to distribute credits to a plurality of processor cores” is intended to cover, for example, an integrated circuit that has Circuitry that performs this function during operation, even if the integrated circuit in question is not currently being used (e.g., a power supply is not connected to it). Thus, an entity described or recited as “configured to” perform some task refers to something physical, such as a device, circuit, memory storing program instructions executable to implement the task, etc. This phrase is not used herein to refer to something intangible.

The term “configured to” is not intended to mean “configurable to.” An unprogrammed field programmable gate array (FPGA), for example, would not be considered to be “configured to” perform some specific function, although it may be “configurable to” perform that function after programming.

Reciting in the appended claims that a structure is “configured to” perform one or more tasks is expressly intended not to invoke 35 U.S.C. § 112(f) for that claim element. Accordingly, claims in this application that do not otherwise include the “means for” [performing a function] construct should not be interpreted under 35 U.S.C § 112(f).

As used herein, the term “based on” is used to describe one or more factors that affect a determination. This term does not foreclose the possibility that additional factors may affect the determination. That is, a determination may be solely based on specified factors or based on the specified factors as well as other, unspecified factors. Consider the phrase “determine A based on B.” This phrase specifies that B is a factor that is used to determine A or that affects the determination of A. This phrase does not foreclose that the determination of A may also be based on some other factor, such as C. This phrase is also intended to cover an embodiment in which A is determined based solely on B. As used herein, the phrase “based on” is synonymous with the phrase “based at least in part on.”

As used herein, the phrase “in response to” describes one or more factors that trigger an effect. This phrase does not foreclose the possibility that additional factors may affect or otherwise trigger the effect. That is, an effect may be solely in response to those factors or may be in response to the specified factors as well as other, unspecified factors. Consider the phrase “perform A in response to B.” This phrase specifies that B is a factor that triggers the performance of A. This phrase does not foreclose that performing A may also be in response to some other factor, such as C. This phrase is also intended to cover an embodiment in which A is performed solely in response to B.

As used herein, the terms “first,” “second,” etc. are used as labels for nouns that they precede and do not imply any type of ordering (e.g., spatial, temporal, logical, etc.), unless stated otherwise. For example, in a register file having eight registers, the terms “first register” and “second register” may be used to refer to any two of the eight registers, and not, for example, just logical registers 0 and 1.

When used in the claims, the term “or” is used as an inclusive or and not as an exclusive or. For example, the phrase “at least one of x, y, or z” means any one of x, y, and z, as well as any combination thereof.

Having thus described illustrative embodiments in detail, it will be apparent that modifications and variations are possible without departing from the scope of the disclosure as claimed. The scope of disclosed subject matter is not limited to the depicted embodiments but is rather set forth in the following Claims.

Terms used herein may be accorded their ordinary meaning in the relevant arts, or the meaning indicated by their use in context, but if an express definition is provided, that meaning controls.

Herein, references to “one embodiment” or “an embodiment” do not necessarily refer to the same embodiment, although they may. Unless the context clearly requires otherwise, throughout the description and the claims, the words “comprise,” “comprising,” and the like are to be construed in an inclusive sense as opposed to an exclusive or exhaustive sense; that is to say, in the sense of “including, but not limited to.” Words using the singular or plural number also include the plural or singular number respectively, unless expressly limited to a single one or multiple ones. Additionally, the words “herein,” “above,” “below” and words of similar import, when used in this application, refer to this application as a whole and not to any particular portions of this application. When the claims use the word “or” in reference to a list of two or more items, that word covers all of the following interpretations of the word: any of the items in the list, all of the items in the list and any combination of the items in the list, unless expressly limited to one or the other. Any terms not expressly defined herein have their conventional meaning as commonly understood by those having skill in the relevant art(s).

It is to be understood that the disclosed subject matter is not limited in its application to the details of construction and to the arrangements of the components set forth in the following description or illustrated in the drawings. The disclosed subject matter is capable of other embodiments and of being practiced and carried out in various ways. Also, it is to be understood that the phraseology and terminology employed herein are for the purpose of description and should not be regarded as limiting.

As such, those skilled in the art will appreciate that the conception, upon which this disclosure is based, may readily be utilized as a basis for the designing of other structures, systems, methods and media for carrying out the several purposes of the disclosed subject matter. It is important, therefore, that the claims be regarded as including such equivalent constructions insofar as they do not depart from the spirit and scope of the disclosed subject matter.

What is claimed is:

1. A system for enabling an Artificial Intelligence (AI) assisted conversation using a biosensor, the system comprising:
the biosensor configured to receive biosignals;
a perception engine configured to receive sensory input and parse the biosignals, wherein the sensory input is at least one of audio data, visual data, and haptic feedback data;
a user experience engine allowing a user, through a generated visual interface, to at least one of view a conversation feature and select the conversation feature, wherein the conversation feature is at least one of:
communication history;
context data; and
data to be communicated, selectable using the biosensor;
an AI system including at least one of:
a memory engine to at least one of store, catalog, and serve at least one of conversation history, biographical background, keywords, and other ancillary data;
the perception engine configured to consume multimodal sensory information from at least one of cameras, microphones, and other data streams of sensory inputs, wherein perception engine output is stored by the memory engine;
a conversation engine configured to consume content and instructions to orchestrate prompts that produce the data to be communicated when sent to a language model (LM); and
a refinement engine configured to allow the user to approve and modify responses before generating a conversation output;
a computing device configured to use the user experience engine to present the conversation feature to the user and accept input data from the user; and
a companion application for generating communications to a conversation partner, wherein the conversation partner is at least one of a human partner and a machine agent.

2. The system of claim 1, wherein the computing device is a brain computer interface (BCI) system including at least one wearable biosensor.

3. The system of claim 1, wherein the companion application is a network-connected companion application.

4. The system of claim 1, wherein the companion application is integrated into a network-connected communication application.

5. The system of claim 1, wherein the user experience engine includes a language engine configured to transform conversation engine output into text or spoken language for presentation to at least one of the user and the conversation partner.

6. The system of claim 1, wherein the conversation engine includes at least one of a conversation type classifier, an adjacency pair classifier, a question classifier, a prompt orchestration and a conversation language model.

7. The system of claim 1, wherein the conversation engine receives at least one of:
non-language context data from the perception engine;
language context data from the perception engine; and
language context data from the memory engine.

8. The system of claim 6, wherein the conversation language model receives prompts from the prompt orchestration and computes suggestion data that is sent to the user experience engine for presentation to the user.

9. The system of claim 1, wherein the perception engine includes:
at least one of biosensors, cameras, and microphones;
a speech to text transformer; and
at least one of:
logic to perform the biosignal analysis, computer vision analysis, and ambient audio analysis; and
AI or machine learning (ML) models to perform the biosignal analysis, the computer vision analysis, and the ambient audio analysis.

10. The system of claim 1, wherein the memory engine includes a local database in communication with long term memory and session memory,
wherein the local database includes at least one of the biographical background of the user and a written language corpus of the user; and
wherein the session memory includes at least one of current session history and recent state data.

11. The system of claim 1, wherein the refinement engine includes phrase refinement configured to develop refinements based on at least one of tone, bridges between conversation concepts and phrases, and follow-up on previous phrases.

12. The system of claim 1, further comprising a tuning engine configured to fine-tune the LM to improve suggestions and personalize the LM for the user.

13. The system of claim 1, wherein the conversation partner is a machine agent trained on a specific knowledge domain.

14. A method comprising:
receiving biosignals at a biosensor configured as part of a system for enabling an Artificial Intelligence (AI) assisted conversation;
receiving, at a perception engine, multimodal sensory information from at least one of cameras, microphones, and other data streams of sensory inputs;
performing, by the perception engine, biosignal analysis upon the biosignals;
generating, by the perception engine, context tags and text descriptions based on at least one of the multimodal sensory information and the biosignal analysis;
receiving, at a conversation engine, the context tags and the text descriptions from the perception engine;
receiving, at the conversation engine, context data from a memory engine configured to at least one of store, catalog, and serve the context data, wherein the context data is at least one of conversation history, biographical background, keywords, and other ancillary data;
receiving, at the conversation engine, instructions from a user experience engine configured to allow a user, through a generated visual interface, to at least one of view a conversation feature and select the conversation feature, wherein the conversation feature is at least one of:
communication history;
the context data; and
data to be communicated, selectable using the biosensor;
generating, by the conversation engine, prompts based on at least one of the context tags, the text descriptions, the context data, and the instructions;
sending the prompts to a language model (LM);
receiving, at the conversation engine, in response to the prompts, the data to be communicated;
receiving, at the user experience engine, the data to be communicated; and
displaying, by the user experience engine to a user through a computing device, the conversation feature, wherein the computing device is configured to use the user experience engine to present the conversation feature to the user and accept input data from the user.

15. The method of claim 14, further comprising:
accepting, by the user experience engine, the input data from the user, wherein the input data includes a selection of the conversation feature; and
generating, by the user experience engine, a communication to a conversation partner based on the conversation feature, wherein the conversation partner is at least one of a human partner and a machine agent.

16. The method of claim 14, the perception engine configured with:
at least one of biosensors, cameras, and microphones;
a speech to text transformer; and
at least one of:
logic to perform the biosignal analysis, computer vision analysis, and ambient audio analysis; and
AI or machine learning (ML) models to perform the biosignal analysis, the computer vision analysis, and the ambient audio analysis; and
further including:
performing at last one of the computer vision analysis upon visual data from the cameras, the ambient audio analysis upon audible data from the microphones, and speech to text transformation upon audible data from the microphones.

17. The method of claim 15, further comprising:
accepting, by a refinement engine, the input data indicating a request to refine the data to be communicated, wherein the refinement engine is configured to allow the user to approve and modify responses before generating a conversation output.

18. The method of claim 15, further comprising:
presenting, by a companion application, the communication to the conversation partner, wherein the companion application is configured to present the communications as at least one of written text and spoken language.

19. The method of claim 14, wherein the system for enabling an AI assisted conversation further comprises a tuning engine configured to fine-tune the LM to improve suggestions and personalize the LM for the user.

20. The method of claim 19, further comprising:
accepting, at the tuning engine, session data from the user experience engine; and
generating, by the tuning engine, using the session data along with stored conversation, metadata, and user behavior, reinforcement training inputs for the LM.
